(19) United States
(12) Patent Application Publication
(10) Pub. No.: US 2025/0047324 A1
(43) Pub. Date: Feb. 6, 2025

(54) POWER LINE COMMUNICATION AND SMART SYSTEMS

(71) Applicant: Focus Universal Inc., Ontario, CA (US)

(72) Inventors: Desheng Wang, Diamond Bar, CA (US); Cailin Tian, Ontario, CA (US)

(21) Appl. No.: 18/919,984

(22) Filed: Oct. 18, 2024

Related U.S. Application Data
(63) Continuation-in-part of application No. 18/638,138, filed on Apr. 17, 2024.
Application No. 18/638,138 is a continuation of application No. 18/145,756, filed on Dec. 22, 2022, now Pat. No. 11,984,942.
Application No. 18/145,756 is a continuation of application No. 16/760,857, filed on Apr. 30, 2020, now Pat. No. 11,546,017.
(63) Continuation-in-part of application No. 18/459,928, filed on Sep. 1, 2023.
Application No. 18/459,928 is a continuation of application No. 17/749,048, filed on May 19, 2022, now Pat. No. 11,750,138.
(63) Continuation-in-part of application No. 17/747,811, filed on May 18, 2022.
(63) Continuation-in-part of application No. 17/747,888, filed on May 18, 2022.
(63) Continuation-in-part of application No. 17/748,917, filed on May 19, 2022.
(60) Provisional application No. 63/190,428, filed on May 19, 2021.
(60) Provisional application No. 63/190,558, filed on May 19, 2021.
(60) Provisional application No. 63/190,563, filed on May 19, 2021.
(60) Provisional application No. 63/190,616, filed on May 19, 2021.

(51) Int. Cl. H04B 3/54

(52) U.S. Cl. CPC H04B 3/54

(57) ABSTRACT

Disclosed is a smart home system for controlling peripheral devices. The smart home system allows a single computing device to control a plurality of peripheral devices. The system can include a crystal oscillator. The computing device connects to a universal device. The universal device connects to one or more system modules. The universal device and system modules communicate using a protocol stored, at least in part, on both the universal device and system modules. The use of the protocol and the system module to peripheral device interface allows for a universality of peripheral devices. That is, the smart home system allows for the extension of smart control to non-traditional smart devices.

### CROSS-REFERENCE TO RELATED APPLICATIONS

The present application is a continuation-in-part of U.S. patent application Ser. No. 18/638,138 (FCUV-112PTUSCN2), filed Apr. 17, 2024 and titled “SYSTEM AND METHOD OF POWER LINE COMMUNICATION”, which is a continuation of U.S. patent application Ser. No. 18/145,756, filed Dec. 22, 2022, which is a continuation of U.S. patent application Ser. No. 16/760,857, filed Apr. 30, 2020, which is a national stage entry of International Patent Application No. PCT/US2019/063880, filed Nov. 29, 2019.

The present application is a continuation-in-part of U.S. patent application Ser. No. 18/459,928 (FCUV-117-CON), filed Sep. 1, 2023 and titled “SYSTEM AND METHOD FOR POWER LINE COMMUNICATION TO CONTROL FANS AND OTHER APPLIANCES”, which is a continuation of U.S. patent application Ser. No. 17/749,048, filed May 19, 2022, which claims the benefit of priority to U.S. Provisional Patent Application No. 63/190,428, filed May 19, 2021.

The present application is a continuation-in-part of U.S. patent application Ser. No. 17/747,811 (FCUV-110), filed May 18, 2022 and titled “SYSTEM AND METHOD FOR A SMART HOME SYSTEM”, which claims the benefit of priority to U.S. Provisional Patent Application No. 63/190,558, filed May 19, 2021.

The present application is a continuation-in-part of U.S. patent application Ser. No. 17/747,888 (FCUV-121), filed May 18, 2022 and titled “HYDROPONIC SMART SYSTEM AND ASSOCIATED METHODS”, which claims the benefit of priority to U.S. Provisional Patent Application No. 63/190,563, filed May 19, 2021.

The present application is a continuation-in-part of U.S. patent application Ser. No. 17/748,917 (FCUV-125), filed May 19, 2022 and titled “SYSTEM AND METHOD FOR AN INTERNET OF THINGS”, which claims the benefit of priority to U.S. Provisional Patent Application No. 63/190,616, filed May 19, 2021.

The disclosure each of the above-referenced applications is hereby incorporated by reference in its entirety. Any and all applications for which a foreign or domestic priority claim is identified in the Application Data Sheet as filed with the present application are hereby incorporated by reference under 37 CFR 1.57.

### FIELD

The present disclosure relates to power line communication, such as in controlling fans and other appliances, as well as smart home and other smart systems.

### BACKGROUND

Power line communication (PLC) to control devices and pass data is a well-known technology. Electrical power companies have used it since the first half of the twentieth century for telemetry and other selected uses. Typically, a residential power line communication system operates by modulating a carrier wave of between 20 and 200 kHz place on to the household wiring by a transmitter. The modulation wave is typically a digital wave. The technology was adapted for use within commercial and home settings in the 1970s with the development of X10, a narrowband power line communication system. As a system, X10 combined hardware, including transmitters and receivers, with a new transmission protocol. Since the carrier signal may propagate to nearby homes (or apartments) on the same distribution system, these control schemes have a “house address” that designates the owner. Further, each receiver in the system has an address allowing each device including a receiver on the system to be individually sent commands using signals transmitted over the household wiring and decoded at the receiver. These devices may be either plugged into regular power outlets, or permanently wired in place. X10 generates 120 kHz bursts at the zero crossings of the alternating current power wave. X10 suffers from several drawbacks, primary among which was an inability to effectively send communication signals despite the electrical noise existing on power lines. The noise being introduced by devices connected to those lines for power. X10 also has transmission distance limitations due to the relative weakness of the signal, and the transmission signal suffers from phase change whenever the signal crosses a terminal.

More recently, digital technology has been brought to bear on PLC. In 1999, the Universal Powerline Bus (UPB), another narrowband power line communication system, was introduced. UPB uses pulse-position modulation to encode data on the power signal. Essentially, pulse-position modulation is a form of amplitude modulation. In pulse-position modulation, a pulse may be generated by the discharge of a capacitor in one of four positions in a frame placed toward the end of every half cycle of the AC power wave. The position of pulse indicates a discrete integer value from zero to three. Thus, the UPB protocol is capable of generating two bits every cycle, and a byte every four cycles. Messages in the protocol can be from 7 to 25 bytes. A major advantage of UPB was that the messaging protocol of UPB allowed for the “linking” of devices. With “linking” a single message could be sent, and the message could include different commands, or the same command, for each device in the link. In this way, multiple light fixture could be adjusted to a particular scheme with one touch of a control.

UPB pulses are relatively weak in comparison to the AC power signal they use as a carrier wave. Certain devices or appliances generate electrical noise in the same range as the power signal, which interferes with the pulse position modulation of the UPB system. One such device is a fan, which generates as much or more noise than most devices. The main source of electrical noise in a fan is the commutator brushes, which can bounce as the motor shaft rotates. This bouncing, when coupled with the inductance of the motor coils and motor leads, can lead to a lot of noise on the power line and can even induce noise in nearby lines. This noise can interfere with system sensors and can even impair the system microcontroller by causing voltage dips on the regulated power line. Large enough voltage dips can corrupt the data in microcontroller registers or cause the microcontroller to reset.

A number of potential solutions to the noise generated by fan motors and other devices have been proposed and implemented within UPB. Among these are adding capacitors either across the fan motor terminals, or from each motor terminal to the case for grounding, keeping motor power leads short, and introducing filtering circuits. The filtering circuits may be plugged in to an outlet or hard wired in at an electrical panel. Each of these solutions either generates further problems that must be solved or is costly to implement in both equipment and labor.

There has been much work done recently in pulse modulating a carrier wave to send signals which convey information through phase shifting. However, extensive filtering of the signal is required, particularly when a user wished to create an ultra-narrow band signal. The ultra-narrow band signal can have as little as a single frequency bandwidth. High enough energy densities may allow for such a signal to be used in powerline control, but there is no known way to ultra-narrow band filter such modulations as baseband. Further, at the RF level, the filters are complex and must be hand tuned. Finally, there is no known way to build a zero group delay narrow band filer into a digital signal processing (DSP), finite impulse response (FIR) or infinite impulse response (IIR) filter.

Other attempts have been made at a broadband version of power line communication. Broadband over power line (BPL) is a system to transmit two-way data over existing alternating current medium voltage (AC MV) electrical distribution wiring, between transformers, and alternating current low voltage (AC LV) wiring between transformer and customer outlets (typically 110 to 240 V). Such systems, like all state-of-the-art power line communication systems, do avoid the expense of a dedicated network of wires for data communication, and the expense of maintaining a dedicated network of antennas, radios and routers in wireless network.

BPL uses some of the same radio frequencies used for over-the-air radio systems. Modern BPL employs frequency-hopping spread spectrum to avoid using those frequencies actually in use, though early pre-2010 BPL standards did not. The BPL OPERA standard is used primarily in Europe by internet service providers. In North America, the BPL OPERA standard is used in some places (Washington Island, WI, for example) but is more generally used by electric distribution utilities for smart meters and load management.

However, since the ratification of the IEEE 1901 (HomePlug) LAN standard and its widespread implementation in mainstream router chipsets, the older BPL standards are not optimal for communication between AC outlets within a building, nor between the building and the transformer where MV meets LV lines. Deployment of BPL has illustrated a number of fundamental challenges, the primary one being that power lines are inherently a very noisy environment. Every time a device turns on or off, it introduces a pop or click, that is to say electrical noise, into the line. Switching power supplies often introduces noisy harmonics into the line. Devices such as relays, transistors, and rectifiers create noise in their respective systems, increasing the likelihood of signal degradation. Arc-fault circuit interrupter (AFCI) devices, required by some recent electrical codes for living spaces, may also attenuate the signals. Finally, transformers and DC-DC converters attenuate the input frequency signal almost completely. “Bypass” devices become necessary for the signal to be passed on to the receiving node. A bypass device may consist of three stages, a filter in series with a protection stage and coupler, placed in parallel with the passive device. And unlike coaxial cable or twisted-pair, standard electrical wiring has no inherent noise rejection.

The second major issue is electromagnetic compatibility (EMC). The system was expected to use frequencies of 10 to 30 MHz in the high frequency (HF) range, used for decades by military, aeronautical, amateur radio, and by shortwave broadcasters. Power lines are unshielded and will act as antennas for the signals they carry, and they will cause interference to high frequency radio communications and broadcasting. In 2007, the NATO Research and Technology Organization released a report which concluded that widespread deployment of BPL may have a possible detrimental effect upon military HF radio communications.

For the foregoing reasons, there is a need for a system which can provide power line communication without detrimental effects from noise and at sufficient data rates.

Power line control (PLC) of devices is a well-known technology. Power companies have used it since the first half of the twentieth century for telemetry and other uses. The technology was adapted for use within commercial and home settings in the 1970s with the development of X10. X10 combined hardware, including transmitters and receivers, with a new transmission protocol. The system generated 120 kHz bursts at the zero crossings of the alternating current power wave. X10 suffered from several drawbacks, primary among which was an inability to deal with the noise on power lines, the noise being introduced by devices connected to those lines for power. X10 also has distance limitations and an inability to cross terminals which change the phase of the power signal.

More recently, digital technology has been brought to bear on PLC. In 1999, the Universal Power-line Bus (UPB) was introduced. UPB uses pulse-position modulation. Essentially, pulse-position modulation is a form of amplitude modulation. In pulse-position modulation, a pulse may be generated by the discharge of a capacitor in one of four positions in a frame placed toward the end of every half cycle of the AC power wave. The position of pulse indicates a value from zero to three. This protocol is capable of generating two bits every cycle, and a byte every two cycles. Messages in the protocol can be from 7 to 25 bytes. A major advantage of UPB was that the messaging protocol of UPB allowed for the “linking” of devices. With “linking” a single message could be sent, and the message could include different commands, or the same command, for each device in the link. In this way, lighting could be adjusted to a particular scheme with one touch of a control.

UPB pulses are relatively weak in comparison to the AC power signal on the power line. Certain devices or appliances generate electrical noise in the same range as the power signal, which interferes with the PPM of the UPB system. One such device is a fan, which generates as much or more noise than most devices. The main source of electrical noise in a fan is the commutator brushes, which can bounce as the motor shaft rotates. This bouncing, when coupled with the inductance of the motor coils and motor leads, can lead to a lot of noise on the power line and can even induce noise in nearby lines. This noise can interfere with system sensors and can even impair the system microcontroller by causing voltage dips on the regulated power line. Large enough voltage dips can corrupt the data in microcontroller registers or cause the microcontroller to reset.

A number of potential solutions to the noise generated by fan motors and other devices have been proposed and implemented. Among these are adding capacitors either across the motor terminals, or from each motor terminal to the case, for grounding, keeping motor power leads short, and introducing filtering circuits. The filtering circuits may be plugged in to an outlet or hard wired in at an electrical panel. Each of these solutions either generates further problems that must be solved or is costly to implement in both equipment and labor.

Given the identified problems, one proposed solution is to connect the fans with a separate cable, for example, an RJ12 cable, which carries a control signal. However, such an arrangement defeats the purpose of using PLC in the first place. PLC takes advantage of the fact that the power line wiring which is also used as a signal carrier line with PLC, is already in place, and no additional lines need to be installed.

For the foregoing reasons, there is a need for a system which can send PLC messages to devices on a network despite the network containing fans which generate noise.

Current state of the art in smart home technology is based on brand-centric eco systems. That is, groups of devices from a single company which share an operating environment. For example, one company may produce a smart speaker which may include some version of virtual assistant technology. The same company may also produce a camera which allows a user to monitor the interior or exterior, or both, of the user's residence remotely over the internet. The same company may further produce a doorbell system which includes a camera which a user may use to see who is at their door, even from a remote location, when the doorbell is rung. Because the devices are all from a single source, they share an operating environment and are thus guaranteed to interoperate. However, they are also marketed as standalone products. Thus, many of such smart home products have redundant features which elevate the cost of each item of the smart home system.

However, if a consumer favors the features of a smart speaker from one company and a doorbell system from a different company, there is no guarantee the two will interoperate, in fact, the truth is quite the opposite, the two devices are nearly guaranteed to not interoperate. Further, many of the devices may have features which are surplus to the needs of most users. Sometimes these features are to enable interoperability, other times they are added by the company creating the product to appeal to consumers. However, each consumer is different and the additional features may be unwanted. Making matters worse, the ecosystems are often created haphazardly. A typical scenario includes a company creating a first device. The operating environment is often created with only the device itself in mind. Such a first product must be a success in order for the company to raise enough capital to research and develop follow on products. Thus, the first product is optimized for its particular purpose without regard for interoperability in an ecosystem. If the first product is a success, the company must develop interoperability with the first device, which is almost exclusively optimized for anything but interoperability. Thus, the company must use less than ideal means to establish interoperability in creating an ecosystem of devices.

Sometimes the choices in creating devices for an ecosystem are dominated by economics. Price of any device is always a factor in how well a particular device or group of devices will function in an ecosystem. While it may be technically possible to include a myriad of possible wired and wireless connections for the devices in an ecosystem, the cost to do so would lead to pricing that is not competitive in the consumer marketplace. Typically, this leads to the company choosing a single, often wireless, connection method for the ecosystem. The choice of a wireless connection eliminates concerns regarding what wired infrastructure the consumer may have. However, the wireless connection may be suboptimal for any number of reasons, but the consumer is left with no choice.

For the foregoing reasons, there is a need for a smart home system which has a competitive cost, but offers choice of devices and connectivity.

Indoor agriculture, and particularly hydroponic agriculture, often requires that plants are grown in sand, gravel, or liquid. In part, this is simply because there is no native soil indoors, unless the building lacks a floor structure such as a slab. Structures lacking floors are uncommon in the 21st century. Because sand, gravel, or liquid lack some of the essential nutrients commonly found in soil, nutrients may be added to the sand, gravel, or liquid to enable the plants to grow. While this method of agriculture is generally referred to as hydroponics, but can take a number of different forms, including deep water culture, and nutrient film technique, as just two examples. Because growers are not relying on the inherent nutrient composition of the soil, the nutrient mix may be adjusted. The fact that only some, or no, nutrients required by plants for ideal growth are present. This represents a problem for the growth of the plants, but also provides an opportunity. The opportunity is that nutrients can be added. Not only can they be added, but a grower is not handcuffed as the grower would be if the grower were working outdoors in the soil. When working outdoors in the soil, a grower is handed the doubled edged sword of having nutrients present, and thus not having to bear the cost of added them, but must accept the nutrient mix present. In hydroponics, the nutrient mix may be optimized or otherwise beneficially combined, because all the nutrients are being added by the grower. The beneficial combination of the nutrient mix means that growth may also be improved.

Further, because of the hydroponics taking place indoors, plants are not subject to the adverse weather conditions which are present from time to time outdoors. For example, the plants may be spared severe heat and storms. The plants are not subject to flooding because the water reaching them is controlled by the grower.

However, even indoor environments may affect the mix of nutrients. The humidity of indoor environments may vary, as well as the temperature. More importantly, indoor environments, and particularly large indoor environments, are not monolithic. That is, the indoor environment may have variation. For example, if there is a metal door in a wall, the metal door may radiate heat to the indoor environment at a greater rate than an insulated wall surrounding the metal door, or an insulated wall across the indoor space from the metal door. Thus, the heat may drastically affect the hydroponics, particularly when the plants are placed in a liquid.

Many growers simply set and forget, that is, they add an beneficial mix of nutrients, but do not monitor more than a single testing site. Naturally, given the possibility for variation of environmental factors, even in an indoor environment, the nutrient mix may not stay at optimum in every part of an operation. Moreover, given the variation possible, even in an indoor environment, one portion of the plants may be optimized, while other portions may not. The portions that are not optimized may go completely unnoticed. This can correspondingly lead to a poorer crop than would be possible were all portions optimized.

For the foregoing reasons, there can be improved systems which can monitor various aspects of the hydroponic farm, and provide control for the systems in operation in the hydroponic farm.

The Internet of Things (IoT) is a system of interrelated devices that are connected to a network, exchanging data without necessarily requiring human-to-machine interaction. Examples include smart factories, smart home devices and systems, medical monitoring devices and systems, wearable technology devices, for example, fitness trackers, and smart city infrastructures. IoT devices are often interchangeably called “smart” devices. This is because IoT devices typically have sensors and complex data analysis programs. IoT devices collect data using sensors and offer services to the user based on the analyses of the data and according to user-defined parameters.

IoT was first proposed in 1985. As mentioned above, IoT may include many different types of devices totaling billions of physical devices around the world that are connected to the internet, collecting and sharing data. The emerging technology of the IoT offers the greatest opportunities to create new business and generate the associated revenues, and thus ranks as the number one disruptive technology. With IoT, some near term estimates conclude 75 billion physical devices need to be connected to the internet within five years. However, the current design model for IoT devices includes designing each device from scratch. Between the amount of hardware and software design and follow on production work currently required, the design-from-scratch model is not feasible to meet near term demand. The strongest indication of this fact is that even though more than 30 years have passed since it's proposal, IoT technology is still in the concept stage.

The current state of the art IoT technology is based on brand-centric eco systems consisting of design from scratch devices. That is, groups of devices from a single company which share a proprietary operating environment. For example, one company may produce a smart speaker which may include some version of virtual assistant technology. The same company may also produce a camera which allows a user to monitor the interior or exterior, or both, of the user's residence remotely over the internet. The same company may further produce a doorbell system which includes a camera which a user may use to see who is at their door, even from a remote location, when the doorbell is rung. Because the devices are all from a single source, they share a proprietary operating environment or system and are thus guaranteed to interoperate. However, they are also marketed as standalone products. Thus, due to being designed from scratch, many of such smart home products take an extraordinary amount of time to bring to market which elevate the cost of each item of the smart home system.

However, if a consumer favors the features of a smart speaker from one company and a doorbell system from a different company, there is no guarantee the two will interoperate, in fact, the truth is quite the opposite, because of design from scratch and the proprietary operating systems, the two devices are nearly guaranteed to not interoperate.

Making matters worse, not only are the ecosystems proprietary because of the operating system, but the ecosystems are often created haphazardly. A typical scenario includes a company creating a first device. The operating system is often created with only the device itself in mind. Such a first product must be a success in order for the company to raise enough capital to research and develop follow on products. Thus, the first product is optimized for its particular purpose without regard for interoperability with other devices in an ecosystem. If the first product is a success, the company must develop interoperability with the first device, which is almost exclusively optimized for anything but interoperability. Thus, the company must use less than ideal means to establish interoperability in creating an ecosystem of devices. Using such a haphazard system, it is nearly impossible to create an IoT of billions of devices where such devices speak directly to each other using point to point communication, rather than first device to hub to second device communication.

Sometimes the haphazard choices in creating devices for an ecosystem are dominated by economics. Price of any device is always a constraining factor in design of the device. Ultimately, the price may constrain features, including networking features which determine how well a particular device or group of devices will function in an ecosystem. While it may be technically possible to include a myriad of possible wired and wireless connections for the devices in an ecosystem, the cost to do so would lead to pricing that is not competitive in the consumer marketplace. Typically, this leads to the company choosing a single, often wireless, connection method for the ecosystem. The choice of a wireless connection eliminates concerns regarding what wired infrastructure the consumer may have. However, the wireless connection may be suboptimal for any number of reasons, but the consumer is left with no choice. Moreover, the choice of wireless communication almost demands a costly and time-consuming design from scratch model for devices and systems.

For the foregoing reasons, there is a need for an IoT system which has a competitive cost, but offers universal connectivity and devices which are able to not only perform desired functions, but also able to communicate with each other.

### SUMMARY

Disclosed is a system for controlling devices via power line communication. The system may include a controller which sends commands indicative of a user's operation of the controller. The system may further include a first transceiver, which may be electrically connected to the controller. The first transceiver may include a first transmitter. The first transmitter may include a first crystal oscillator circuit. The first crystal oscillator circuit may include a first crystal oscillator powered to transmit a sinusoidal wave at a clock frequency from a first output. The first transmitter may further include a second crystal oscillator circuit. The second crystal oscillator circuit may include a second crystal oscillator, which may be powered to transmit a sinusoidal wave at a transmission frequency and a first phase from a second output. The first transceiver may further include a signal splitter. The signal splitter may be connected to the second output. The signal splitter may split sinusoidal wave to a first signal and a second signal. The signal splitter may output the first signal to a third output and may output the second signal to a fourth output. A phase shift circuit may be connected to the fourth output and the first output. The phase shift circuit may receive the second signal and phase shift the second signal to a second phase. The amount of phase shift may be indexed by a ratio of the clock frequency to the transmission frequency. The phase shift circuit may further include a fifth output for outputting the second signal at the second phase. The first transceiver may further include a switch. The switch may include a first terminal, a second terminal, and a third terminal. The switch may be electrically connected to the third output at the first terminal, the fifth output at the second terminal, and to a baseband signal output transmitting a baseband signal at the third terminal. The switch may operate to switch between alternately outputting the first signal and the second signal as directed by the baseband signal. The output combination of the first signal and the second signal may form a control signal. The switch may further include a transceiver output on a common of the switch for outputting the control signal. The system may further include a power line, which may be electrically connected to the transceiver output. The system may further include one or more electrical outlets electrically connected to the power line. The system may further include one or more devices electrically connected to the one or more electrical outlets. The one or more devices may each include a second transceiver. The second transceiver may include a receiver. The receiver may include a ultra narrow band crystal filter which may filter a bandwidth centered around the transmission frequency. The one or more devices may further include a baseband decoder, which may be electrically connected to the ultra narrow band crystal filter. The baseband decoder may recover the baseband signal from the control signal.

Further disclosed is a method for providing power line communication. The method may include generating a sinusoidal wave using a crystal oscillator. The method may further include splitting the sinusoidal wave in to a first signal and a second signal. The method may further include phase shifting the second signal using a phase shift circuit. The method may further include outputting the first signal and the second, phase shifted signal to a switch. The method may further include forming a control signal by operating the switch to alternate between outputting the first signal and the second, phase shifted signal according to a baseband signal, the first signal and the second, phase shifted signal imparting different phase states to respective portions of the control signal, the respective portions encoding binary information on the control signal. The method may further include outputting the control signal to a power line. The method may further include receiving the control signal on a receiver including an ultra narrow band filter, the receiver being electrically connected to the power line. The method may further include decoding the control signal to executable instructions using the protocol. The method may further include controlling the operation of at least one device based on the decoded control signal.

Further disclosed is a system for providing power line communication. The system may include a smart device which may send commands which may be created according to, and interpreted by, a protocol. The system may further include a first transceiver electrically connected to the smart device. The transceiver may include a first crystal oscillator generating a first signal sent to a first output. The system may further include a signal splitter connected to the first output. The signal splitter may output the signal received from the first output to a second output and may output a copy of the signal received from the first output to a third output. The system may further include a phase shift circuit connected to the third output and including a fourth output, the phase shift circuit may be configured to shift the phase of the copy of the first signal. The phase shift circuit may output the second signal to the fourth output. The system may further include a switch. The switch may have a first terminal which may be electrically connected to the second output and may have a second terminal which may be electrically connected to the fourth output. The switch may further include a transceiver output. The system may further include a first processor, which may be electrically connected to the smart device, the switch, and to a first memory. The first memory may contain the protocol. The first processor may execute the protocol according to the commands from the smart device in order to generate a baseband signal output to the switch. The baseband signal may control the operation of the switch. The system may further include a power line. The power line may be connected to the transceiver output. The system may further include at least one device, which may be electrically connected to the power line. The at least one device may include a first receiver including a first ultra narrow band filter, a second processor, which may be electrically connected to the first ultra narrow band filter, and a second memory, which may be electrically connected to the second processor. The second memory may contain a first copy of the protocol. The system may further include at least one sensor. The at least one sensor may be connected to the power line. The at least one sensor may include a second transceiver. The second transceiver may include a second receiver including a second ultra narrow band filter, and a third processor. The third processor may be electrically connected to the second ultra narrow band filter. A third memory may be electrically connected to the third processor. The third memory may contain a second copy of the protocol. When a user operates the smart device, a command may be sent. The protocol, executing on the first processor, may convert the command to a control signal by sending a baseband signal to the switch. The switch, according to the baseband signal, alternates between outputting a first signal and a second signal in order to encode the control signal with binary information. The control signal may be output to the power line and may be received at the first ultra narrow band filter, second ultra narrow band filter, or both. The control signal may be analyzed by the first copy of the protocol, second copy of the protocol, or both. The decoded control signal may be executed on the second processor, or the third processor, or both. The control signal may be converted to instructions for controlling the at least one device, or providing parameters for the at least one sensor, or both.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of an exemplary PLC system.

FIG. 2A shows a circuit diagram of one embodiment of the crystal oscillator and integrated circuit portions of the transceiver.

FIG. 2B shows a circuit diagram of one embodiment of the switch.

FIG. 2C shows a circuit diagram of one embodiment of a sub-circuit which strips harmonics from the signal output by the switch.

FIG. 3A shows a circuit diagram of the high frequency amplifier portion of the receiver of the transceiver.

FIG. 3B shows a circuit diagram of the amplifier and mixer portion of the receiver of the transceiver.

FIG. 3C shows a circuit diagram of the ultra narrow band filter of the receiver.

FIG. 3D shows a circuit diagram of the amplitude limiting sub-circuit of the receiver.

FIG. 3E shows a circuit diagram of the baseband decoding sub-circuit of the receiver.

FIG. 4 shows a flowchart of a method of providing power line communication.

FIG. 5 shows a diagram of the two crystal oscillator waves at the switch.

FIG. 6 shows one embodiment of a detection method at the receiver.

FIG. 7 shows a flowchart of a method of providing power line control.

FIG. 8 shows a diagram of an emitter wave with information in the form of phase inversion spikes.

FIG. 9 shows a schematic diagram of the smart home system.

FIG. 10 shows a view of a user interface.

FIG. 11 shows a schematic view of a system module.

FIG. 12 shows a flowchart of power line control.

FIG. 13 shows a schematic view of the smart hydroponic system module.

FIG. 14 shows a schematic view of the smart hydroponic system.

FIG. 15 shows a flowchart of operation of the IoT system.

FIG. 16 shows a diagram of a control signal.

FIG. 17 shows a schematic view of an IoT device.

### DETAILED DESCRIPTION

The detailed description set forth below in connection with the appended drawings is intended as a description of the presently preferred embodiment of system and method to transmit commands and data between an external device or application and a translator application on a computing device using text language protocol, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

### Example Power Line Communication Systems

Disclosed is a system and method to control devices with control signals and send data through a powerline. Control signals are sent via power line communication to eliminate the need for a dedicated control cable infrastructure as part of the system. The transmitter on a first end of a powerline may be mirrored by a receiver at another end of a powerline. The receiver may be integrated with the device being controlled or may be a separate component of the system placed between the device to be controlled and the transmitter. Moreover, each of the transmitter and the receiver may be combined to form a transceiver. Indeed, in most embodiments, all such devices are transceivers. At least one transceiver on the system may further include circuitry which allows connection to a wireless device

A controller may be electrically connected to the transceiver, which is, in turn, connected to the power line. The disclosed system may use a building's or even neighborhood's, or even region's pre-existing electrical wiring infrastructure to send control signals. Sending control signals to control components of a system and transfer data among components is commonly called power line communication (PLC). The use of PLC completely eliminates the requirement for creating a cable infrastructure separate from that of the power line in order to carry the data and control signals. In the state-of-the-art non-PLC systems such signals are carried on an ethernet or RJ12 cable infrastructure, or transferred wirelessly. The power line of a device or sensor may be connected to one or more conventional outlets for providing power to the devices or sensors. Each of the one or more outlets may have one or more sockets. One or more devices may plug in to one of the one or more sockets of each of the one or more outlets, thereby electrically connecting the devices to the power line. The power line may carry two separate signals. The first may be a power signal placed on to the powerline by a power company. The second may be a control signal placed on the power line by the transmitter controlled by a user.

The system operates without the power signal acting as a carrier wave or the power signal otherwise being changed in any way to convey information. The power signal and the control signal are completely separate signals. The power signal is typically at 50 Hz or 60 Hz, but may be at other frequencies, depending on the area of the world and the existing power signal conventions there. However, the control signal may have a frequency in the kHz to double or triple-digit MHz range, or even GHz range. Thus, while the two signals exist on the same line, they have limited or no interaction.

The system may generate more than one a sinusoidal wave for use in encoding information. For example, the system may generate two sinusoidal waves at the same frequency and amplitude. The two sinusoidal waves may be generated by two crystal oscillators or may be generated by one crystal oscillator and the signal split to form two signals. To generate each of the two sinusoidal waves, power may be applied to one or more crystal oscillators. Each of the one or more crystal oscillators generate a constant sinusoidal wave in the high kHz to MHz range and with a high Q factor. Importantly, when more than one crystal oscillator is used, crystals of near identical construction may be used so that the crystals generate signals of identical frequencies without a requirement for frequency correction. The crystal oscillators may form part of a larger transmitter. A controller may be connected to the transmitter. One of the two sinusoidal waves may be phase shifted. Each of the waves may be assigned to represent a binary state. Contemporaneously to the generation of the sinusoidal waves, a user may manipulate the controller to send information to an electrically connected processor executing a protocol. The processor uses the protocol to convert the information from the controller in to control information to be encoded on the sinusoidal wave. In order to encode control information using the two sinusoidal waves, the processor, according to the protocol, controls a switch which selectively chooses one or the other of the sinusoidal waves to be serially added to the power line. The control information may be formed in to a baseband signal, such as a digital wave. Thus, it is the switch that is controlled by the protocol, and specifically, the protocol using the baseband signal, to encode the signal with information. One sinusoidal wave having a first phase may be used to represent either one or zero in the protocol, and the second sinusoidal wave may represent the other of the one or zero. The timing of the switching, and thereby the placement and spacing of the phased waves, is done according to command information sent from the controller which is then converted by the protocol. The resulting signal with the encoded control information, called a control signal, is sent through the power line.

Once the control signal is output to a power line, the control signal travels the extent of that power line, and any connected power lines. That is, the control signal will continue on the power line to every terminal in a structure, or even beyond a structure, depending on the design of the power system and the PLC system. In this way, the control signal is broadcast on the power line.

On the receiving end, a device may be plugged in to a socket of the one or more outlets. This electrically connects the device to the power line and allows the device to receive both the power signal and the control signal present on the power line. On the device or an adapter placed between and connected to both the device and the power line, an ultra narrow band filter, as part of a receiver, may filter out all of the signal on the power line except a bandwidth of, for example, 10 Hz or less centered on the transmission frequency of the crystal oscillators. Alternatively, the filter may allow more than a 10 Hz band to pass. Thus, the crystal filter acts as a bandpass filter, and filters only a narrow band centered on the transmission frequency, and allows the rest of the signal to remain on the powerline. Once the control signal is received, the receiver may send the control signal to a processor for analysis by the protocol and decoding back to baseband. The protocol may be stored on a memory in the device or may be stored on the adapter electrically connected to both the power line and the device. According to the protocol, a determination may be made if the control signal is directed to the device, if not, the control signal is ignored. If the control signal is directed to the device, the protocol, executing on a processor, converts the control signal in to executable instructions for controlling the device. A single control signal transmission may include one or more commands. When there is more than one command on the control signal, the commands may be the same command for different devices, or different commands for the same device, or both.

Using this protocol, a single controller and transceiver combination can control multiple individual devices on the system. All of this can be accomplished without being affected by the electronic noise on the power line. The system includes robustness against noise due to several features. First, the ultra-narrow bandwidth, which is at or approaching one Hertz, is only affected by noise which is on that specific frequency. Relatedly, all the energy of the signal is placed on the same single frequency, resulting in a high energy density for the signal. Finally, the information on the signal is encoded by a very specific phase differential. One phase indicating a first binary state, and the other phase representing a second binary state. Unless the noise includes these specific phase changes, the signal may still be detected.

It may be possible for the devices to be controlled autonomously either by automated control signals sent by the controller, or by automated control signals sent from sensors, or both. Each device may have one or more sensors electronically connected to it. In some embodiments of the system, the one or more sensors may be physically integrated with the device. When this is the case, the one or more sensors and the device may share a transceiver. When the one or more sensors are physically separate from the device, for example, when one sensor may be assigned to control two or more devices and electronically connected to each device the sensor is assigned to control. Each sensor may include a transceiver. When the sensor includes a transceiver, the sensor may include instructions stored in a memory on the sensor which may be programmed by the controller. The instructions may be to change the state of the device if certain criteria are detected by the sensor. For example, if the sensor is a temperature sensor and the device a light, and a first temperature is detected, the instructions may send a command dimming the light. If a second temperature is detected by the temperature sensor, the instructions may send a command for turning the light off. The control signal is generated by the temperature sensor in the same manner as the controller, except the commands are drawn from a predetermined list stored on a memory of the temperature sensor, and triggered by conditions detected by the sensor, rather than being triggered manually as with a user's use of a smart device or controller. In addition, the controller may also have a list of automated commands stored in memory. The commands may be triggered by conditions detected by a connected sensor, or may be triggered by other conditions. For example, the command may be tied to a specific time, and the command executes when the clock on the controller reaches that time.

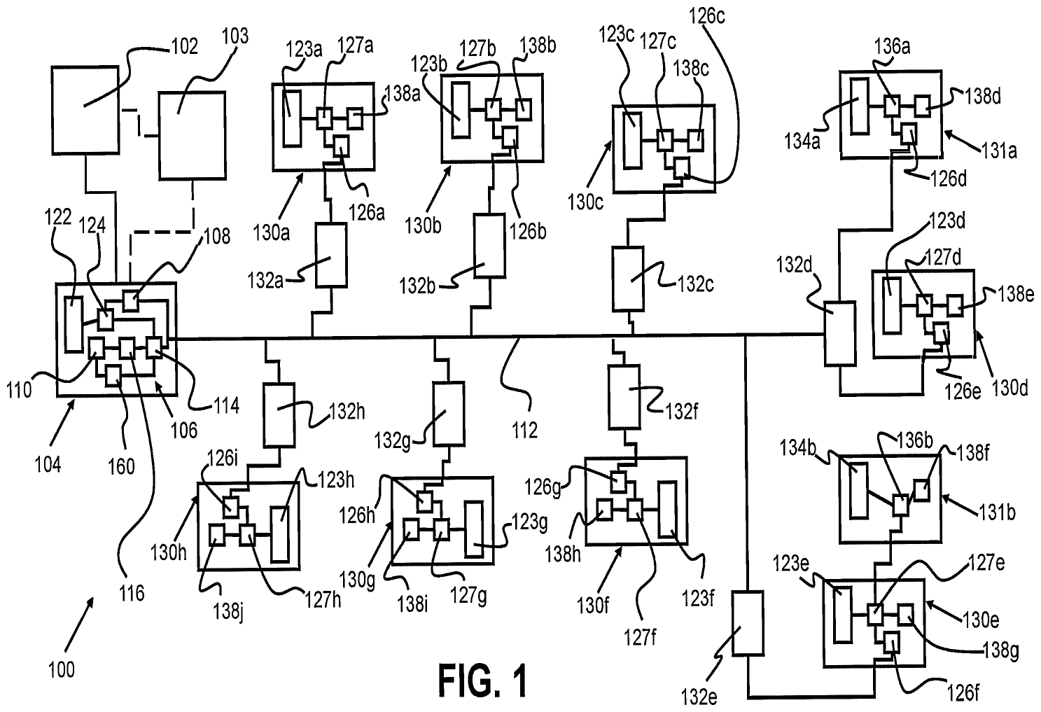

More specifically, as shown in FIG. 1, the system 100 may include a controller 102. As described herein, the controller can include a universal device 102 or other device disclosed herein. The controller 102 may be electrically connected to a device 104, such as a transceiver 104. As shown and described below, the computing device 104 may in some embodiments include a transceiver 104, an emitter 104, a tank valve 104, a computing device 104, a universal device, and/or some other device described herein. The controller 102 may be a programmable logic controller which is connected to the transceiver 104 via a wired connection, for example, a low voltage wired connection as is well known in the art. Alternatively, the transceiver 104 and the controller 102 may be integrated in a single housing. Still further alternatively, or in addition, the controller 102 may be configured to allow control functionality to be passed to an external device. For example, a device running a software package available for personal computers with operating systems such as Microsoft® Windows®, Mac® OS, Unix, Linux, etc. This configuration can allow a user to use a standard computer as an extension of the controller 102. Still further alternatively, a user may use a mobile computing device 103 as an extension of, or in place of, the controller 102. For example, Android®, iOS®, and Windows® based mobile computing devices, such as smart phones and tablets can be used as an extension of, or in place of, the controller 102. A user can install an application onto the mobile computing device 103. The application can allow the mobile computing device 103 to function as an extension of, or in place of, the controller 102.

Regardless of what specific device is utilized as an extension of, or as the controller 102, the user interface may communicate data to a routing device over a communication link. In one embodiment, the communication link can be a wireless communication link, for example, Wi-Fi, Bluetooth®, cellular (3G, 4G, 5G, LTE, etc.), or other suitable wireless communication technology. Alternatively, the communication link could be a wired connection, such as Ethernet or other open and/or dedicated communication protocols. The routing device can be a standard WiFi® local area network (LAN) router for receiving data, and then routing it to a device. The routing device may be integrated with the controller 102.

A touch screen or a display (not shown) on the controller 102 or external computing device 103 may be used as a system interface by a user (not shown). Certain commands which may be executed by the protocol may be indicated by control surfaces on the touch screen. For example, the commands may be indicated by icons or text, or a combination of both. When a user touches the portion of the screen with the control surface, a command is sent in a message to the processor in the transceiver 104, which interprets the command using the protocol.

The transceiver 104 may include a transmitter portion 106 and a receiver portion 108. The primary function of the transceiver 104 is to send signals as directed by the controller 102 through the processor. The transmitter portion 106 of the transceiver 104 sends a signal upon which control information is encoded. The receiver portion 108 of the transceiver 104 receives data signals from the devices or sensors. For example, the devices 130a-h and the sensors may send acknowledgements of messages or self-identification information to the transceiver. For example, devices may include an actuator, a fan, a light, a ballast for a light, a valve, a computer numerical controlled machine, a robot, a conveyor belt, or any other electrical or electrically controlled device. The device 130a-h may include IoT devices and/or other devices described herein.

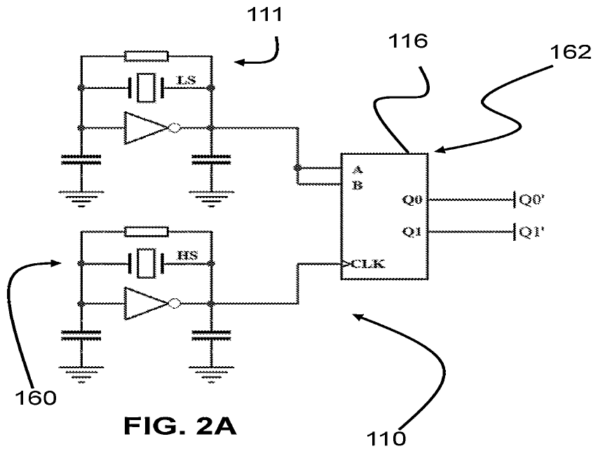

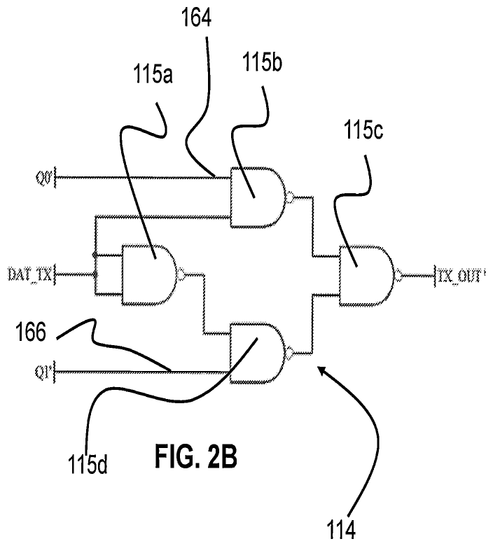

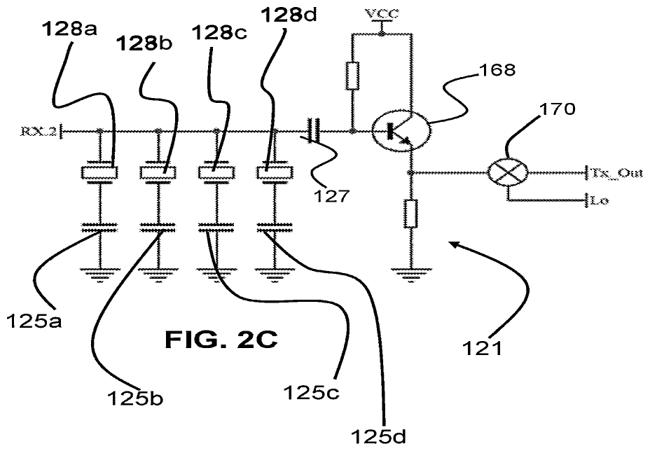

As shown in FIGS. 1 and 2A, the transmitter portion 106 of the transceiver 104 may include a crystal oscillator circuit 110. The crystal oscillator circuit 110 draws power from the power line 112. The power is taken from the power line 112 and may be transformed down by a transformer 138a-j to a lower voltage. The power may also be converted from alternating current to direct current. The voltage may be transformed down, for example, from 110V to 5 V. On a 0.2 A circuit of the power line 112, the 5 V of transformed voltage produces one watt of power for the crystal oscillator circuit 110. As shown in FIG. 2A, each of two crystal oscillators may output a signal. The first crystal oscillator may have a first predetermined primary frequency and amplitude. The second crystal oscillator may have a second predetermined primary frequency and amplitude, with the second primary frequency being a multiple of the first primary frequency. In the embodiment of FIG. 2A, one crystal oscillator produces a signal which is split to form the two sinusoidal waves for forming the control signal. The second crystal oscillator 160 provides a clock signal. The clock signal may be used to control the amount of phase shifting. For example, if a crystal oscillator of 1 MHz is used to produce the signals for transmission, the crystal oscillator for the clock signal may be a multiple of 4 MHz. For example, the crystal oscillator producing the clocks signal may be 16 MHz. Based on the ratio, the transceiver may produce as many as 15 phase shifted signals of the 1 MHz signal, using the 16 MHz clock signal, as is described in further detail below. One or more of the phase-shifted signals, along with the original signal, may be used to encode information, as is described in further detail below. As long the crystal oscillators receive power, the crystal oscillators will continue to output a signal.

Crystal oscillators emit a sinusoidal wave at a frequency determined by their physical structure. Importantly, crystal oscillators, and particularly quartz crystal oscillators, have a very high Q factor. Quartz crystal oscillators are capable of primary frequencies from in the high kHz up to the MHz range. However, higher frequency signals, up in to the GHz range, may be produced by amplifying a harmonic of the primary frequency. Further, this disclosure also contemplates using amplified harmonics of the oscillator, and even potentially frequency modulated amplified harmonics, to allow transmission frequencies as low as 1 Hz. Also, as indicated by the high Q factor, they have a narrow bandwidth relative to their frequency. A typical Q factor for a quartz oscillator ranges from 104 to 106, compared to 102 for an inductor and capacitor, or LC, oscillator. The maximum Q for a high stability quartz crystal oscillator can be estimated as Q=1.6×107/f, where f is the resonant frequency in megahertz.

Another important aspect of quartz crystal oscillators is that quartz crystal oscillators exhibit very low phase noise. In many oscillators, any spectral energy at the resonant frequency is amplified by the oscillator, resulting in a collection of tones at different phases. In a crystal oscillator, the crystal mostly vibrates on one axis, therefore only one phase is dominant. Low phase noise makes crystal oscillators particularly useful in applications requiring stable signals and very precise time references. This is particularly important with this disclosure as the signal from one of the crystal oscillators may be phase shifted by a precise amount. In an embodiment, for optimum operation of the system, the phase shift between the two signals is consistent, as is discussed below in greater detail.

A quartz crystal provides both series and parallel resonance. The series resonance is a few kilohertz lower than the parallel resonance. Crystals below 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit has to be exactly that specified by the crystal manufacturer. Note that these points imply a subtlety concerning crystal oscillators in this frequency range: the crystal does not usually oscillate at precisely either of its resonant frequencies.

Crystals above 30 MHz (up to >200 MHz) are generally operated at series resonance where the impedance appears at its minimum and equal to the series resistance. For these crystals the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit may include additional LC circuits to select the desired overtone.

Crystal oscillators may experience frequency drift over time. Thus, the system may include a frequency correction circuit to compensate for this frequency drift. The frequency modulation circuit may include an ability to detect the incoming signal, and provide data on the frequency of the incoming signal to a processor. The processor may be connected to a memory which stores data on an expected frequency for the signal, and instructions which may be executed on the processor to control the frequency modulation circuit to modulate the incoming signal either up or down to match the expected frequency if the incoming signal is not at the expected frequency. The frequency modulation circuit may extend the operable life of the quartz crystal oscillator by compensating for the expected eventual frequency drift.

As shown in FIGS. 1, 2A, and 2B, a signal from the first crystal oscillator circuit 111 is routed to an integrated circuit 162. Between the first crystal oscillator circuit 111 and the integrated circuit 162, the signal may be split to create two signals. The signal may be split at a location between the crystal oscillator circuit and the integrated circuit 162. As shown in FIG. 2A, the crystal oscillator circuit may be a complimentary metal oxide semiconductor (CMOS) crystal oscillator circuit. Alternatively, the crystal oscillator circuit may be an alternate type of oscillator circuit, with oscillator circuits which operate in series resonance being preferred. The split signal may be input, each on a separate pin, to the integrated circuit 162. As shown in exemplary embodiment of FIG. 2A, the signal is input to the integrated circuit 162 on two pins, pin A and pin B. The integrated circuit 162 may include a phase shift sub-circuit 116 to phase shift one of the input signals. It will be easily recognized by those of ordinary skill in the art that the integrated circuit 162 may include a plurality of phase shift sub-circuits in order to create a plurality of phase shifted signals from at least one of the two input signals. At least one of the two split signals input from the first crystal oscillator circuit to the integrated circuit 162 may pass through the integrated circuit 162 without modification to the amplitude, frequency, or phase of the signal. Moreover, all of the signals, including those that are phase shifted, retain the same frequency.

The signals input on pin A may have a different signal path from the signal input on pin B. For example, the signal input on pin B may pass through a phase shift circuit, and the signal input on pin A passed without passing through a phase shift circuit. Alternatively, the signal from pin A may be phase shifted, and the signal input on pin B may pass without the phase being changed. The integrated circuit 162 may phase shift the second signal many times. For example, using the clock signal of 16 MHz to index the timing of the phase shifts of the 1 MHz signal, the signal may be phase shifted as many as 15 times. This is because 16/1=16. That is, there are 16 possible phase states, or the original state and 15 shifted states in each cycle of the 1 MHz signal which are indexed by the 16 MHz clock signal. The 16 MHz clock signal is produced by a 16 MHz crystal oscillator circuit 160, and input to the clock pin of the integrated circuit 162. Thus, each of the 15 phase shifted signals may be shifted by 22.5 degrees because 360/16=22.5. As discussed above, the frequency oscillation of a crystal oscillator is very stable and accurate. The phase shifting circuit of the present disclosure makes use of this stability and accuracy of the clock frequency crystal oscillator, which is 16 MHz in the above example, as a tool in phase shifting. Because the phase shift circuit indexes the phase shift based on the stable and accurate frequency of the clock crystal oscillator, the phase shifts of the transmission frequency signal are very precise. This precision provides the potential for the use of multiple phase states to create higher data rates.

As discussed above, there may be up to 16 different phase states in the exemplary embodiment. Depending on the crystals used, there may be more than 16 or less than 16 possible phase states. Each of the phase states may be assigned to represent one of two binary states, that is, one or zero. While these phase states may be produced, the system may choose to utilize less than all the phase states that are produced. In the simplest embodiment, the system may use just the unaltered signal and one phase shifted signal.

The phase shifted signal may then be routed to one terminal of a switch 114. As shown in FIG. 2B, the switch 114 may be a combination of logic gates 115a-d, for example not/and (NAND) gates, a fast switching operation, as is well known in the art, or any other switch which is able to provide fast enough switching, including transistors which may act as switches by having a voltage applied to, and then disconnected from, the base of the transistor. The switch may have the general effect equivalent to that of a single pole, dual throw, or SPDT switch. The first of the two incoming signals from the first crystal oscillator may be connected to a first terminal 164 of the switch 114. The second of the two incoming signals from the one or more crystal oscillators may be connected to a second terminal 166 of the switch 114. The output may be connected to the common of the switch 114. The speed of the switch 114 allows for very rapid alternation between the first signal and the phase shifted second signal. By way of example and not limitation, the switch 114 may cycle fast enough to switch 10 times from the first signal to the second signal and back to the first signal in a single cycle of a 40 MHz signal. Thus, there is an opportunity, depending on the protocol used by the system, to send 10 bits of information in a single 40 MHz cycle, all without interference by noise. In this example, the system could generate 400 million bits of information a second on a bandwidth of a single frequency. Alternatively, the switch may cycle fewer than 10 times in a 40 MHz cycle, or more than 10 times in a 40 MHz cycle. Still further alternatively, the crystal oscillator may generate a sinusoidal wave at more than 40 MHz or less than 40 MHz. The operation of the system, including the creation and switching between the sinusoidal waves produced by the crystal oscillators is discussed in great detail below. The transmission portion 106 is electrically connected to a transceiver output 120, which is in turn connected to the power line 112. It will be apparent to one of ordinary skill in the art that the components of the switch may be expanded to allow for the formation of a control signal with any plurality of phase states. While the example shown includes only two logic gates for the passage of the signals to two phase states, one of ordinary skill in the art will recognize that the exemplary configuration of FIG. 2B can be expanded to accommodate many more phase states. For example, even 100 or more phase states may be possible. When designing an embodiment for a plurality of phase states to encode information on a control signal, a balance may be struck between the frequency of the transmission signal and the number of phase states. For example, when lower frequencies are used, more phase states may be used, and when higher frequencies are used, fewer phase states may be used. This is only a general rule, and other factors may cause exceptions.

As shown in FIG. 2C, before the control signal is transmitted, the control signal may be routed through a harmonic elimination and frequency mixing circuit 121. The circuit may include a plurality of crystal oscillators 128a, 128b, 128c, 128d and capacitors 125a, 125b, 125c, 125d in parallel. The control signal passes through one capacitor 127 in series, and then through a transistor 168. Finally, the control signal passes through a signal lamp 170 and is output.

The transceiver 104 may include a memory 122 on which a protocol is stored, and a processor 124 which is electrically connected to the memory, and on which the protocol is executed. The protocol may include a portion which interprets commands sent by the controller 102, or from a transceiver 126a-i in a device 130a-h or a sensor 131a. The protocol, executed by the processor 124, accomplishes the encoding of the output of the crystal oscillator circuit by controlling the switch 114 through a baseband signal.

The protocol is designed so that control signals include an identifier as to which device 130a-h or sensor 131a, 131b the message is directed. If a message is not directed to a particular device 130a-h or sensor 131a, 131b, that device or sensor ignores the message.

The power line 112 may carry standard North American domestic power. That is, 120 V nominal, 60 Hz electrical power. As noted previously, the power line may have electronic noise on it from one or more sources. Alternatively, the voltage may be more than 120V or less than 120V. Further alternatively, the frequency of the power signal may be greater than 60 Hz or less than 60 Hz.

The power line may be carrying single phase or three phase power. If one or more of the three phase conductors are split to provide single phase operation, the disclosed system will still function, because the output routes the control signal to each of the conductor wires on a three-phase system, rather than selectively choosing just one.

One or more devices 130a-h or one or more sensors 131a, 131b, or both, may be connected to the power line 112. In FIG. 1, 8 devices 130a-h are shown, but it will be understood that there could be fewer than 8 devices, or more than 8 devices. The devices 130a-h include a plug (not shown) for connecting the device 130a-h to a conventional outlet socket 132a-h on a conventional outlet. The conventional outlet 132a-h is electrically connected to the power line 112. The devices 130a-h further include a transceiver 126a-c, and 126e-i to receive the control signal from the transceiver 104 or a sensor 131a and 131b when a sensor is not integrated with the device, as is the case with sensor 131b and device 130e, a processor for executing the protocol, a memory for storing the protocol, and a transmitter for sending both self-identification information, and acknowledgement messages to the transceiver, and a transformer which takes power from the power line for powering the temperature sensor, transceiver and the memory and processor which executes the protocol.

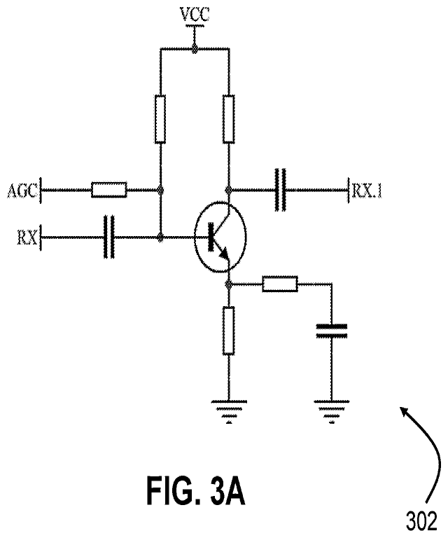

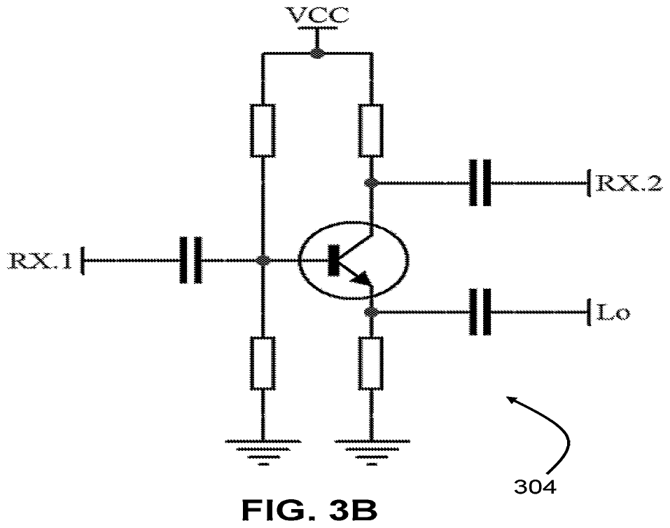

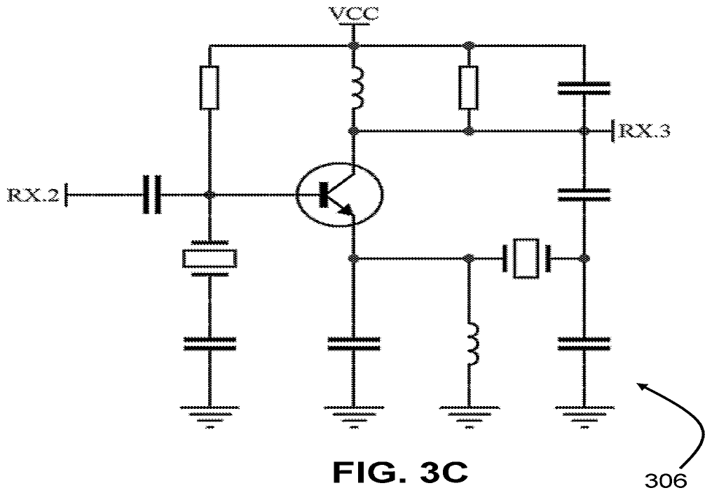

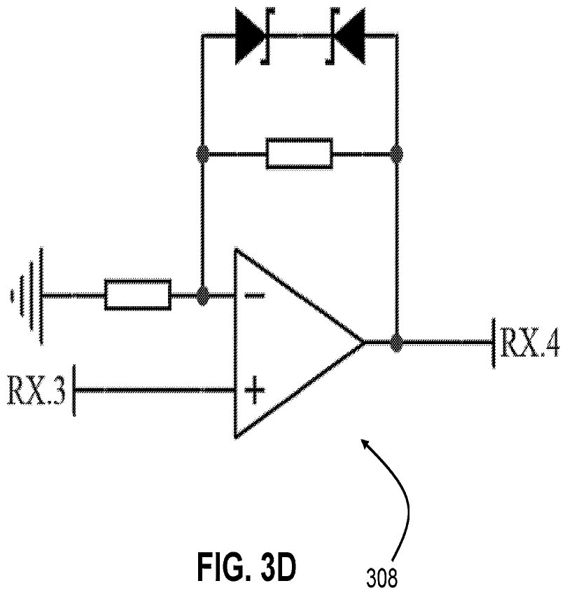

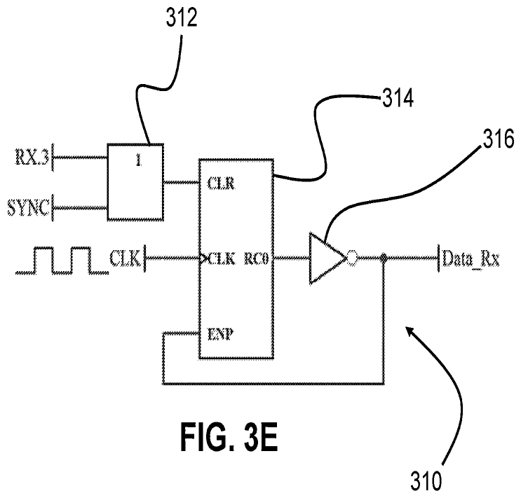

As shown in FIGS. 1, and 3A-3E, the transceiver 126a-i in the devices 130a-h and sensor 131a includes a receiver. The receiver includes a plurality of sub-circuits. As shown in FIG. 3A, a received control signal may first pass through a high frequency amplification sub-circuit 302 of the receiver. As shown in FIG. 3B, a mixing and amplification sub-circuit 304 may be connected to the high frequency amplification sub-circuit 302. As shown in FIG. 3C, connected to the mixing and amplification sub-circuit 304 is an ultra narrow band filter 306. The ultra narrow band filter 306 passes a very narrow band of frequencies, for example, 10 Hz. Just as with the crystal oscillator in the transceiver 104 and transceivers 126a-i, the crystal in the ultra narrow band filter 306 has a very high Q factor. The crystal's stability and its high Q factor allow ultra narrow band filters 306 to have precise center frequencies and steep band-pass characteristics. Thus, the ultra narrow band filter only captures frequencies in an ultra-narrow band centered on the frequency produced by the crystal oscillator circuit 110 and does not allow the rest of the signal on the power line to pass to the transceiver. Thus, the power signal on the power line may be routed to other components in the device to provide power, with the power signal being substantially unaffected. As shown in FIG. 3D, the ultra narrow band filter 306 is connected to an amplitude limiting sub-circuit 308. A control signal passing through the amplitude limiting sub-circuit has the amplitude controlled because too high amplitude in the control signal can cause distortion in the control signal when the control signal is decoded. As shown in FIG. 3E, the amplitude limiting sub-circuit 308 may be connected to a baseband decoding sub-circuit 310. As explained in further detail below, in the baseband decoder sub-circuit 310 may receive the analog signal with varying phase states, and the protocol may be used to measure the phase states against a clock signal as a standard or index. The baseband decoding sub-circuit 310 uses one or more integrated circuits 312, 314 to convert the control signal in to a binary baseband signal. After conversion, the decoded baseband signal is amplified by an operational amplifier 316 and output.

This configuration of the crystal oscillator in the transceiver 104 and crystal filter in the transceiver 126a-i of the device 130a-h plays a large role in eliminating noise. In some systems, noise has been a problem which prohibits the use of PLC. Solutions to the electrical noise problem have been proposed, but all are either burdensome, or costly, or both. For example, a broadband filter may be added to the system to filter out the noise, but the equipment is expensive and bulky, and often required to be wired to a structure's electrical panel. Such solutions merely place post installation band aids on the problem.

The disclosed system does not suffer from electronic noise interfering with the control signal for several reasons. First, the frequency at which the configuration operates is relatively high as compared to the power signal on the power line. In the case that the noise does reach the frequency of the control signal, the noise would have to be equal to, the power of the control signal to compete in the ultra-narrow bandwidth. The ultra-narrow bandwidth is another aspect of the system which provides robustness against noise. The electronic noise would have to be found within the bandwidth, which, were the bandwidth relatively wide, would be likely. However, with the bandwidth so narrow, it is relatively unlikely that electronic noise will be found within the ultra-narrow bandwidth. Moreover, for example, with a one-watt transmission power spread across a very small bandwidth, which may be even a single frequency, the control signal can compete with, if not outright overmatch, most noise. Also, the noise would have to be in phase with both of the crystal oscillator-produced signals. Even if the noise were to be at the same frequency and have the same power as the crystal oscillator produced signals, the control signal may be detectable within the noise unless the noise includes both of the phase states of the control signal. It is extremely unlikely that the noise will include both phase states or change phase as rapidly as the control signal.

Another benefit of the disclosed system and method is the distance over which the control signals of the disclosed system can be transmitted. Because the energy of the control signal is spread across a much narrower bandwidth than typical electromagnetic signals conveying control information, the control signal does not suffer from attenuation in the way that a broader bandwidth signal with the same energy would. As a result, the signal travels over a longer distance than a similarly powered signal with a greater bandwidth. As with most other electrical signals, lower frequency signals travel farther.

Such a transceiver 104, device 130a-h, and sensor 131a and 131b configuration has still further advantages. Because the system 100 operates on such a narrow bandwidth, the system does not interfere with other devices or systems. Moreover, because of the signal's placement in the spectrum, there are very few devices with which the system 100 can interfere. Thus, the system 100 is not only able to deal with the worst noise found on most power lines 112 but is further able to avoid interfering with other systems because the system 100 operates on an ultra-narrow bandwidth.

Sensors, for example, sensor 131b, may be integrated with each of the devices. When integrated, the sensor may share the device's transceiver 126f with the device. Alternatively, the device and sensor may share a transceiver, memory and processor. Still further alternatively, the device and the sensor may each have a dedicated transceiver, memory, and processor. Thus, during operation, all commands may be sent directly to the device and stored in the device's memory for processing by the protocol on the processor, and accessed by the device or sensor, or both.

Alternatively, the sensors may be separate, but electrically connected to the device. Depending on the configuration and characteristics of the device, the device may interfere with the data taking function of the sensor, necessitating physical separation. Moving the sensor away from the device may allow for more accurate or effect data taking, or both more accurate and effective data taking.

The sensor may be a component separate from the device. The sensor may be connected to the powerline. The memory electrically connected to the sensor may store parameters sent by the controller for a corresponding set of commands already saved to a memory of the sensor. The sensor unit may include a power supply which includes a plug to connect to an outlet socket in order to send and receive control signals. The plug also allows the sensor unit to receive a power signal. The power supply may include transformers to decrease the incoming voltage to properly power the components of the temperature sensor unit.

When the sensor is separate from the device, each sensor includes a transceiver identical to that of the transceiver operating in conjunction with the controller. The sensor may include instructions stored in a memory on the sensor which may have certain parameters of commands set by the controller. For example, the controller may set a particular temperature as a parameter. Based on the temperature, there may be a command to dim the device, for example, a light fixture, or at a different and higher temperature, to turn the light fixture off. The control signal is generated by the sensor, for example, a temperature sensor, in the same manner as a control signal is generated by the controller, except the commands are drawn from a predetermined list of commands stored on the memory of the sensor, and triggered by conditions detected by the sensor. For example, a temperature sensor may have a command to turn off a device, specifically a light fixture, if a temperature of 95 degrees Fahrenheit is detected by the sensor. Thus, rather than the commands being determined manually, the commands are determined autonomously based on predetermined conditions.

It may also be the case that a system, which may include light fixtures among multiple kinds of devices, uses a combination of the above sensor configurations, which may be, for example, a sensor for temperature alone, or may be a combination sensor which includes a temperature sensor among several kinds of sensors which can detect several kinds of data. That is, some light fixtures may have a temperature sensor integrated with the light portion, other light fixtures on the system may have a temperature sensor integrated with the ballast, and still other light fixtures may be controlled by a separate temperature sensor as an individual component of the system.

Regardless of whether a single type of device and sensor arrangement is used, or a combination of types of device and sensor arrangements are used, all of the device and sensor arrangements are directed to achieving the purpose of decentralization of sensing and control. As described above, prior art systems all have centralized sensing and control. With as much as one sensor for every device, much more precise control can be achieved because the sensor may provide localized control for the device in a closed loop fashion, completely apart from the control provided by the main controller.

The disclosed PLC system may operate as a hybrid system. That is the PLC system may simultaneously operate as both an open loop system with portions of subsystems operating as a closed loop system. Any device may be controlled both by the controller in open loop, and by the assigned sensor, if any, in closed loop. It should be noted, however, that the protocol is designed such that the controller and sensors do not send the same commands at the same time. Rather, control may be split between the two depending on which of the controller and sensor is best positioned to issue the command.

The disclosed system, both because of the method of control, and because of the physical arrangement of the components of the system, offers considerable robustness against failures. A device in the disclosed system will continue to function under the control of both, or either, of the controller and the assigned sensor should any other device in the system cease functioning. Depending on the location and type of failure in a pure open loop system, the entire system may cease functioning. Further, if the sensor is integrated in to the device, even multiple failures elsewhere in the system may not affect the flow of commands from the sensor to the device. Even if the sensor is a separate component, there may be a very short distance of powerline between the device and the sensor. The copper wire of the powerline on which the signals are carried has very low failure rates, making a failure of the wire between a sensor and a device highly unlikely. Thus, even with a longer span of wire between the controller and any devices than there may be between a sensor and a device, failures of the wire are very unlikely. Because the commands may be sent from either the sensor or the controller, total failure of the system is highly unlikely. Even in the event of the failure of the controller or an individual sensor, the controller or other sensors will still operate devices assigned to those sensors. Almost all sensors also have extremely low failure rates, making the most likely source of failure the controller. However, failures of the controller are easier to detect than any other failure on the system, for reasons explained below. This lowers the risk of the operation of the system.

As noted above, the transceiver 104 includes both a transmitter 106, and a receiver 108. The transmitter 106 includes the combination of the crystal oscillation circuit 110, and the switch 114. The receiver 108 of the transceiver 104 is the same as the receiver 126a-i described for the devices 130a-h and the sensor 131a. Further, the transmitter integrated with device and sensor transceivers 126a-i is the same as the transmitter 106 described for the transceiver 104 operating in conjunction with the controller. The transceiver 126a-i on the devices 130a-h and sensor 131a may be used to send acknowledgements of commands sent to the devices 130a-h and sensors 131a, 131b back to the transceiver 104. The receiver 108 on the transceiver 104 may be used to receive identification information from the devices 130a-h and sensors 131a, 131b which are electrically connected to the transceiver 104, the controller 102, or both. Further, the receiver 108 on the transceiver 104 may be used to receive the acknowledgements from the devices 130a-h and sensors 131a, 131b. For example, when a sensor 131a is a component of the system separate from a device, the sensor 131a may include a transceiver 126d. The transceiver of the sensor is identical to that of the transceiver operating in conjunction with the controller and the transceiver integration with a device.

In operation, the system may function in two distinct modes, but the modes may operate in parallel, or contemporaneously. The first mode may be characterized by control signals being sent exclusively from the controller. The second mode may be characterized by essentially autonomous control of the devices by the system's sensors, and secondarily, autonomous control signals from the controller. That is, it is possible that the controller and the sensors may send control signals contemporaneously, or even almost simultaneously. The two modes are primarily distinguished by user control in the case of signals from the controller and autonomous control based on predetermined parameters stored in the sensors and controller. In the case of the first mode, after the controller 102 is powered up, woken up from sleep mode, or connected via a wired or wireless connection to the transceiver 104, the controller 102 may interrogate the devices 130a-h and sensors 131a, 131b electrically connected to the power line 112. This is done by the controller 102 sending a command to the devices 130a-h and sensors 131a, 131b to respond to the command with identification information. If a controller 102 is already connected, the protocol may require that a device 130a-h or sensor 131a, 131b which is later connected to the system 100 send self-identification information to the controller 102.

Because the controller 102 is able to identify each device 130a-h or sensor 131a, 131b, or combination thereof, connected to the controller 102 individually, future commands may be specified as being for a particular device 130a-d, 130f-h or separate sensor 131a or combination device/sensor 130e/131b. Because these commands contain information identifying the device 130a-d, 130f-h or separate sensor 131a, or combination device/sensor 130e/131b to which they are directed, the commands will be ignored by other devices or sensors, or combination device/sensor. Alternatively, some or all of the devices 130a-d, 130f-h or separate sensors 131a, or combination device/sensor 130e/131b could be specified by a command. Thus, groups of devices, for example, a group of light fixtures in a specified area of a structure, may be controlled as a group. Alternatively, the separate sensors may be controlled as a group apart from the devices, or vice versa. Or, if, for example, all devices and separate sensors need to be powered down, this can also be accomplished through the above identification of all devices 130a-h and separate sensors 131a, or combinations thereof. In fact, there may be a particular identifier in the protocol specifying that a command is for all components of the system, including devices 130a-h, separate sensors 131a, and combinations thereof. Such an identifier prevents the protocol from requiring that each device 130a-h and sensor 131a, if any are separate components, have an individual identifier separately listed in a command.

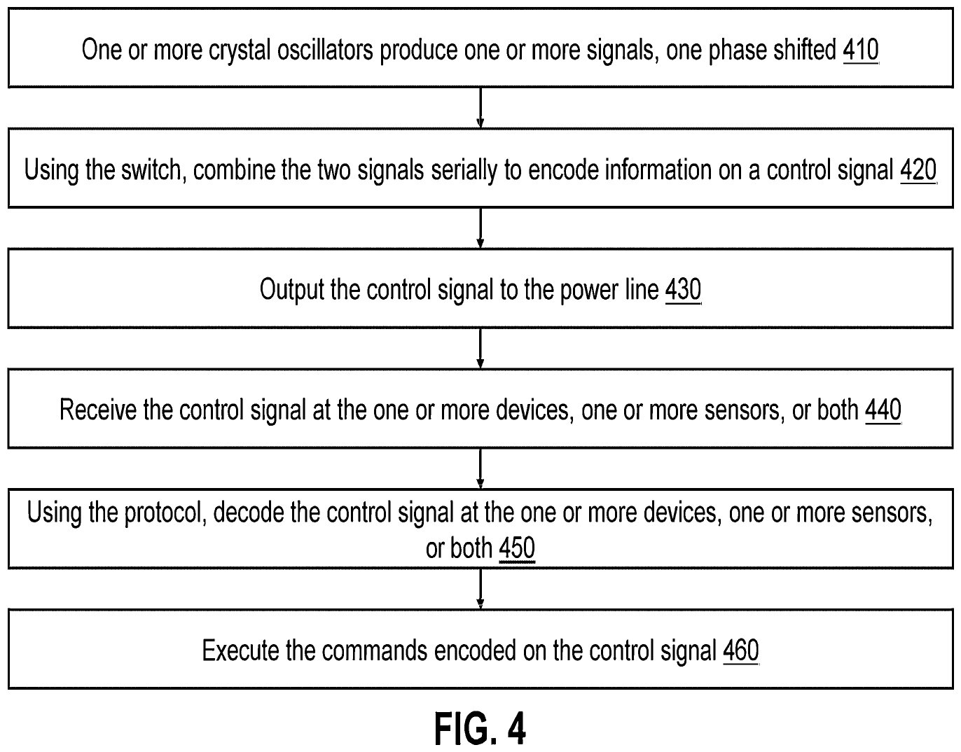

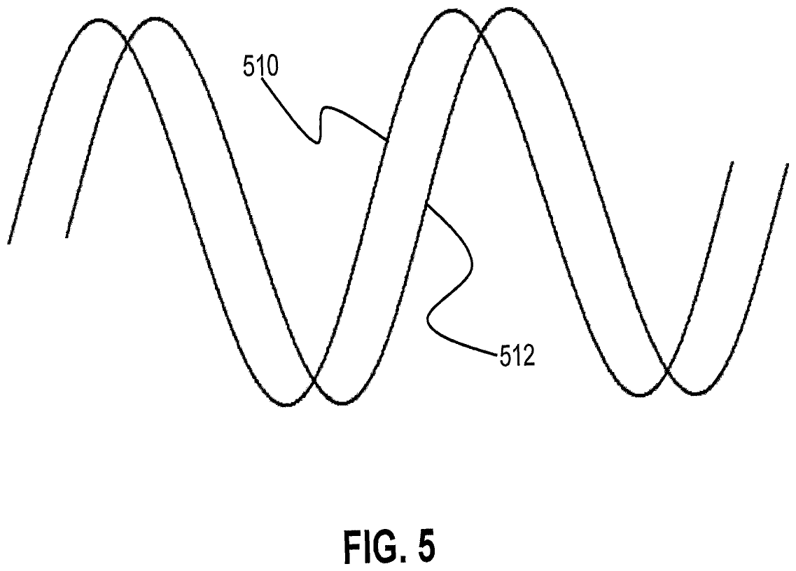

In order to send commands to one or more devices 130a-h with integrated sensors, or to separate sensors operating in mode one, commands from the controller 102 are converted to control signals by the protocol. The control signal has two parts. The first part is a first sinusoidal wave, which is generated continuously by one or more crystals in one or more crystal oscillation circuits, as shown in Step 410 on FIG. 4. The second part is a second sinusoidal wave which is generated either by the same one or more crystal oscillation circuits or another of the one or more crystal oscillation circuits. This second sinusoidal wave is then phase shifted so it is out of phase with the first sinusoidal wave. The two sinusoidal waves may be out of phase, for example, by 22.5 degrees. Alternatively, the first sinusoidal wave and the second sinusoidal wave may be out of phase by as less than 22.5 degrees or more than 22.5 degrees. As shown in FIG. 5, the non-phase shifted sinusoidal wave 510, and the phase shifted sinusoidal wave 512, are electronically routed to a switch. Using the switch controlled by the protocol, control information may be encoded on an output signal. The information may be encoded by creating an output wave which alternates between the first sinusoidal wave and second sinusoidal wave according to a baseband signal which is input to the switch 114 from a processor. The output of the switch 114, which is shown in Step 420 of FIG. 4, includes portions of the two signals which are in two different phases. The portions may be in series. Thus, the first sinusoidal wave may form a section of the control signal, and be followed by a section formed by the second sinusoidal wave, and vice versa. Alternatively, as is discussed above, there may be a plurality of phase states, for example, 16. Each of the phase states may be assigned to represent one of the two binary states, and in the exemplary embodiment of 16, provide 16 bits of data per cycle of the transmission frequency. After generation, each of the sinusoidal waves may be fed to the connected switch 114, as is described above. The switch 114 is also connected to a processor 124 which executes the protocol. Based on the command signals from the controller, which are converted by the processor to a baseband signal using the protocol, the processor 124, using the baseband signal, directs the switch 114 to switch between the first sinusoidal wave and the second sinusoidal wave. Information is encoded on the output sinusoidal waveform by varying the timing between the first sinusoidal wave and the second sinusoidal wave from the crystal oscillator circuit 110 by switching the switch 114 from the first signal to the second, phase shifted signal and back to the first signal, and back again, in order to encode the information carried by the baseband signal. The phase shifting allows one of the signals, or sinusoidal wave, to represent a first binary state, for example zero. The second signal, or sinusoidal wave, may represent a second binary state, for example one, or vice versa. The spacing of portions of the wave having a certain phase may represent control information as well. For example, if a portion of the output signal is twice as long as another portion, the first portion may represent two of the first binary states in a row. All of the above encoding may be decoded by the protocol when the output signal is received by the receiver. The output wave including the control information may be called a control signal.

As discussed above, the timing for the portions of a signal of a certain phase may be set to a fractional portion of the wave cycle of the crystal oscillator frequency by the protocol. For example, the control signal may be timed so that a portion of the signal is never any less than a full cycle. Thus, where a signal of a first phase 510 appears on the output wave, the protocol may interpret the first phase 510 as indicative of a first binary state, while uninterrupted, addition cycles representing additional instances of the same binary state. When the output wave changes phase to a second binary state 512, a cycle of the second phase may be indicative of a second binary state. In this embodiment of the encoding one phase is assigned a binary state, and always indicates that binary state.

Alternatively, a change in phase may represent a first binary state, while no change in phase from, for example, cycle to cycle, represents another binary state. It is contemplated that the phase may change more often than a single cycle, and less often than a single cycle. It is the change of cycle, or, as in the previous embodiment, the presence of a certain phase that is indicative of the binary states. Single cycles are used as examples herein to make the operation of the system easier to understand, but one of ordinary skill will instantly recognize that there is no requirement to use whole cycles for operation of the system. In this second embodiment, a change is indicative of a first binary state. Thus, after a first cycle, the phase may change. The change may be indicative of a binary state, for example one. The phase remains unchanged for another cycle. This lack of change may be indicative of a second binary state, for example, zero. Thus, two different phase states may seem to represent different binary states, but, in reality, it is the presence or absence of change between phases that represent the different binary states.

In either of the above protocol definitions, the protocol may interpret the control signal as a series of binary states, with the binary states representing either a one or a zero. Commands may be defined by the protocol from differing sequences of ones and zeros, or binary sequences.

Sequences of ones and zeros may form data or commands that can be analyzed and converted by the protocol. Therefore, the sequences of ones and zeros may be said to form a baseband signal. As an example, the devices and separate sensors may identify themselves using a binary code of a set number of digits. The identification may be a shorter or longer sequence than those of the commands. The protocol may define a preliminary indicator which indicates the start of a command or data string, and a second indicator which indicates the command or data send is complete and requests that the device or sensors to which the command was directed send an acknowledgement to the controller. Similarly, the protocol may use binary sequences to define commands. Each of these may be included in the baseband signal. By way of example and not limitation, the protocol may define that “1001” may correspond to a command to turn a device 130a-k, to 100% of any adjustable range. For example, if the device is a light, that means turning on the light to max brightness, or if the device is a fan, turning that fan on to max revolutions per minute. A control signal of “1000” may correspond to a command to turn the device 130a-k off. The data and commands may be packaged as messages that include the preliminary indicator that a command or data follows, headers which identify to which fans the command is directed, the command, and an indicator that the command is complete and a request for acknowledgement of the command by the device or sensor.

It is important to note that when the first sinusoidal wave and second sinusoidal wave are combined in serial segments to create the control signal, the frequency of the first and second sinusoidal waves are unaffected. That is, the frequency of the control signal is that same as that of the first sinusoidal wave and second sinusoidal wave. Rather, only the phase changes within the control signal when the first sinusoidal wave and second sinusoidal wave are combined in segments to create the control signal. Thus, the control signal is output to the power line with the frequency unaffected.

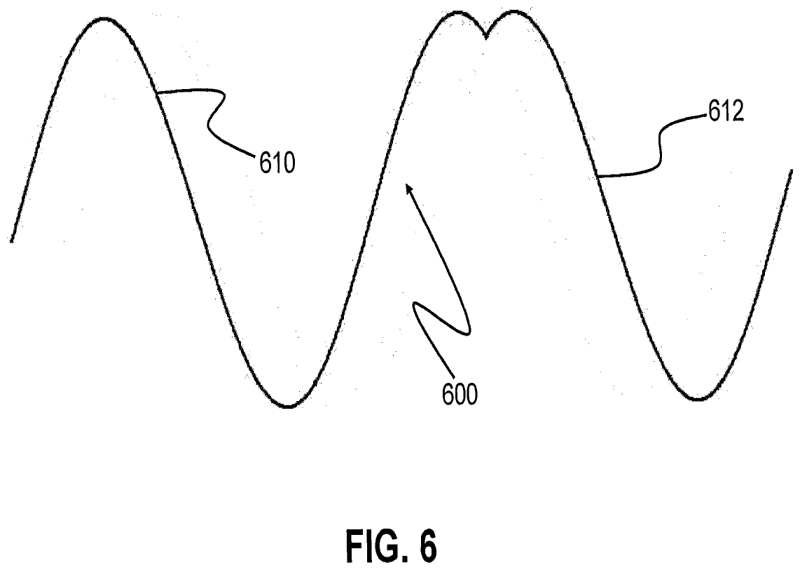

Once the control information is encoded by using the switch to alternate the sinusoidal waves generated by the crystal oscillator circuit 110, the control signal is output to the power line 112 as is shown in Step 430 of FIG. 4. The output is a broadcast throughout the power line 112. An exemplary control signal 150 is shown in FIG. 6. The control signal 600 includes a plurality of phases 610, 612. It will be noted that the segments of differing phases 610, 612 are placed at protocol-defined intervals along the control signal 600, rather than one phase change after another with no space in between, which would make detection extremely difficult with current detector technology, although such spacing is still theoretically possible.

Alternatively, the transceiver may include additional circuitry which may either be bypassed or may receive an output of the signal of the transmission crystal oscillator. This circuitry may be configured to amplify a harmonic frequency of the signal output by the transmission crystal oscillator. For example, the harmonic may be an order of magnitude higher in frequency than the resonant frequency of the transmission crystal oscillator. Other harmonics and the primary frequency may then be stripped from the signal. This amplified and higher frequency signal may then be split and encoded as described above. Further, the smart device or controller may have a setting which indicates which devices and which sensors are close and which are at a distance. The higher frequency may be used for faster response and higher data rates where possible, and the lower frequency signal may be used for devices and sensors which are out of range of the higher frequency transmission, ensuring the control signal is received by the devices and sensors at a greater distance.

Start up control signals may be sent using mode one operation by the controller, and may include power on signals for designated devices. The power on signals may be refined predetermined modifications. For example, in the case of a device with a range of settings, for example, a light, the predetermined modification may ramp up the brightness of the light produced by the light fixtures during power on. The same may be done during power off by including a predetermined modification ramping down the brightness of each light fixture during power off. Ramping up and ramping down may use the dimming function of the lights to gradually power them on from a lower brightness to a greater brightness, and gradually power the lights down from a greater brightness to a lower brightness, and then off. These predetermined modifications may be of great benefit when the lighting system is used for indoor agriculture, because the ramping simulates sunrise and sunsets, allowing the lighted crops to receive the same type of light they would if the crops were in an outdoor environment. Alternatively, all of the above control signals may come from the controller during both mode one and mode two of the operation of the system.

Commands or parameters may also be sent using mode one to the sensors, without regard to whether the sensors are integrated with a device or are separate components on the system. For example, the controller may send data parameters for the sensor's native commands. For example, if the sensor is a temperature sensor, the sensor may include a dimming command. The dimming command may specify dimming to a lower wattage when a temperature parameter is met. By way of example and not limitation, the controller may specify that the temperature sensor should send a dimming command to the light to 50% of the current wattage if a temperature of 80 degrees Fahrenheit is detected by the sensor. The sensor may further include a shutdown command. The shutdown command may turn off the light fixture if the sensor assigned to the light detects a temperature indicated in by parameter sent by the controller. By way of example and not limitation, if the temperature parameter sent by the controller is 90 degrees Fahrenheit, and the sensor detects a temperature of 90 degrees Fahrenheit, the sensor may send a command to the lighting fixture to shut down. If the sensor is a separate component of the system, the controller may send control signals to the sensor assigning devices to which the sensor is to send control signals. Because the controller is sent identification information by all the system components, a user may identify the components and make the assignment using the controller. Alternatively, the controller may include algorithms which assign sensors to devices automatically.

On the receiving end, the control signal 600 is received on the receiving circuit 108. After being amplified, the control signal is passed to the ultra narrow band filter of the device transceiver 126a-k or sensor transceiver, if sensors are implemented as separate components on the system, as is shown in Step 440 of FIG. 4. The ultra narrow band filters may operate to bandpass a bandwidth of 20 Hz or less centered on the transmission frequency of the crystal oscillator from the signal on the power line. Naturally, the rest of the signal on the power line may be unaffected so that the power on the power line may be used to power devices and sensors on the system. The 20 Hz or less bandwidth captures the control signal because the phase changes do nothing to spread the bandwidth of the original sinusoidal wave generated by the crystal oscillator. That is to say, the signal is not frequency modulated. Alternatively, the filter may pass a bandwidth of well than 20 Hz or more than 20 Hz.

Following the filtering, the protocol stored on a memory 123a-h, and executing on a processor 127a-h on each of the devices 130a-h, the protocol stored on a memory 123a-h, and executing on a processor 127a-h on each of the devices, the protocol stored on a memory 134a, 134b, and executing on a processor 136a, 136b on each of the sensors, or integrated device and sensor, detects and analyzes the information in the control signal 150. The control information encoded on the control signal 150 may be decoded and converted by the protocol as is shown in Step 450 of FIG. 4. Based on where the detected phase states, and the timing of the control signal in each phase state, the control signal may be converted to a series of binary digits, or a series of ones and zeros. The conversion may then be used to determine instructions which are executable to give commands to the devices and to set parameters for the sensors, either integrated with the devices or as separate components, as is shown in Step 460 of FIG. 4, and described above. Alternatively, the center point may be defined in the positive portion of the cycle or the negative portion of the cycle. Alternatively, if only two phase states are used, the detector may detect unchanged, or base phase state signals, and assign a first binary state to those signals, as required by the protocol, and assign a second binary state to any other signals which have differing phase states. If multiple phase states are used, then each may be assigned one of the two binary phase states, and the detector may determine at which phase state the signal is located, and assign a binary state to that signal detected at that particular phase state according to the protocol.

The use of ultra-narrow bandwidth and phase changes to encode data and unaltered frequency sinusoidal wave in the control signal provides further robust protection against interference by electrical noise on the power line 112. In order for electrical noise on the system to interfere with the control signal the electrical noise would need both reach in to the narrow bandwidth on which the oscillator is transmitting, and the filter is receiving, and to change phase as the control signal 600 does. This kind of rapid phase change combined with a fixed amount of offset is uncommon in electrical noise, including the noise typically found on power lines. Thus, in addition to all the other ways the system 100 eliminates electrical noise which may affect the control signal 600, even the manner in which the information is encoded to the control signal 600 provides robustness against interference by electrical noise.

After the control signals are sent and received, the system may primarily operate in mode two. Mode two is characterized by a combination of open and closed loop operation, but relies primarily on mode two operation. As described above, the sensors may send command signals using the same encoding as the control signals from the controller. However, no user direction is required when mode two signals are sent by sensors. Based on the parameters provided during mode one, each sensor may automatically send control signals to the assigned devices if any of the stored parameters are reached. Per the example given above for the temperature parameters, if the temperature sensor detects a temperature of 80 degrees Fahrenheit, the temperature sensor may send a control signal containing a dimming command to the temperature sensor's assigned light fixtures. Alternatively, if the temperature sensor detects a temperature of 90 degrees Fahrenheit, the temperature sensor may send a control signal containing a shut-down command to the temperature sensor's assigned light fixtures. All commands which have a temperature as a parameter may be native to the temperature sensor, with the controller providing the parameter of the precise temperature at which the commands should be sent during phase one.

Simultaneously during mode two operation, the controller may still send commands which include time as a parameter. The controller 102 includes a clock function, which may be set to local time. The controller may also include a timing function to control when the devices are powered on and when they are powered off. This function is particularly useful in indoor agriculture, because when sent to lights, it allows the lights to simulate daylight during a 24-hour day cycle. The timing function includes sending a control signal to the one or more light fixtures to power on at a predetermined time, and to power off at a predetermined time. The powering on may be customized by ramping the brightness of the one or more light fixtures up to simulate a sun rise, as described above. Similarly, the powering off may be customized by ramping the brightness of the one or more light fixtures down to simulate a sun set, which is also described above. Both the ramping time, and the starting brightness, as well as the amount of increase in wattage, and therefore resulting brightness, may be parameters which may be set by a user. These parameters may be built in to the controller and will operate essentially autonomously during phase two. As one of ordinary skill in the art will readily recognize, such parameters may be applied to other devices as well. For example, the timing may be used to control a sprinkler system, or a residential or commercial HVAC system.

Of course, the parameters for either the controller or the sensor may be changed at any time by a user. This may be necessary for any number of reasons, but is not required unless there is a component failure. Failure detection is discussed in detail below.

The devices 130a-h or sensors 131a, 131b may, contemporaneously to any control signals from the controller 102, send an acknowledgement of the control signal back to the controller 102, or to the sensor if the system is in mode two operation. The receiver portion of the transceiver 104 or the transceiver on the sensor receives the acknowledgement, the processor on either of the transceivers converts it using the protocol, and, accordingly, the controller 102 or the sensor does not resend the command. In the event that the transceiver 104 or the transceiver on the sensor does not receive the acknowledgement, the protocol operating on the controller 102 or sensor directs the corresponding transceiver to send the command again after a pre-determined time interval. This pattern continues until the acknowledgement is received from the device 130a-k or sensor to which the control signal was sent.

In some circumstances, it may be possible that the device did not send an acknowledgement because the device never received the message. For example, if system is operating in the two or three-digit MHz range or higher, and the signal has to travel through any appreciable distance of wire, the signal may be attenuated by the wire, or by other factors, and not reach the device. In some embodiments the system may have a second set of crystal oscillators which operate at a lower frequency. The instructions stored in memory may include that the next message be sent using this lower frequency. Lower frequency signals generally have better range in every medium. This is also true in the case of electrical wire. Thus, if the initial control signal failed to reach the device, the lower frequency signal is all but guaranteed to reach the device. Thus, if the device fails to respond to the control signal, sending an acknowledgement back to the transceiver operating in conjunction with the controller, or the transceiver associated with a sensor, the user can be all but certain that the reason is that the device is suffering a failure, rather than the signal failing to reach the device. Thus, the device can be checked and serviced in such an instance. If the transceiver operating with the controller receives a acknowledgement from the transceiver associated with the device, then the transceiver operating with the controller will continue to communicate with the device on the lower frequency.

Alternatively, the crystal oscillator circuit may include components which allow access to harmonics of the crystal. The crystal oscillator circuit may use a lower frequency harmonic of the crystal rather than a second crystal to generate the lower frequency control signal. The harmonic may be amplified to a level equivalent to that of the non-harmonic signal. In either this embodiment or the previous embodiment, the entire system may switch to operate on the lower frequency. Alternatively, the controller and transceiver with which it operates may continue to communicate at both frequencies, depending on the device with which it is communicating. Those devices that don't respond on the primary, higher frequency signal, but do respond to the secondary, lower frequency signal, will continue to communicate on the lower frequency signal, both for control signals and acknowledgements. This split frequency system has the advantage of ensuring communication with as many devices as possible while using higher frequencies where possible to give the data rates for the maximum possible number of devices on the system.

Should the controller 102 fail catastrophically, the controller 102 will no longer send commands. While this is certainly a failure, it is not catastrophic for the system as a whole, because such a controller failure is both easy to detect, and the devices on the system may continue to function under the control signals available to the one or more sensors on the system. A controller 102 failure is easy to detect because the controller 102 is typically used by the user to send commands from time to time, and may further automated commands, as described above. A user is likely to notice if automated commands are not executed. Thus, if, for example, the system includes lights, and all of the lights fail to turn on or off, there is likely a failure in the controller.

As disclosed, through the decentralized control, the lighting system has internal robustness against the risk of a failure of a central controller. The one or more sensors on the system will continue to function. In embodiments where the one or more sensors include instructions to issue control signals to the devices on the system, the sensors will continue to do so. Thus, if, for example, the lights on a system are not turned off due to a controller catastrophic failure, the temperature may get high enough where the temperature may be detrimental to the plants of an indoor agricultural system. However, even if the controller 102 has failed, the one or more temperature sensors may dim the lights as the first predetermined temperature is reached, and then may shut the lights off as the second predetermined temperature is reached. In this way, the decentralized control prevents damage to the plants. If the light fixtures don't come back on, the controller 102 failure is again easily detected and rectified by replacing the controller and starting back up.

It may be possible that, over time, each of the crystal oscillators may have some drift in the transmission frequency. The crystal oscillator circuit may include portions which are directed to correcting for any frequency drift. The crystal oscillator circuit may include components which allow the transmission frequency to be tuned. The tuning may be done manually, through adjustments of the circuit by a user. Alternatively, the crystal oscillator circuit may include components which monitor the transmission frequency and adjust the transmission frequency automatically back to a pre-determined transmission frequency if there is any drift detected.

Alternatively, or in addition, the crystal filters may be tuned. Similar to the crystal oscillation circuit, the crystal filter may be tuned manually or automatically. For example, if the transmission frequency of the transceiver operating with the controller beings to drift, the transmission frequency may be adjusted to match where it was previously, so that only a single transceiver has to be adjusted, and not several. Alternatively, the crystal filters may be tuned to match the drifted signal of the controller transceiver. As a still further alternative, both the controller transceiver may be tuned. For example, either the controller transceiver or the device transceiver may be automatically tuned. For example, the crystal filter may include an auto center function where the crystal filter scans a bandwidth of possible frequencies, and when it finds a transceiver signal, centers on that signal.

### Example Applications of Power Line Communication

Disclosed is a system and method to control devices via power line control (PLC). Although the system and method may be applied to any device, this disclosure concentrates on electric fans for the reason that fans are often difficult to control with PLC due to the amount of electrical noise that fans generate in the power line. The system may include a controller, an emitter, a power line, one or more outlets, and one or more smart fans. In some embodiments, the controller and emitter may be integrated in a single unit.

The controller is electrically connected to the emitter, which is, in turn, connected to the power line. The power line may be connected to one or more conventional outlets for providing power to electronic devices. Each of the one or more outlets may have one or more sockets. One smart fan may plug in to one of the one or more sockets of each of the one or more outlets, thereby electrically connecting the smart fan to the power line.

A sinusoidal wave is generated by the emitter. To generate the sinusoidal wave, power may be applied to a crystal oscillator. The crystal oscillator generates a constant sinusoidal wave in the high kHz (e.g., 250-1000 kHz) to MHz (2-8 MHz) range and with a high Q factor.

A user may then manipulate the controller to cause information to be sent to a processor executing a protocol. According to the protocol, the processor converts the information from the controller in to control information to be encoded on the sinusoidal wave. In order to encode control information on the sinusoidal wave, the processor, according to the protocol, cycles a switch which routes the sinusoidal wave through either a phase inversion circuit or through a bypass. When the signal is routed through the phase inversion circuit and then rapidly returned to the bypass, a momentary phase inversion, or phase inversion spike, in the sinusoidal wave is created. The timing of the switching, and thereby the creation and spacing of the phase inversion spikes, is done according to command information sent from the controller and then converted by the protocol. The resulting signal with the added control information, called a control signal, is sent through the power line.

Once the control signal is output to a power line, the control signal travels the extent of that power line and any connected power lines. That is, the control signal will continue on the power line to every terminal in a structure, or even beyond a structure, depending on the design of the power system and the PLC system. In this way, the control signal is broadcast on the power line.

On the receiving end, a smart fan may be plugged in to a socket of the one or more outlets. This electrically connects the smart fan to the power line, and allows the smart fan to receive both the power signal and the control signal. On the smart fan, a crystal filter electrically connected to the power line filters out a bandwidth of 500 Hz or less centered on the transmission frequency of the crystal oscillator, and band passes the remaining power line signal. Once the control signal is received, the control signal is sent to a processor for analysis by the protocol, which is stored on a memory. According to the protocol, a determination is made if the control signal was directed to the smart fan analyzing the control signal, if not, the control signal is ignored. If the control signal is directed to the smart fan, the protocol, executing on a processor converts the control signal in to executable instructions for controlling a fan motor on the smart fan.

Using this protocol, a single controller and emitter combination can control multiple individual smart fans on the system without being affected by the electronic noise produced by the smart fan on the power line.

More specifically, with further reference to FIG. 1, the system 100 may include a controller 102. The controller 102 may be electrically connected to an emitter 104. The controller 102 may be a programmable logic controller which is connected to the emitter 104 via a wired connection, for example, a low voltage wired connection as is well known in the art. Alternatively, the emitter 104 and the controller 102 may be integrated in to a single housing. Alternatively, or in addition, the controller 102 may allow for control functionality to be passed to an external device. For example, a software package available for personal computers running operating systems such as Microsoft® Windows®, Mac® OS, Unix, Linux, etc. This can allow a user to use a standard computer as an extension of the controller 102. Optionally, a user can use a mobile computing device as an extension of, or in place of, the controller 102. For example, Android®, iOS®, and Windows® based mobile computing devices, such as smart phones and tablets can be used as an extension of, or in place of, the controller 102. A user can install an Application onto their mobile computing device. The Application, can allow the mobile computing device to function as an extension of, or in place of, the controller 102.

A touch screen on the controller 102 may be used as a system interface by a user (not shown). Certain commands which may be executed by the protocol may be indicated by visual representations on the touch screen. For example, the commands may be indicated by icons or text, or a combination of both. When a user touches the portion of the screen with the visual representation, a command is sent in a message to the processor in the emitter 104, which interprets the command using the protocol.

The emitter 104 can be a transceiver. The primary function of the emitter 104 is to send signals as directed by the controller 102. The transmitter portion 106 of the transceiver sends a control signal upon which control information is encoded. The receiver portion 108 of the transceiver receives data signals from the smart fans. For example, the devices 130a-k may be smart fans and may send acknowledgements of messages or self-identification information to the emitter 104.

A transmitter portion 106 of the emitter includes a crystal oscillator circuit 110. The crystal oscillator circuit 110 draws power from the power line 112. The power is taken from the power line 112 and transformed down from about 110V to about 0.1V. In a circuit providing 10 amps of current on the power line 112, a 0.1V of transformed voltage produces one watt of power for the crystal oscillator circuit 110. The power can be applied to a crystal oscillator which can produce a sinusoidal signal. The signal produced by the crystal oscillator is amplified by an amplifier and the resulting signal is both transmitted from and fed back in to the crystal oscillator. As long as the crystal oscillator receives power, the crystal oscillator will continue to output the wave signal.

Crystal oscillators emit a sinusoidal wave at a frequency determined by their physical structure. Crystal oscillators, and particularly quartz crystal oscillators, have a very high Q value. Quartz crystal oscillators are capable of primary frequencies in the high kHz up the MHz range. Also, as indicated by the high Q value, they have a narrow bandwidth. A typical Q value for a quartz oscillator ranges from 104 to 106, compared to perhaps 102 for an inductor and capacitor, or LC, oscillator. The maximum Q for a high stability quartz oscillator can be estimated as Q=1.6×107/f, where f is the resonant frequency in megahertz. The purer the crystal, the higher the Q value, as imperfections, which are measured in parts per million, cause the bandwidth to spread. At some point the cost to reduce the imperfections in parts per million during creation of the crystal no longer justifies the resulting performance increase. Thus, crystal oscillators with imperfections in the range of 50 parts per million (PPM) to 0 PPM of imperfections are contemplated, with imperfections in the range of 35 PPM to 2 PPM being preferred.

Another important aspect of quartz crystal oscillators in light of the disclosure is that crystal oscillators exhibit very low phase noise. In many oscillators, any spectral energy at the resonant frequency is amplified by the oscillator, resulting in a collection of tones at different phases. In a crystal oscillator, the crystal generally vibrates on one axis, therefore only one phase is dominant. Low phase noise makes crystal oscillators particularly useful in applications requiring stable signals and very precise time references.

A quartz crystal provides both series and parallel resonance. The series resonance is a few kilohertz lower than the parallel resonance. Crystals below 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit may need to be exactly the one specified by the crystal manufacturer. Note that these points imply a subtlety concerning crystal oscillators in this frequency range: the crystal does not usually oscillate at precisely either of its resonant frequencies.

Crystals above 30 MHz (up to >200 MHz) are generally operated at series resonance where the impedance appears at its minimum and equal to the series resistance. For these crystals the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit usually includes additional LC circuits to select the desired overtone.

The signal created by the crystal oscillator circuit 110 is next routed to a switch 114. The switch 114 may be a fast switching operation, as is well known in the art, or any other switch which is able to provide fast enough switching, including transistors which may act as switches by having a voltage applied to the base, or having the voltage disconnected. The switch may have a common which receives the sinusoidal wave from the crystal oscillation circuit, and on the opposite side of the switch, a first terminal and a second terminal. Connected to the first terminal of the switch 114 is a phase inversion circuit 116. Connected to the second terminal of the switch 114 is a bypass. The speed of the switch 114 allows for very rapid alternation between the bypass and the phase inversion circuit. By way of example and not limitation, the switch 116 may cycle fast enough to switch 100 times from the bypass to the phase inversion circuit and back to the bypass in a single cycle of a 20 MHz signal. Thus, there is an opportunity, depending on the protocol used by the system, to send 100 bits of information in a single 20 MHz cycle, all without interference by noise. In this example, the system could generate 2 billion bits of information a second. Alternatively, the switch may cycle fewer than 100 times in a 20 MHz cycle, or more than 100 times in a 20 MHz cycle. Still further alternatively, the crystal oscillator may generate a sinusoidal wave at more than 20 MHz or less than 20 MHz. The operation of the system, including the creation and modification of the sinusoidal wave produced by crystal oscillator is discussed in detail below. The transmission portion 106 is electrically connected to an emitter output 120, which is in turn connected to the power line 112.

The emitter 104 may include a memory 122 on which a protocol is stored, and a processor 124, which is electrically connected to the memory, and on which the protocol is executed. The protocol may include a portion which interprets commands sent by the controller 102, or from a transceiver 126a-k in a smart fan 130a-k. The protocol, executed by the processor 124, accomplishes the encoding of the sinusoidal wave of the crystal oscillator circuit by controlling the switch 114.

The protocol is designed so that messages include an identifier as to which smart fan 130a-k the message is directed. If a message is not directed to a particular smart fan 130a-k, that device ignores the message.

The power line may carry standard North American domestic power. That is, 120 V nominal, 60 Hz electrical power. As noted previously, in addition to the power signal, the power line may have electronic noise on it from one or more sources. The power line may be carrying single phase or three phase power. If the three phase conductors are split to provide single phase operation, the system still functions, because the output routes the control signal to each of the conductor wires on a three-phase system. Because of the large separation of frequencies between the control signal and the power line signal, the control signal and power signal do not interact. Once the control signal is output to a power line, the control signal travels the extent of that power line, and any connected power lines. That is, the control signal will continue on the power lines to every terminal in a structure, or even beyond a structure, depending on the design of the power system and the PLC system. In this way, the control signal is broadcast on the power line or lines. Additional details about PLC is provided in International Patent Application Publication No. WO 2021/107961, which is hereby incorporated by reference herein for all purposes.

One or more smart fans 130a-k may be connected to the power line 112. In FIG. 1, 11 smart fans 130a-k are shown, but it will be understood that there could be fewer than 11 smart fans, and more than 11 smart fans. The smart fans 130a-k include a standard plug (not shown) for connecting the smart fan 130a-k to a conventional outlet socket 132a-k on a conventional outlet. Thus, the conventional outlet socket 132a-k is electrically connected to the power line 112. The smart fans 130a-k further include a receiver to receive the control signal from the emitter, a processor for executing the protocol, a memory for storing the protocol, and a transmitter for sending both self-identification information, and acknowledgement messages to the emitter, and a transformer taking power from the power line for powering the smart portion of the smart fan, specifically the transceiver and the memory and processor which executes the protocol.

The transceiver 126a-k in the smart fan 130a-k uses a crystal filter to receive control signals sent over the power line. Just as with the crystal oscillator in the emitter 104, the crystal filter has a very high Q factor. The crystal's stability and its high Q factor allow crystal filters to have precise center frequencies and steep band-pass characteristics. Typical crystal filter attenuation in the band-pass is approximately 2-3 dB. Thus, the crystal filter only captures frequencies in an ultra-narrow band centered on the frequency produced by the crystal oscillator circuit 110, and allows the rest of the signal on the power line to pass. Thus, the power signal on the power line may be routed to other components in the fan to provide power.

This configuration of the crystal oscillator in the emitter 104 and crystal filter in the transceiver 126a-k of the smart fan 130a-k plays a large role in eliminating noise. As noted above, noise has been a problem which prohibits, at least in some cases, the use of power line control. Fans are known to generate more electronic noise than many appliances or other electrical devices, if not the most electric noise of any type of device. First, the frequency at which the configuration operates is relatively high for a power line. Most power lines noise is not generated at the frequency of the control signal. In the case that the noise does reach the frequency of the control signal, the noise would have to be nearly equal to, or equal to, the power of the control signal to compete in the ultra-narrow bandwidth. With the one watt transmission power spread across a very small bandwidth, the control signal can compete with, if not outright overmatch, most noise.

Another benefit is the distance over which the control signals of the disclosed system can be transmitted. Because the energy of the control signal is spread across a much narrower bandwidth, the control signal does not suffer from attenuation in the way that a broader bandwidth signal with the same energy would. As a result, the signal is able to travel over a longer distance than a similarly powered signal with a greater bandwidth.

Such an emitter 104 and smart fan 130a-k configuration has still further advantages. Because the system 100 operates on such a narrow bandwidth, the system does not interfere with other devices or systems. Moreover, because of the placement in the spectrum, there are very few devices with which the system 100 can interfere. Thus, the system 100 is not only able to deal with even some of the worst noise found on most power lines 112, but is further able to avoid interfering with other systems because the system 100 operates on an ultra-narrow bandwidth.

As noted above, the emitter 104 includes both a transmitter portion 106, and a receiver 108. The transmitter portion 106 includes the combination of the crystal oscillation circuit 110, the switch 114, the phase inversion circuit 116, and the bypass. Thus, the emitter 104, includes a transceiver. The receiver 108 of the emitter 104 is the same as that described for the smart fan 130a-k. Further, the transmitter on the smart fan transceiver 126a-k is the same as the transmitter portion 106 described for the emitter 104. The transceiver 126a-k on the smart fan 130a-k may be used to send acknowledgements of commands sent to the smart fan 130a-k back to the emitter 104 or controller 102, or both. The receiver 108 on the emitter 104 may be used to receive identification information from the smart fans 130a-k which are electrically connected to the emitter 104, the controller 102, or both. Further, the receiver 108 on the emitter 104 may be used to receive the acknowledgements from the smart fans 130a-k.

In operation, after the controller 102 is powered up, woken up from sleep mode, or connected via a wired or wireless connection to the emitter 104, the controller 102 may interrogate the smart fans 130a-k electrically connected to the power line 112. This is done by the controller 102 sending a command asking the smart fans 130a-k to provide identification information. If a controller 102 is already connected, the protocol may require that a smart fan 130a-k, which is later connected to the system 100 to send self-identification information to the emitter 104 through the power line 112 and on to the controller 102 through either the wired or wireless connection.

Because the controller 102 is able to identify each smart fan 130a-k connected individually, future commands may be specified as being for a particular smart fan 130a-k. Because these commands contain information identifying the smart fan 130a-k to which they are directed, the commands will be ignored by other smart fans 130a-k. Using this aspect of the protocol, each smart fan 130a-k can be controlled separately. Alternatively, some or all of the smart fans 130a-k could be specified by a command. Thus, groups of smart fans, for example, a group of smart fans in a specified area of a structure, may be controlled as a group. Or, if, for example, all fans need to be powered down, this can also be accomplished through the above identification of all smart fans 130a-k. In fact, there may be a particular identifier in the protocol specifying that a command is for all smart fans 130a-k. This prevents the protocol from requiring that each smart fan 130a-k have an individual identifier separately listed in a command.

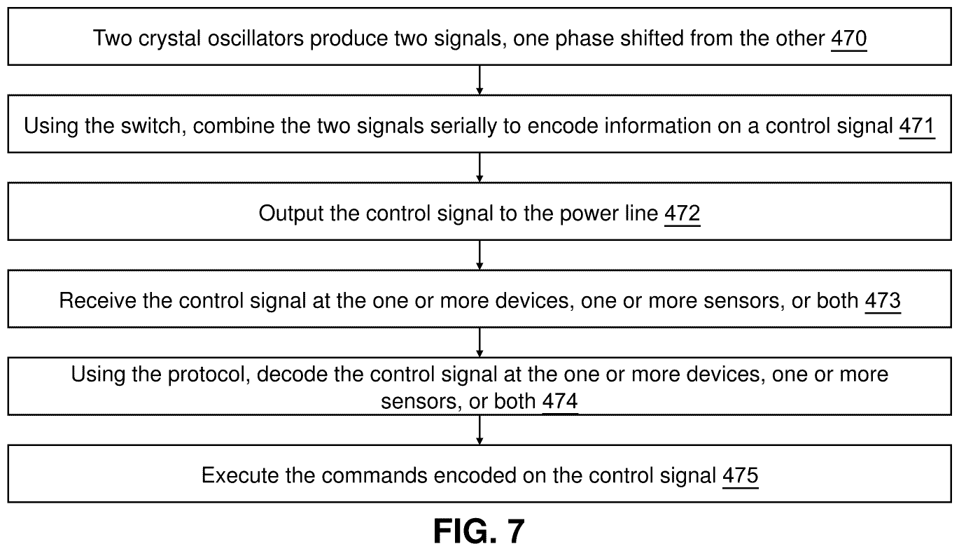

In order to send commands to one or more smart fans 130a-k, commands from the controller 102 are converted to control signals by the protocol. The control signal has two parts. The first part is the sinusoidal wave, which the crystal oscillation circuit generates continuously, as shown in Step 470 on FIG. 7. The second part is control information which is encoded on the sinusoidal wave, which is shown in Step 471 of FIG. 7. After generation, the sinusoidal wave is fed to the connected switch 114, as is described above. The switch 114 is also connected to a processor 124 which executes the protocol. Based on the command signals from the controller, which are converted by the processor using the protocol, the processor 124 directs the switch 114 to switch between the phase inversion circuit 116 and the bypass. Information is encoded on the sinusoidal waveform generated by the crystal oscillator circuit 110 by switching the switch 114 from the bypass to the phase inversion circuit 114 and back to the bypass in order to create phase inversion spikes at defined intervals on the sinusoidal wave. The phase inversion spikes and their spacing represent control information which may be decoded by the protocol. The sinusoidal wave combined with the control information may be called a control signal.

When the control information is added to the sinusoidal wave to create the control signal, the amplitude and frequency of the sinusoidal wave may be unaffected. Rather, only the phase is changed in creating the phase inversion spikes. Thus, the control signal is output to the power line with the frequency unaffected from when the sinusoidal wave was generated by the crystal oscillator. Also, the amplitude is not changed, as the only amplification takes place within the crystal oscillation circuit.

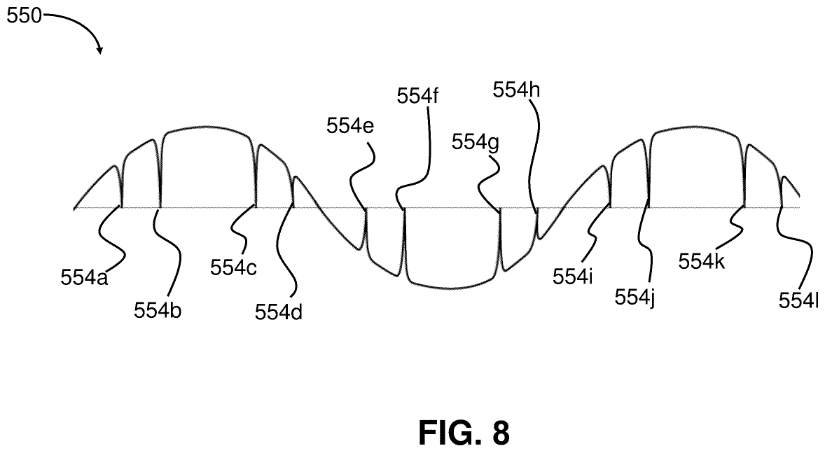

Once the control information is encoded on the sinusoidal wave generated by the crystal oscillator circuit 110, the control signal is output to the power line 112 as is shown in Step 472 of FIG. 2. The output is a broadcast throughout the power line 112. An exemplary control signal 550 is shown in FIG. 8. The sinusoidal wave that carries the control signal 550 includes a plurality of phase inversion spikes 554a-1. It will be noted that the phase inversion spikes 554a-1 are placed at intervals along the sinusoidal wave to create the control signal 550, rather than one phase inversion spike 554a-1 after another with no space in between. In some embodiments, there is no change in amplitude or frequency for the phase inversion spikes 554a-1; rather, only the phase is inverted.

On the receiving end, the control signal 550 is received on the crystal filter of the smart fan transceiver 126a-k as is shown in Step 473 of FIG. 7. The crystal filter filters out all of the signal on the power line except a bandwidth of 500 Hz or less centered on the transmission frequency of the crystal oscillator. Naturally, the rest of the signal on the power line may be band passed so that the power on the power line may be used to power the smart fan. The 500 Hz or less bandwidth captures the control signal because the phase inversions do little to spread the bandwidth of the original sinusoidal wave generated by the crystal oscillator. That is to say, the signal is not frequency modulated. The sinusoidal wave is generated and then phase inverted at intervals, rather than being a carrier wave that is then either frequency or amplitude modulated. Thus, the sinusoidal wave's very high Q factor, in the 105 or 106 range, is retained, which shows that the control signal includes the sinusoidal wave's narrow bandwidth. The protocol stored on a memory 134a-k, and executing on a processor 136a-k on the smart fan 130a-k detects and analyzes the information in the control signal 550. The control information encoded on the control signal 550 may be decoded and converted by the protocol as is shown in Step 474 of FIG. 7. The conversion may result in instructions which are executable to control the fan motor 138a-k as is shown in Step 475 of FIG. 7.

The use of phase inversion and the spacing thereof in the control signal provides further robust protection against interference by electrical noise on the power line 112. In order for electrical noise on the system to interfere with the control signal the electrical noise would need to invert its phase as the control signal 550 does. This kind of rapid phase inversion is uncommon in electrical noise, including the noise typically found on power lines. Thus, in addition to all the other ways the system 100 eliminates electrical noise which may affect the control signal 550, even the manner in which the control signal 550 is added to the sinusoidal wave generated by the crystal oscillator circuit provides robustness against interference by electrical noise.

The timing for phase inversions may be set to a fractional portion of the wave cycle of the crystal oscillator frequency by the protocol. Thus, where a phase inversion spike 554a-1 appears on the sinusoidal wave carrying the control signal 550, the protocol may interpret the phase inversion spike 554a-1 as indicative of a first binary state, while uninterrupted portions of the sinusoidal wave are interpreted as a second binary state. In this way, the protocol may interpret the control signal as a series of binary states, with the binary states representing either a one or a zero. Commands may be defined by the protocol from differing sequences of ones and zeros, or binary sequences.

Sequences of ones and zeros may form data or commands that can be analyzed and converted by the protocol. As an example, the smart fans may identify themselves using a binary code of a set number of digits. The identification may be a shorter or longer sequence than those of the commands. The protocol may define a preliminary indicator which indicates the start of a command or data string, and a second indicator which indicates the command or data send is complete and requests that the smart fan or fans to which the command was directed send an acknowledgement. Similarly, the protocol may use binary sequences to define commands. For example, the protocol may define that “1001” may correspond to a command to turn a smart fan 130a-k to full speed, while “1000” may correspond to a command to turn the smart fan 130a-k off. The data and commands may be packaged as messages that include the preliminary indicator that a command or data follows, headers which identify to which fans the command is directed, the command, and an indicator that the command is complete and a request for acknowledgement of the command by the smart fan.

Based on the command encoded in the control signal 550, the smart fan 130a-k to which the control signal command was directed may, for example, make an adjustment or power off. Additionally, the smart fan 130a-k may contemporaneously send an acknowledgement of the command back to the emitter 104. The receiver portion of the emitter 104 receives the acknowledgement, and, accordingly, does not resend the command. In the event that the emitter 104 does not receive the acknowledgement, the protocol directs the emitter 104 to send the command again after a pre-determined time interval. This pattern continues until the acknowledgement is received from the smart fan or fans 130a-k given the command.

### Example Smart Home Systems

Disclosed is a smart home system and method. The smart home system may include a computing device. By way of example and not limitation, the computing device may be a smart phone, a tablet computer, or a laptop computer. Alternatively, the computing device may be any device which provides a display to display control surfaces, and allow the control surfaces be manipulated to cause the smart home system to send commands. The computing device may be connected to a universal device through a wired or wireless connection. The universal device may connect to one or more system modules through another wired or wireless connection. The universal device and the system modules may use an open source protocol to communicate. Each of the one or more system modules may be connected to a peripheral device. The peripheral devices may be from a plurality of manufacturers. None of the peripheral devices need any logic circuits, because rather than each of the peripheral devices having logic circuits, many portions of which are redundant, the functions of the logic circuit are apportioned to the universal device and the one or more modules. The circuits and components common to all the traditional smart devices on the smart home system and their corresponding functions may be apportioned to the computing device or universal device, or both. The unique circuits and components to the traditional smart devices on the smart home system and their corresponding functions may be apportioned to the corresponding system module. By way of example and not limitation, the peripheral devices may include lights, fans, outdoor sprinkler valves, garage door openers, automated blinds, thermostats, doorbell camera systems, and medical devices.

The computing device, either when it is connected to the smart home system, or when a new peripheral device is connected to a smart home system which already has a computing device connected, may send a message to the universal device requesting initialization information regarding connected system modules and peripheral devices. The initialization information may include the type of system module, what controllable functions the system module has, and what the parameters are in controlling the functions.

The initialization information may be used by a software application stored on the computing device to create a user interface. The user interface may have control surfaces for controlling the parameters of the functions.

The system module may have more than one function. By way of example and not limitation, the device may have a first function which responds to a binary control parameter. This control parameter may be, for example, state of operation control parameter which includes the values “on” and “off.” The device may have a second function which has a control parameter which includes a range of values. For example, the range of values may be a wattage value, or may be an indexed number, for example 1 to 10, used to designate levels of resistance in a circuit, to control a volume level.

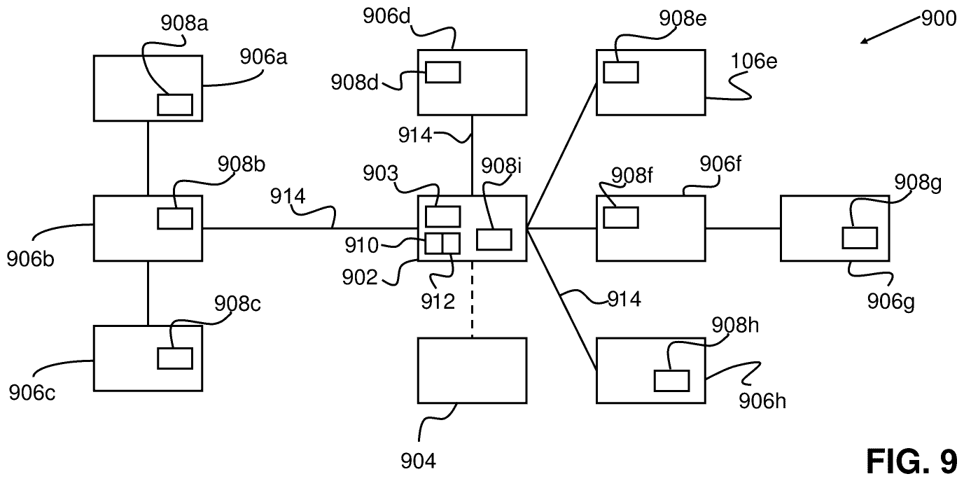

More specifically, with reference to FIG. 9, the smart home system 900 may include a computing device 904. The computing device 904 may be a mobile computing device. For example, Android®, iOS®, and Windows® based mobile computing devices, such as smart phones and tablets. The computing device 904 may also be a laptop or a desktop computer. The software application running on the computing device 904 may be an application, often abbreviated as an “app,” programmed to operate on, for example, Android®, iOS®, or Windows® operating systems, or a combination of more than one of the operating systems, or may be a software package available for personal computers running operating systems such as Microsoft® Windows®, Mac® OS, Unix, Linux, etc., or a combination of more than one of the operating systems.

Alternatively, or in addition, the smart home system 900 may include a control panel 903 hardwired to, or integrated with, the universal device 902. This configuration may allow a user to use the computing device 904 as an extension of the control panel 903, or to operate the system from the control panel 903. Thus, the control panel 903 and the computing device 904 can be used in parallel, for example, to operate two different system modules 906a-h contemporaneously. The control panel 903 may be a programmable logic controller or the like. Alternatively, the control panel 903 could be a tablet computer hardwired to the universal device 904. The control panel 903 may include a wireless module which allows the control panel 903 to communicate with the computing device 904, and allows for pass through of computing device 904 messages to the universal device 902. For ease of explanation, when used in the remainder of this disclosure, the term “universal device,” is understood to include the controller 903, among other hardware, unless specifically stated otherwise.

The computing device 904 may send messages to the universal device 902. The universal device 902 may include programming which allows the universal device 902 to interoperate with computing devices 904 using various operating systems. Because of this feature, not only may more than one computing device 904 be used with the system, but each computing device 904 may have a different operating system. This interoperation is part of what makes the universal device 902 operate in a universal manner. The universal device 902 may receive messages from, and send messages to, any computing device 904 which a user wishes to place in to operation on the smart home system 900, making the universal device 902 agnostic in regard to the interoperability with computing devices 904 based on any of a number of operating systems.

The universal device 902 performs several functions. First, the universal device 902 converts the messages of the computing device 904 to the protocol. The universal device 902 includes instructions which allow the universal device 902 to recognize which operating system the computing device 904 is using, and establish bilateral communication with the computing device 904. Then, based on the messages sent by the computing device 904, the universal device 902 converts the messages in to the protocol used for communication between the universal device 902 and the system modules 906a-h. Second, the universal device 902 provides routing functions for messages sent by the computing device 904 to the various system modules 906a-h. Third, the universal device 902 provides device management. When a new system module 906a-h is added, the universal device 902 may detect the addition of the system module 906a-h and request initialization information. The initialization information may include an identification code for the system module 906a-h, what functions the system module 906a-h has, and what the control parameters for the functions are. The universal device 902 may store this information in a non-transient media memory. The universal device 902 may also pass the initialization information to the computing device 904 in a message.

Physically, the universal device 902 may be a standalone device or may be integrated with the controller 903 as discussed above. The universal device 902 and controller 903 combination may include a screen which allows a user to view data passed from the system modules 906a-h and to generate commands to be sent to the system modules 906a-h for action on the peripheral devices to which the system modules 906a-h may be electrically connected. The universal device 902 may include a number of circuits and components which would be common to the traditional peripheral devices the smart home system 900 integrates. By way of example and not limitation, both a thermostat and a sprinkler control system may include display screens. Rather than have a display screen on both of the sprinkler control system and the thermostat, the display on the computing device 904 or on the universal device 902, or both, provide a display which performs all the display tasks for the smart home system 900. Thus, this one display on the computing device 904 or the universal device 902 replaces the screens on the traditional sprinkler system and thermostat. The universal device 902 may include other circuits or components that would be common to all traditional peripheral devices. The inclusion of these components and circuits in the universal device 902 or computing device 904 or both, through either hardware or software, integrates tasks which would normally be performed by a traditional peripheral device in to the universal device 902 and the computing device 904.

The system modules 906a-h include circuits and components which perform tasks which are either unique to a traditional peripheral device, or only included in a minority of traditional peripheral devices. When the circuits and components, and therefore the corresponding functions, are either unique to a traditional peripheral device, or only included in a minority of traditional peripheral devices, they cannot be effectively integrated in to a hub of a smart home system 900. The hub of the smart home system 900 may include the computing device 904 and the universal device 902. Stripped down to these unique circuits and components, each system module 906a-h takes a non-traditional form. In fact, either portions, or an entirety of, traditional peripheral devices may be replaced by the system modules 906a-h, which perform the functions unique to the traditional peripheral devices while the universal device 902, or the combination of the universal device 902 and computing device 904 perform functions common to all the traditional peripheral devices. At a minimum, the computing device 904 or the universal device 902, or both in combination, take over some of the tasks previously performed by the traditional peripheral device.

An exception to the distribution of common functions to the hub and unique functions to the system modules 906a-h is the transceivers 908a-i on both the universal device 902 and the system modules 906a-h. These transceivers 908a-i may be nearly identical. The transceivers 908a-i may contain the transmission circuit and the receiver circuit described in detail below. The transceivers 908a-i are included in both the universal device 902 and each of the system modules 906a-h because communication cannot be distributed to a single device, particularly when the communication is bi-directional as the protocol requires.

The system modules 906a-h, in some circumstances, may take a traditional peripheral device, which was not “smart” upon manufacture and transform the traditional peripheral device in to a smart device. By way of example and not limitation, a sprinkler system is traditionally a standalone system which may not be controlled by a mobile device, or as part of an integrated smart home system. However, using a system module 906a-h to replace the traditional controller of the sprinkler system, the sprinkler system is readily integrated in to the disclosed smart home system 900. The pump included in a swimming pool filtration system may also be added to the smart home system 900 in a similar way. The addition of atypical devices to the smart home system 900 is another way in which the smart home system 900 creates universality.

Moreover, the system modules 906a-h for traditionally non-smart devices, for example, lamps, can, in addition to making the lamp part of the smart home system, add smart features to the lamp. For example, a dimming feature, controllable by the computing device 904 and the universal device 902, may be added to the system module 906a-h for the lamp. The system module 906a-h could use a variable resistor, the level of which may be set by a control surface on a user interface created by a software application, to vary the wattage to the lamp. Thus, lamps which were previously either on or off only may now be dimmed. Thus, not only may features be off loaded to the computing device 904 and the universal device 902 to remove common circuits and components from the module, but new features may be added that would have been prohibitively expensive to add to a lamp without the disclosed smart home system 900.

In some instances, the system modules 906a-h may be collocated with the peripheral device. In other instances, the system module 906a-h may be placed at a location other than the location of the peripheral device. By way of example and not limitation, the system module 906a-h for a thermostat may replace the thermostat in a retrofit, or may be placed in the location that would have been reserved for the thermostat in new construction structure. In contrast, the system module 906a-h for a peripheral device which does not traditionally have a logic circuit such as a lamp, may be placed in a light switch which controls the power to the circuit in which the lamp is connected to power, or in the power outlet in which the lamp is plugged. In this circumstance, the system module 906a-h for the lamp will include circuitry which includes a switch. The switch may be operated remotely by messages sent from the computing device 904, and passing through the universal device 902, as is described in detail below. The switch which is integrated with the lamp during manufacture may be left in the “on” position. The system module 906a-h, when commanded, closes the module switch, allowing power to flow to the lamp. If the system module 906a-h were to fail, the lamp could still be operated as normal using the switch integrated during manufacture. Thus, when the system module 906a-h is not collocated with the peripheral device, the system module 906a-h may have less impact on the operation of the peripheral device, should the system module 906a-h fail. The same may not be true of a collocated system module 906a-h and device or standalone system module 906a-h, for example, a system module 906a-h replacing the thermostat.

Because only the most unique functions of the traditional peripheral device are preserved in the system module 906a-h, and the redundant and common circuits and components off loaded to the computing device 904 and universal device 902, the cost to produce the system modules 906a-h is lower than the traditional peripheral devices they replace. Because some of the functions previously performed on the traditional peripheral device are off loaded to the computing device 904 and universal device 902 in the disclosed smart home system 900, the components for those functions are no longer needed by the system modules 906a-h. This lowers the cost to produce a system module while also making the smart home system more user friendly. The smart home system may be more user friendly because a user no longer has to go to an installation site of, for example, a sprinkler system to operate the sprinkler system, or to the installation site of a thermostat to operate the thermostat. Rather, the user can operate all of the modules on the smart home system 900 from a single location. That location may be a mobile computing device 904, or a fixed location computing device 904, a control panel 903, or all of the above in any combination.

The system modules 906a-h may be connected to the universal device 902 via a wired or wireless connection. When the system modules 906a-h are connected to the universal device 902 via a wired connection, they made be connected by a dedicated wiring infrastructure, for example, an ethernet wiring infrastructure, or they may be connected through a wiring system in which the control signals of the smart home system 900 are combined with other signals. For example, the existing power lines of a structure may be used to send control signals using the protocol on a power line control (PLC) system discussed in detail below.

Further, when peripheral devices are purchased for use in conjunction with the smart home system 900, the peripheral devices may be the most basic models which have no smart features. For example, a garage door controller may be purchased without any ability to connect through wireless means, or any other smart features. Such features may be added through one or more of the system modules 906a-h. Being able to purchase baseline models lowers cost for the consumer. Moreover, any of these models may be made “smart” through the use of system modules 906a-h, and the peripheral devices are guaranteed to interoperate with the disclosed smart home system 900 by the use of the system modules 906a-h.

As can be easily understood from the discussion of the components of the system, the disclosed smart home system 900 is customizable to every user. The only absolute requirement for each user would be to purchase the universal device 902. Even at that, there may be more than one model of the universal device 902. By way of example and not limitation, the universal device 902 may have a first model which relies on the computing device 904 for the display, and all commands must be sent using the computing device 904. Alternatively, another model of the universal device 902 may be integrated with a controller 903 as discussed above. This would allow parallel use of the controller 903 and computing device 904 in sending commands, or for a user to choose between exclusive use of the controller 903 or computing device 904 from time to time. The system modules 906a-h may be purchased based on which peripheral devices a user wishes to control. Thus, a user living in a home in a geographic region with heavy year-round rainfall may choose to not purchase a sprinkler system module because the user's home does not have sprinklers. However, the same user may purchase one or more light modules to intelligently control the lighting of the home.

The smart home system 900 also prevents consumers from paying for features they will not use. Most traditional peripheral devices include a feature set which maximizes the technology present in the device, rather than being based on the features most used by consumers. The system modules 906a-h allow control of the essential aspects of the devices without adding features which have more marginal usefulness. For example, with lights or lamps one embodiment of system module may only allow turning the light off or on. However, another system module for lights may allow a user to both turn the light on or off, and allow dimming. Similarly, for a pool pump control system module, a base module may allow programming of a single operation cycle and manual controls. Another, upgraded pool pump system module would include all of the features of the baseline module and additional features, such as multiple operation cycles and control of separate zones, for example, a spa and a pool zone.

In operation, the smart home system 900 may seek to maximize the utility of available communication links. For example, the smart home system 900 may use a wired connection for all the devices on the system which are local and must be powered. For example, the smart home system may incorporate PLC for the wired connection. In PLC the connection is made using a structure's preexisting power lines. In addition to the power signal, which may be provided from an external source, such as a servicing utility company, additional signals may be added locally to the power line. These signals may be control signals that allow the smart home system 900 to control any module which is electrically connected to the power lines of a residence.

A touch screen (not shown) on the controller 902 or computing device 904 may be used as a system interface by a user (not shown). Certain commands which may be executed by the protocol may be indicated by visual representations on the touch screen. For example, the commands may be indicated by icons or text, or a combination of both. When a user touches the portion of the screen with the visual representation, a command is sent in a message to the universal device, which interprets the command using the protocol.

A PLC transceiver 908i may be integrated with the universal device 902. The primary function of the PLC transceiver 908i is to send signals as directed by the controller 902, or the computing device 904, or both. The PLC transceiver 908i sends a signal upon which control information is encoded. The PLC transceiver may also receive data signals from the system modules 906a-h. For example, the system modules 906a-h may send acknowledgements of messages or self-identification information to the universal device 902.

The PLC transceiver 908a-i includes a crystal oscillator circuit (not shown). The crystal oscillator circuit draws power from the power line 914. The power is taken from the power line 914 and transformed down from 110V to 0.1V. On a 10 amp circuit of the power line 914, the 0.1V of transformed voltage produces one watt of power for the crystal oscillator circuit. As long as the crystal oscillator receives power, the crystal oscillator will continue to output the wave signal.

Crystal oscillators emit a sinusoidal wave at a frequency determined by their physical structure. Most importantly to the disclosure, crystal oscillators, and particularly quartz crystal oscillators, have a very high Q factor. The Q factor, as is well known in the art, is the resonant frequency of the crystal divided by the bandwidth. Quartz crystal oscillators are capable of primary frequencies in the high kHz up the MHz range. Also, as indicated by the high Q factor, they have a narrow bandwidth. A typical Q factor for a quartz oscillator ranges from 104 to 106, compared to 102 for an inductor and capacitor, or LC, oscillator. The maximum Q for a high stability quartz crystal oscillator can be estimated as Q=1.6×107/f, where f is the resonant frequency in megahertz.

Another important aspect of quartz crystal oscillators in light of the disclosure is that quartz crystal oscillators exhibit very low phase noise. In many oscillators, any spectral energy at the resonant frequency is amplified by the oscillator, resulting in a collection of tones at different phases. In a crystal oscillator, the crystal mostly vibrates on one axis, therefore only one phase is dominant. Low phase noise makes crystal oscillators particularly useful in applications requiring stable signals and very precise time references. A quartz crystal provides both series and parallel resonance. The series resonance is a few kilohertz lower than the parallel resonance. Crystals below 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit has to be exactly that specified by the crystal manufacturer. Note that these points imply a subtlety concerning crystal oscillators in this frequency range: the crystal does not usually oscillate at precisely either of its resonant frequencies.

Crystals above 30 MHz (up to >200 MHz) are generally operated at series resonance where the impedance appears at its minimum and equal to the series resistance. For these crystals the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit usually includes additional LC circuits to select the desired overtone.

The signal created by the crystal oscillator circuit 910 is next routed to a switch 914. The switch 914 may be a fast switching operation, as is well known in the art, or any other switch which is able to provide fast enough switching, including transistors which may act as switches by having a voltage applied to, and then disconnected from, the base of the transistor. In this disclosure, the switch may be a single pole, dual throw, or SPDT switch. An SPDT may have a single common connection on one side, and two terminals on the opposite side. When the switch is operated, the switch moves from a first terminal to the second terminal. When switched again, it moves from the second terminal back to the first terminal. An incoming signal from the crystal oscillator circuit 910 is connected to the common. Connected to the first terminal of the switch 914 is a phase inversion circuit 916. Connected to the second terminal of the switch 914 is a bypass 918. The speed of the switch 914 allows for very rapid alternation between the bypass and the phase inversion circuit, or between the first and second terminals. By way of example and not limitation, the switch 916 may cycle fast enough to switch 900 times from the bypass to the phase inversion circuit and back to the bypass in a single cycle of a 20 MHz signal. Thus, there is an opportunity, depending on the protocol used by the system, to send 900 bits of information in a single 20 MHz cycle. In this example, the system could generate 2 billion bits of information a second. Alternatively, the switch may cycle fewer than 900 times in a 20 MHz cycle, or more than 900 times in a 20 MHz cycle. Still further alternatively, the crystal oscillator may generate a sinusoidal wave at more than 20 MHz or less than 20 MHz. The operation of the system, including the creation and modification of the sinusoidal wave produced by crystal oscillator is discussed in great detail below. The transmission portion 906 is electrically connected to an emitter output 920, which is in turn connected to the power line 914.

The universal device may include a memory 912 on which a protocol is stored, and a processor 910 which is electrically connected to the memory, and on which the protocol is executed. The protocol may include a portion which interprets commands sent by the controller 902 or computing device, or from a module transceiver. The protocol, executed by the processor 910, accomplishes the encoding of the sinusoidal wave of the crystal oscillator circuit by controlling the switch.

The protocol is designed so that messages include an identifier as to which system module 906a-h the message is directed. Although eight system modules are shown, it will be understood that the smart home system 900 may have more than eight system modules or less than eight system modules. If a message is not directed to a particular system module 906a-h, that system module 906a-h ignores the message.

The protocol may be standardized. That is, it may have a set sequence of digits or characters that correspond to the execution of a particular command. The protocol may include a plurality of the digit or character sequence to command correspondences. If fact, there might be a list that is fixed at any moment in time which a manufacturer can consult while developing a product. New commands may be developed and added as a need arises. Because the protocol is standardized, anyone can use commands from the list while being assured that the commands will have the intended effect. Part of the protocol may also be a conversion module. The conversion module is bidirectional. That is, the conversion module may take messages or commands from the protocol and convert them in to messages or commands that may be executed or communicated on a specified operating system. In fact, the protocol may be designed so that the conversion module may allow a user to take a computing device 904 using any common operating system, and be guaranteed that the operating system and the protocol will interoperate. The same is true of commands and messages generated by the computing device 904. The commands and messages generated by the computing device 904 will be converted in to the corresponding digit or character sequence and sent to the system module 906 or system modules 906a-h for execution. This means that any computing device 904 may be chosen for interoperation, and any system module 906 may be later added and the protocol will allow for it to interoperate not just with the computing device 904 or universal device 902, but with other system modules 906.

Upon addition to the smart home system 900, each system module 906a-h may send self-identification information to the universal device 902. The universal device 902 may, in turn, send some or all of the self-identification information to the computing device 904. The self-identification information may include an identifier for the system module. The identifier may be a binary sequence. The self-identification information may further include which features may be controlled through the user interface, and which type of control surface corresponds to each feature. The self-identification information may also include what control parameters correspond to the control surface for controlling a particular feature.

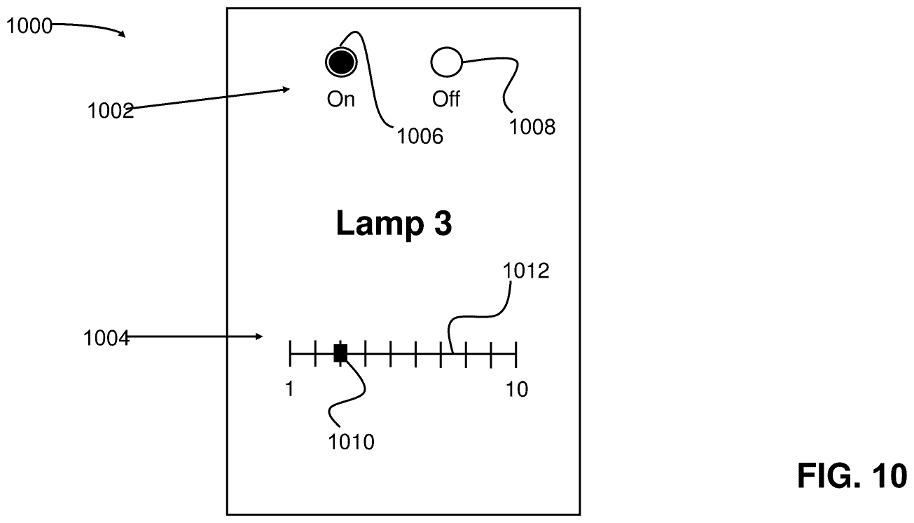

With reference to FIGS. 9 and 10, the initialization information may be used by a software application stored on the computing device 904 to create a user interface 1000. The user interface 1000 may have control surfaces 1002, 1004 for controlling the parameters of the functions. One or more of the system modules 906a-h may have more than one function. By way of example and not limitation, the one or more system modules 906a-h may have a first function which responds to a binary control parameter. This control parameter may be, for example, state of operation control parameter which includes the values “on” and “off.” As a part of the user interface 1000, the software application may create a control surface corresponding to the function and control parameter. In the case of a binary control parameter the user interface 1000 may include a control surface 1002 which includes two radio buttons 1006, 1008. A first radio button 1006 may allow a user to send a command turn the system module on by selecting the first radio button 1006, which is labelled “on,” and a second radio button 1008 may allow a user to send a command turning the system module off by selecting the second radio button 1008, which is labelled “off.” [The system module may have a second function which has a control parameter which includes a range of values. For example, the range of values may be a wattage value, or may be an indexed number, for example 1 to 10, used to designate levels of resistance in a circuit, to control a volume level. As a part of the user interface 1000, the software application may create a control surface corresponding to the function and control parameter. In the case of a control parameter with a range of values, the user interface 1000 may include a control surface 1004 which includes a scale of values. As shown in FIG. 10, the values range from 1 to 10. However, it is understood that the values may begin at any number, and may end at any number. The range of values may be more than 10, and the range of values may be less than 10. The user may slide the marker 1010 along the scale 1012 to each of the indexed positions in order to control the function.

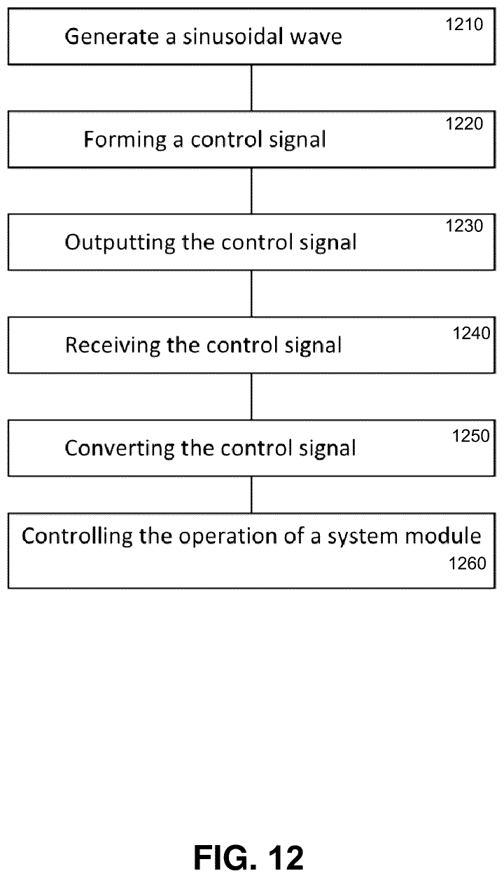

In order to send commands to one or more modules, commands from the user interface on the controller or on the computing device are converted to control signals by the protocol. The control signal has two parts. The first part is the sinusoidal wave, which the crystal oscillation circuit generates continuously, as shown in Step 1210 on FIG. 12. The second part is control information which is encoded on the sinusoidal wave, which is shown in Step 1220 of FIG. 12. After generation, the sinusoidal wave is fed to the connected switch 914, as is described above. The switch 914 is also connected to a processor 924 which executes the protocol by operating the switch. Based on the command signals from the controller, which are converted by the processor using the protocol, the processor 924 directs the switch 914 to switch between the phase inversion circuit 916 and the bypass 918. Information is encoded on the sinusoidal waveform generated by the crystal oscillator circuit 910 by switching the switch 914 from the bypass 918 to the phase inversion circuit 914 and back to the bypass 918 in order to create phase inversion spikes at defined intervals on the sinusoidal wave. The phase inversion spikes and unaltered portions of the sinusoidal wave represent control information which may be decoded by the protocol. The unaltered sinusoidal wave combined with the control information may be called a control signal.

The timing for the phase inversions may be set to a fractional portion of the wave cycle of the crystal oscillator frequency by the protocol. Thus, where a phase inversion spike 554a-1 appears on the control signal 550, the protocol may interpret the phase inversion spike 554a-1 as indicative of a first binary state, while uninterrupted portions of the control signal 550 are interpreted as a second binary state. In this way, the protocol may interpret the control signal as a series of binary states, with the binary states representing either a one or a zero. Commands may be defined by the protocol from differing sequences of ones and zeros, or binary sequences.

Sequences of ones and zeros may form data or commands that can be analyzed and converted by the protocol. As an example, the light fixtures and separate temperature sensors may identify themselves using a binary code of a set number of digits. The identification may be a shorter or longer sequence than those of the commands. The protocol may define a preliminary indicator which indicates the start of a command or data string, and a second indicator which indicates the command or data send is complete and requests that the lighting fixture or fixtures, or temperature sensors to which the command was directed send an acknowledgement. Similarly, the protocol may use binary sequences to define commands. By way of example and not limitation, the protocol may define that “1001” may correspond to a command to turn a lighting fixture to 100% of the wattage, while “1000” may correspond to a command to turn the lighting fixture off. The data and commands may be packaged as messages that include the preliminary indicator that a command or data follows, headers which identify to which fans the command is directed, the command, and an indicator that the command is complete and a request for acknowledgement of the command by the lighting fixture or temperature sensor. It is important to note that when the control information is added to the sinusoidal wave to create the control signal, the amplitude and frequency of the sinusoidal wave are unaffected. Rather, only the phase is changed in creating the phase inversion spikes. Thus, the control signal is output to the power line with the frequency unaffected from when the sinusoidal wave was generated by the crystal oscillator. Also, the amplitude is not changed, as the only amplification takes place within the crystal oscillation circuit. Once the control information is encoded on the sinusoidal wave generated by the crystal oscillator circuit 910, the control signal is output to the power line 914 as is shown in Step 1230 of FIG. 12. The output is a broadcast throughout the power line 914. An exemplary control signal 550 is shown in FIG. 8. The control signal 550 includes a plurality of phase inversion spikes 554a-1. It will be noted that the phase inversion spikes 554a-1 are placed in protocol-defined intervals along the control signal 550, rather than one phase inversion spike 554a-1 after another with no unaltered portions in between, although is also a possible arrangement, depending on the binary sequences defined in the protocol.

The smart home system may also use wireless connections in combination with the wired connection between the universal device and the one or more system modules for communication. For example, the computing device may connect to the universal device through a wireless connection, as discussed above. Further, the universal device may make use of a wireless connection to the cloud for certain functions. For example, the universal device may access the cloud to store configuration settings for the smart home system. Alternatively, or in addition, the smart home system may access code for creating user interfaces based on the self-identification information the system modules provide. Also, if a user is not collocated with the smart home system, the user may access the smart home system, and specifically the universal device, via the internet using the computing device. Thus, the universal device may have both a wired connection, for example, via power line, and a wireless connection via, for example, WiFi, to connected to a computing device via the internet as is well known in the art.

Because the universal device and the modules communicate via the protocol, and the bandwidth available via PLC is large in comparison to the data needs of the protocol, the communication between the universal device and the modules is fast. In fact, the universal device can communicate with each of the attached modules multiple times in a fraction of a second. Such a communication configuration allows for near instantaneous changes when required by a user.

As an alternative to PLC, the universal device may be connected to the modules through other wired connections. For example, a wiring infrastructure of ethernet cable may be created to connected each module to the universal device via one or more networking switches. Of course, such a wiring infrastructure has the disadvantage of cost to install the wiring and the cost of the wire itself as compared to the preexisting power lines. However, such a wiring infrastructure has the advantage of being the exclusive carrier of the control signals, and can be guaranteed to be free of any other signals if installed properly.

As yet another alternative, the universal device and the one or more system modules may communicate via a wireless connection. The universal device and the one or more system modules may use WiFi protocol, or Bluetooth®, or other wireless protocols which allow the one or more system modules to exchange messages with the universal device.

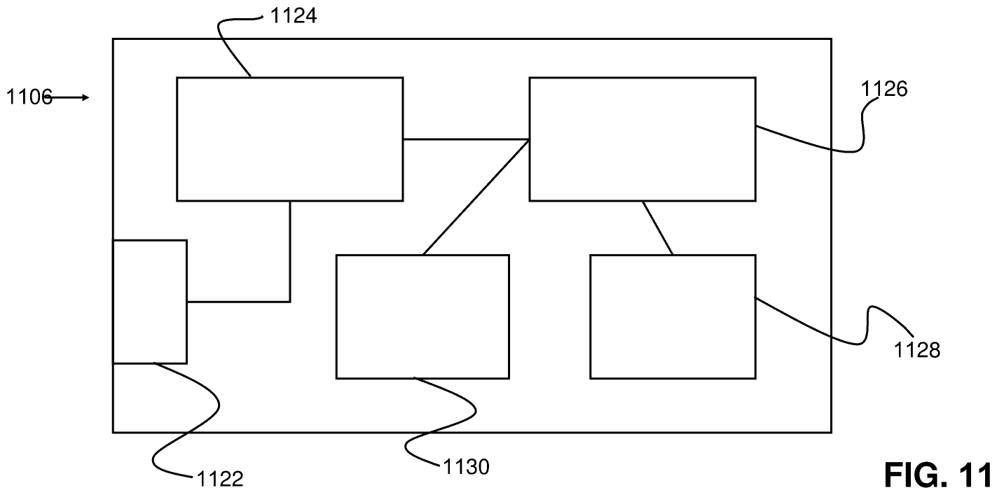

Referring now to FIGS. 11, 12, and 8, if PLC is being used, on the receiving end, the control signal 550 is received on an input/output port 1122 and passed to the transceiver 1124 of the one or more system modules 1106, as is shown in Step 1240 of FIG. 12. The crystal filter filters out only a bandwidth of 500 Hz or less centered on the transmission frequency of the crystal oscillator from the signal on the power line. Naturally, the rest of the signal on the power line may be band passed so that the power on the power line may be used to power the one or more modules and any peripheral devices which may be connected. The 500 Hz or less bandwidth captures the control signal because the phase inversions do nothing to spread the bandwidth of the original sinusoidal wave generated by the crystal oscillator. That is to say, the signal is not frequency modulated.

Following the filtering, the protocol stored on a memory 1128, and executing on a processor 1126 on the one or more system modules, detects and analyzes the information in the control signal 550. The control information encoded on the control signal 550 may be decoded and converted by the protocol as is shown in Step 1250 of FIG. 12. The conversion may result in instructions which are executable to give commands to the unique circuitry and components 1130 of the one or more modules 1106 and to set control parameters for the functions of the system modules 1106 as is shown in Step 1260 of FIG. 12, and described above.

The use of ultra-narrow bandwidth and phase inversion spikes combined with protocol defined placement of phase inversions spikes and unaltered sinusoidal wave in the control signal provides robust protection against interference by electrical noise on the power line 914. In order for electrical noise on the system to interfere with the control signal the electrical noise would need both reach in to the narrow bandwidth on which the oscillator is transmitting, and the filter is receiving, and to invert its phase as the control signal 550 does. This kind of rapid phase inversion is uncommon in electrical noise, including the noise typically found on power lines. Thus, in addition to all the other ways the smart home system 900 eliminates electrical noise which may affect the control signal 550, even the manner in which the information is added to the sinusoidal wave 550 generated by the crystal oscillator circuit provides robustness against interference by electrical noise. This largely mitigates concerns about electronic noise interfering with the control signal, and makes a separate wiring infrastructure even less attractive, given the cost of a separate wiring infrastructure.

The one or more system modules may then execute the command sent. Contemporaneously, the one or more system modules may send a confirmation to the universal device that the command has been received. Once the command has been executed, the one or more system modules may further send an update to the universal device showing the current operating state, including the new parameter setting. The universal device may communicate with the computing device to confirm the new state of operation for the one or more system modules.

### Example Hydroponic Smart Systems

A hydroponic farm is a complex operation. Plants may be placed in a liquid and the liquid may be infused with nutrients to aid growth. Although some hydroponic farms may be outdoors, most are indoors, and therefore require artificial lighting to provide light for photosynthesis. The larger the farm, the more likely the variation in environmental conditions between areas in the farm, even indoors. Thus, lighting solutions are beneficial for plant growth, but the temperature can be monitored so that the lights and other heat sources do not increase the temperature to levels which would damage the plants. In terms of the liquid environment, two parameters of the nutrient solution that may be monitored and controlled may be the hydrogen ion concentration, which is a measure of the acidity or alkalinity of a solution (pH), and electrical conductivity (EC). The disclosed system includes control of lighting and monitoring of temperature. The control and monitoring seek to optimize operation of the lighting through a mix of centralized and decentralized control of various aspects of the lighting's operation. Further, the system provides localized monitoring of pH and EC, and well as localized control of nutrient mix in the liquid to optimize conditions for plant growth.

Further, the system places monitoring and control of every aspect of the system in a single location on the user interface of a computing device. The computing device may be a mobile device such as a smart phone, a tablet, or a laptop, or a stationary device, such as a desktop computer or a programmable logic controller including a touch screen. The user interface may include fields for input of various of parameters to control operation of the system, and to access measurements by various measuring devices, as is described in greater detail below. The computing device may be connected wirelessly to a central controller. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology.

The timing of the lighting may be automated by a central controller. That is, the central controller may turn one or more light fixtures in smart hydroponic system modules on and off at times predetermined by a user and input as parameters in the central controller. The parameters may be input either using the computing device or directly using a hardware interface on the controller. In addition to the centralized control, a temperature sensor may be located on every lighting fixture. As used herein, the term “lighting fixture” is meant to include both a lighting element and a ballast combination unless specifically stated otherwise. The temperature sensor may include providing measurements which could trigger a dimming command or shut off command of the light fixture, should the temperature reach predetermined threshold temperatures for each of those operations. Again, these threshold temperature parameters may be input using the computing device user interface or by the hardware interface on the central controller.

Sensors placed locally on the smart hydroponic system modules may monitor pH and EC in the liquid. The computing unit may receive the measurements from the sensors and pass the measurements to the computing unit, and then to the central controller, which may pass the measurements to the computing device, which may collect and display the measurements. The computing unit may further automatically control the addition of nutrients to the liquid to bring the nutrient mix back to an optimum state. Alternatively, before taking action, the computing unit may send a message to the central controller, which may in turn send the message to the computing device. The message may ask a user's permission before adding nutrients. The message may take the form of a pop up on the computing device, the pop up including providing radio buttons which allow a user to select to provide or deny permission for the system to act. Parameters may be set to establish tolerances for the nutrients. This prevents the computing unit from acting too aggressively when placed on automatic control. The mix of centralized and decentralized control and monitoring solves several technical shortcomings with the state-of-the-art systems while creating time savings and optimizing plant growth and yield.

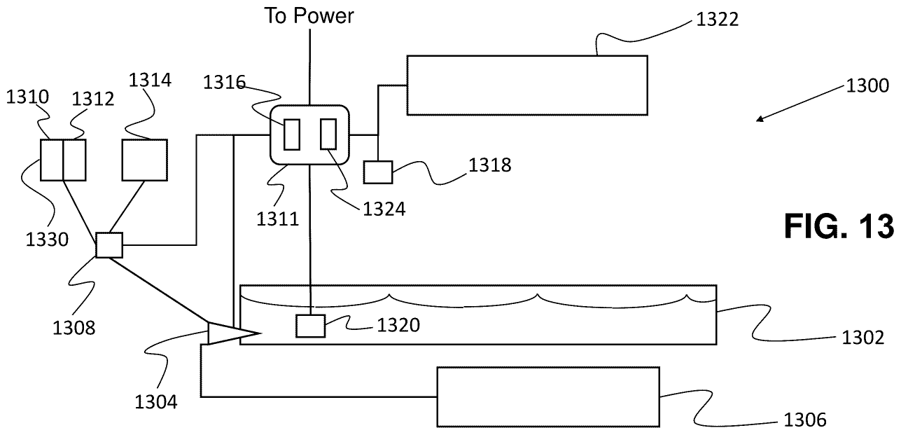

More specifically, as shown in FIG. 13, the smart hydroponic system module 1300 may include a tank 1302, a tank valve 1304 in fluid communication with the tank 1302. The tank valve 1304 controls water and additive flow in to the tank 1302. A liquid source 1306 may be connected to a first inlet of the tank valve 104, and an additive valve 1308 may be connected to a second inlet of the tank valve 1304. The additive valve 1308 may control which additive flows to the tank valve 1304. A pH tank 1330 may be connected to a first inlet of the additive valve 1308. The pH tank 1330 may include a “pH up” additive compartment 1310, and a “pH down” additive compartment 1312. A fertilizer tank 1314 may be connected to a second inlet of the additive valve 1308. A computing unit 1311 may control both the tank valve 1304 and the additive valve 1308 through an electrical connection. The computing unit 1311 receives data from the light temperature sensor 1318, and the tank sensor package 1320. The computing unit 1311 and light temperature sensor 1318 both connect to, and take part in the control process for, a light fixture 1322.

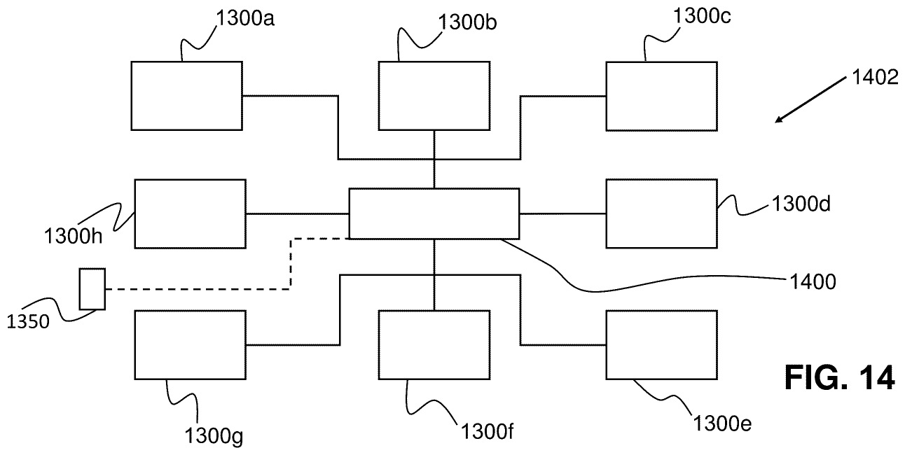

As shown in FIG. 14, a smart hydroponic system 1402 may include a central controller 1400 and one or more smart hydroponic system modules 1300a-h. The computing device 1350 may be wirelessly connected to the central controller 1400, as indicated by the dashed line. Although eight smart hydroponic system modules are shown, it is understood that there may be fewer than eight or more than eight, as discussed above.

Plants (not shown) may be placed in the tank 1302. The tank 1302 may be part of a deep water culture (DWC) system or a nutrient film technique (NFT) trough, or other hydroponic farming system. The tank 1302 may have varying amounts of liquid in it. The tank 1302 may have a bottom and two sets of opposing sides. Each side may be connected along a longitudinal edge of the side to an edge of the bottom, and at first and second ends of the side to an end of an adjacent side. An outlet of the tank valve 1304 may be placed on one of the sides, so that the tank valve 1304 outlet is fluidly connected with the tank 1302. The top of the tank 1302 may be open, or it may be partially enclosed. When the top is partially enclosed, the top may include a plurality of openings through which plants may protrude. The top on the tank 1302 may help to inhibit the growth of algae and to minimize evaporation, as is discussed in detail below. The tank 1302 may also include an air pump (not shown) which may be placed submerged in the liquid, particularly when the tank 1302 is part of the DWC system. The pump oxygenates the liquid in the tank 1302. Plants absorb oxygen in the liquid through their roots, enabling growth of the plants.

The tank 1302 may have containers placed in it for holding the plants in a certain orientation. For example, the plants may be placed in a substantially cylindrical mesh container or a mesh tray. The mesh container or mesh tray may hold a media for orienting the plant in an upright position while allowing access to the roots. The mesh allows the liquid to pass through the container and contact the roots. This allows the roots to absorb nutrients from the liquid. The top of the tank 102 may be as closed as possible to mitigate the exposure of the liquid to light. As the liquid may have high levels of nitrogen, phosphorous, carbon and potassium to create the optimum nutrient mix for the plants, light can provide the energy to feed the growth of algae and create a bloom. Too much algae can harm the plants in the hydroponic system by blocking the equipment, including the air pump and the tank valve 1304, and by depriving the roots of the plants of oxygen. Algae will absorb all of the oxygen, leaving none or very little for the plants. The top may help to prevent evaporation from the tank 1302 as well, by allowing less exposure to environmental air. This is a benefit because, especially if the environment is dry, water can evaporate quickly, raising costs for the hydroponic farm.

The tank valve 1304 may include an outlet in fluid communication with the tank 1302. The tank valve 1304 may further include two inlets. A first inlet is in fluid communication with a liquid source 1306. The liquid source 1306 may be a supply from a water utility, or a reservoir, or a combination of both. A second inlet is in communication with an additive valve 1308. The tank valve 1304 is an electrically actuated valve, and is in electrical communication with the computing unit 1311. The computing unit 1311 may send commands to the to the tank valve 1304 which cause the tank valve 1304 switch between fluid communication with the first inlet with the outlet, the second inlet with the outlet, and an off position with no fluid communication. Such commands may be overridden or modified by commands from the computing device 1350 should the user wish to override or modify any of the commands.

The additive valve 1308 may include an outlet in fluid communication with the tank valve 1304. The additive valve 1308 may further include two inlets. A first inlet is in fluid communication with a pH additive tank 1330. The pH additive tank 1330 may include a first compartment 1310 which holds a liquid, the liquid's composition such that the liquid will raise the pH of the liquid in the tank 1302. The pH additive tank 1330 further may include a second compartment 1312 which holds a liquid, the composition of which lowers the pH of the liquid in the tank 1302. A second inlet may be in fluid communication with a fertilizer tank 1314. The fertilizer tank 1314 may hold a liquid which includes nutrients for the plants in the tank 1302. The additive valve 1308 may further be in electrical communication with the computing unit 1311. The computing unit 1311 may send commands to the additive valve 1308 which cause the additive valve 1308 to move between a fluid communication between the first inlet and the outlet, the second inlet and the outlet, and an off position with no fluid communication. Such commands may be overridden or modified by commands from the computing device 1350 should the user wish to override or modify any of the commands.

Various sensors may be electrically connected to the computing unit 1311. A temperature sensor 1318 may be electrically connected to the computing unit 1311 and the light fixture 1322. The temperature sensor 1318 may measure the temperature of the air near the light fixture and the plants and send the measured temperature as data to the computing unit 1311. The computing unit 1311 may include a processor 1316 which executes instructions stored on a memory 1324 to check the data against parameters stored on the memory 1324, which is electrically connected to the processor 1316. If the temperature is outside of the parameters stored in the instructions, the instructions may cause the processor to send a command to the light fixture to dim or shut down. The details of the operation of the hydroponic smart system 1300 are discussed in detail below. Further, a sensor package 1320 may be electrically connected to the computing unit 1311. The sensor package 1320 may include a plurality of sensors. For example, the sensor package 1320 may have a sensor for pH, a sensor for EC, a sensor for liquid level, and a sensor for liquid temperature, or any combination of sensors depending on the application and the location of the hydroponic farm. The sensor package 1320 may pass data, including the various measurements taken by the sensors, to the computing unit 1311. The computing unit 1311 may receive the data and execute instructions stored on the memory 1324 using the processor 1316 to check the measurements against stored parameters. The stored parameters may have been previously input to the memory 1324 either using a hardware interface on the central controller 1400 or the computing device 1350. The computing unit 1311 may send commands to the tank valve 1304 or the additive valve 1308, or the light fixture 1322, or some, or all, of the above in combination based on the check of the measurements against the parameters. Again, the details of the operation of the hydroponic smart system 1300 are discussed in further detail below.

The sensor package 1320 may be at least partially submersed in the liquid contained by the tank 1302. The sensor package 1320 may have single housing including all of the sensors, or may include a separate housing for each sensor. Alternatively, one housing may have more than one sensor, and other housings may have a single sensor. Still further alternatively, the liquid level sensor may only be in a separate housing. The liquid level sensor may be located in an interior of the tank 1302. The liquid level sensor may be place partially submerged, and partially above, the liquid level in order to properly measure the liquid level in the tank 1302.

The hydroponic smart system module 1300 may be connected to a power line through a standard outlet in a structure. The computing unit 1311 may include a protocol which allows the computing unit 1311 to receive commands sent over the power line from a central controller 1400. The method of sending commands over the power line is commonly called power line control. As shown in FIGS. 13 and 14, the central controller 1400 may be connected to a plurality of smart hydroponic system modules 1300a-h. Although eight smart hydroponic system modules 1300a-h are shown connected to the central controller 1400, it is understood that this is merely exemplary, and that there may be more than eight hydroponic smart system modules 1300 connected to the central controller 1400 or fewer than eight smart hydroponic system modules 1300 connected to the central controller 1400. One limitation to the number of hydroponic smart system modules 1300, which may be connected to the central controller, may be the total number of electrical sockets in a structure. Additionally or alternatively, smart hydroponic system modules may be added at any point in the future to the system 1402. The system 1402 is not limited to the number of smart hydroponic system modules with which the system starts. Additionally, smart hydroponic system modules may be removed from the system. Thus, the system 1402 does not have a fixed number of smart hydroponic system modules with which the system 1402 can operate. There is no maximum, and there is no minimum number of smart hydroponic system modules. Use of the protocol ensures that future added smart hydroponic system modules will be able to interoperate with the already connected system 1402.

The power line control system and other aspects of Power Line Communication (PLC) are disclosed in International Patent Publication WO 2021/107961, which is hereby incorporated by reference herein for all purposes. The central controller 1400, either autonomously or as a pass through for the computing device 1350, may send commands over the power line to one or more of the smart hydroponic system modules 1300a-h. Thus, the smart hydroponic system modules may be controlled by both the computing device 1350, the central controller 1400, and controlled locally by the computing unit 1311 based on input from the sensor package 1320 and the temperature sensor 1318. It should be noted that commands are divided between central and local control in order to take advantage of each. That is, commands are not divided between central and local control simply according to user preference. Some commands may be reserved to central control, and other commands may be reserved to local control. Alternatively, some commands may be given by both central control and local control, but at different times or because of different inputs to the computing unit 1311. Moreover, it should be further noted that not only may smart hydroponic system modules 1300 be added to the system 1402, but additional sensors, valves, or other components may be added to one or more of the smart hydroponic system modules, and the system would not function differently, as described in detail below.

Alternatively, the central controller 1400 may connect to each of the smart hydroponic system modules through a wireless connection. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology. Commands from the central controller 1400 may be sent using the above protocols while preserving the local control for the computing unit 1311. The computing unit 1311 may still connect to the lighting fixture 1322, the temperature sensor 1318, the sensor package 1320, the tank valve 1304, and the additive valve 1308 through wired connections, and commands sent to the above components from the computing unit 1311 using a wired protocol, including the power line control protocol. When the central controller 1400 and the computing unit 1311 are connected wirelessly, both the central controller 1400 and the computing unit 1311 may have wireless transceivers for the purpose of transmitting and receiving messages and commands. Still further alternatively, the computing unit 1311 may be connected to the lighting fixture, 1322, the temperature sensor 1318, the sensor package 1320, the tank valve 1304, and the additive valve 1308 through wireless means. The wireless connection may be made through any number of protocols known in the art. For example, the wireless connection may be a wireless communication link, for example, Wi-Fi, Bluetooth®, cellular (3G, 4G, 5G, LTE, etc.), or other suitable wireless communication technology. The computing unit 1311 sends commands to the components using the appropriate protocol when connected using that protocol. When connected by wireless means, every component will have a transceiver for purposes of wireless interoperation, including sending and receiving messages and commands.

A single power line input may provide power to every component of the hydroponic smart system 1300. Alternatively, the hydroponic smart system 1402 may have some components powered by one power line output, and other components powered by a different power line output. One power line output may be input in to the computing unit 1311. The computing unit 1311 may provide power distribution for the hydroponic smart system module 1300. The computing unit 1311 may include transformers which bring the power line voltage, which is nominally 120 volts in North America, down to a low voltage range for operating the tank valve 1304, the additive valve 1308, the temperature sensor 1318, and the sensor package 1320. This power may be provided to the tank valve 1304, the additive valve 1308, the temperature sensor 1318, and the sensor package 1320 through wired connections such as standard low voltage wiring as is well known in the art. The low voltage power may also be self-distributed to the computing unit 1311 to power the various components, including the memory 1324 and the processor 1316, of the computing unit 1311. The computing unit 1311 may distribute full 110 volt power to the lighting fixture 1322. This power may be distributed by providing a bypass prior to any transformation of the power received by the computing unit 1311 from the outlet.

In operation, the hydroponic smart system 1300 may operate on repeated 24-hour day/night cycles. For ease of explanation, this disclosure will divide a 24-hour cycle by starting at an artificial sunrise, which is created by the powering on of the one or more light fixtures 1322, and ending the moment before the artificial sunrise begins again. Because the hydroponic smart systems 1300a-h and controller 1400 are installed indoors, the rise and setting of the Sun are not relevant. This rise and setting of the Sun are replaced by power on and shut down of the artificial lighting provided by the light fixtures 1322. However, the powering on and off of the light fixtures 1322 may be keyed to the actual sunrise and sunset at the geographic location, should a user chose to set up the system 1402 to operate that way.

In the case of a first power on of the system 1402, that is, the computing device 1350, central controller 1400 and smart hydroponic system modules 1300a-h combination, there are a few differences as compared to a subsequent power on. In a first power on, after the computing device 1350, or central controller 1400, or both, are powered up, woken up from sleep mode, or connected via a wired or wireless connection to the hydroponic smart systems 1300a-h, the controller 1302 may interrogate the computing units of the smart hydroponic system modules 1300a-h connected to the power line, and provide any returned information to the computing device 1350. This is done by the central controller 1400 sending a command to the smart hydroponic system modules 1300a-h to respond to the command with identification information. If the central controller 1400 and/or computing device 1350 is already connected, the protocol may require that a smart hydroponic system modules 1300a-h which is later connected to the system 1402 send self-identification information to the central controller 1400. It should be noted that the self-identification information may further include identification of individual components of the smart hydroponic system modules 1300a-h. These may include the lighting fixture 1322, for example. Thus, the central controller 1400 may send commands which pass through the computing unit 1311 to components such as the lighting fixture 1322. However, such pass-through commands are not limited to commands for the lighting fixture 1322. The central controller 1400 may also send commands for the tank valve, the additive valve, or any other component.

After a first power on, because the central controller 1400 is able to identify each smart hydroponic system modules 1300a-h, and even components of the smart hydroponic system modules, individually, future commands may be specified as being for a particular smart hydroponic system modules 1300a-h or component of a smart hydroponic system module 1300. Because these commands contain information identifying the smart hydroponic system modules 1300a-h or component thereof to which they are directed, the commands will be ignored by other smart hydroponic system modules 1300a-h. Alternatively, some or all of the smart hydroponic system modules 1300a-h could be specified by a command. Thus, groups of smart hydroponic system modules 1300a-h, for example, a group of smart hydroponic system modules 1300a-h in a specified area of a structure, may be controlled as a group. Or, if, for example, all smart hydroponic system modules 1300a-h need to be powered up or down, this can also be accomplished through the above identification of all smart hydroponic system modules 1300a-h. In fact, there may be a particular identifier in the protocol specifying that a command is for all components connected to the central controller 1400. Such an identifier prevents the protocol from requiring that each smart hydroponic system modules 1300a-h, have an individual identifier separately listed in the command. The computing device 1350 or the central controller 1400 may send a “power on” command for the light fixtures 1322. The power on may be further controlled by ramping up the light fixtures 1322 during power on. Ramping up may use variable wattage settings of the light fixture 1322 to gradually increase from a lower brightness to a greater brightness until the light fixture 1322 reaches the maximum wattage. This function is of great benefit in indoor agriculture, because the ramping simulates sunrise, allowing the lighted crops to function as if they were in an outdoor environment. Both the power on time for the hydroponic smart systems 1300a-h and, more specifically, the lighting fixtures 1322 may be set as parameters in the central controller 1400 by a user, either using the native hardware interface or the computing device 1350. Whether the power on is to include a ramping of the light wattage may also be set as a parameter in the central controller 1400 by the user, also either using the native hardware interface or the computing device 1350. Further, the exact time for the ramping overall, as well as the time intervals for the increase, and the starting wattage, and wattage increase at the specified time intervals may all be set as parameters in the central controller 1400, again either using the native hardware interface or the computing device 1350. Generally, when the central controller 1400 sends the power on command, it is sent to all the smart hydroponic system modules 1300. However, especially when a large structure has compartmentalized areas, it may be desirable to only power on specified areas. This allows an operation to power on the areas in series, and have less than all the light fixtures 1322 on at any one time, keeping the current draw low.

After the initial power on, the hydroponic smart system module 1300 may be controlled locally, or, said another way, in a closed loop manner. Based on measurements taken by the temperature sensor 1318 or sensor package 1320, the computing unit 1311 may send commands to the lighting fixture 1322, the tank valve 1302, or the additive valve 1308. The computing unit 1311 may use a protocol which is standardized and open. Standardized means that it can be used by any device built which may be added to the system 1402, either at present or in the future. The protocol may include a list of set commands and messages which may be exchanged between the computing device 1350 and the central controller 1400, or the computing device 1350 and the computing unit 1311, or both. Open means that the protocol is designed in such a way that all components may make use of the common portion of the protocol. The conversion may be at the computing device 1350, and this portion of the protocol is maintained by a protocol owner. The protocol may include conversion software for any operating systems commonly used on mobile devices and desktop computers. On the opposite side of the protocol, a manufacturer of a component has the freedom to design how the protocol commands are executed. Thus, the manufacturer of a component may take a simple, straightforward approach to hardware design which is capable of receiving the command and executing it.

The temperature sensor 1318 may send data to the computing unit 1311. The data may include temperature measurements. A user may input parameters in to the computing unit 1311 for the temperature sensors 1318, either by using the native hardware interface of the central controller 1400 or the computing device 1350. The central controller 1400 or the computing device 1350, through the central controller 1400, may send the temperature parameters for the computing unit's 1311 native dimming and shut down commands. The dimming and shut down commands may be stored as instructions on the memory 1324 and executed on the processor 1316, with the commands being formed and sent to the lighting fixture 1322 according to the protocol.

The dimming command specifies dimming the light fixture 1322 to a lower wattage when a temperature measurement exceeds a set parameter. By way of example and not limitation, the computing unit 1311 may send a command to dim the light to 50% of the current wattage if a temperature above 80 degrees Fahrenheit is detected by the temperature sensor 1318. The temperature may be a parameter set by a user. The parameter may be input using the native hardware interface on the central controller 1400 or the user interface on the computing device 1350. The amount of dimming desired may be input using the native hardware interface on the central controller 1400 or the user interface on the computing device 1350, as well.

The shut-down command turns off the light fixture 1322 if the temperature sensor 1318 detects a temperature indicated in the parameter. By way of example and not limitation, if the temperature sensor detects a temperature of above 90 degrees Fahrenheit, the computing unit 1311 commands the lighting fixture 1322 to shut down. The temperature parameter may be input using the native hardware interface on the central controller 1400 or the user interface on the computing device 1350.

Alternatively, or in addition, a liquid temperature sensor on the sensor package 1320 may be used in place of, or in conjunction with, the temperature sensor 1318. For example, there may be instructions which specify that the light fixture 1322 may be sent a dimming command or a shut-down command based on either a temperature parameter set that specifies the command be sent based on a temperature reading matching a first parameter from the temperature sensor 1318 as discussed above, or based on a temperature reading matching a second parameter sent from the liquid temperature sensor in the sensor package 1320. Or, the dimming or shut down command may be triggered by exceeding a combined parameter set. That is, the dimming or shut down command may only be sent if measurements are outside of two parameters sets, one of which may be based on a measurement from the temperature sensor 1318, and the other based on measurements from the sensor package 1320. In some embodiments, if only one measurement is outside of the parameters set, the command may not be sent.

The sensor package 1320 may take measurements at intervals during the entirety of the cycle, without regard to the light fixture 1322 being on or off. Some of the measurements may not be tied to parameters that would trigger commands, while other measurements may be tied to parameters that would trigger commands. For example, the sensor package 1320 may include a liquid level sensor. The tank 1302 may have known dimensions, thus depending on the liquid level in the tank 1302, the volume of liquid in the tank 1302 may be calculated. Thus, the liquid level sensor measurement may not be keyed to any parameters, and accordingly, may not trigger any commands. However, the measurements taken by the liquid level sensor may be used in calculations, which are used to determine the scope of commands, or to determine aspects of commands sent to, specifically, the tank valve 1304 and the additive valve 1308. For example, with a known volume of liquid in a tank 1302, and a known flow rate for a valve 1304, 1308, a time to add a certain volume of liquid may be calculated.

Both while the light fixture 1322 is on and off, the computing unit 1311 may send commands to the tank valve 1304, or the additive valve 1308, or both. The commands may be triggered by the sensor package 1320 taking measurements that are outside of parameters stored by a user in the memory 1324. The sensor package 1320 may include a sensor which measures the pH of the liquid. The sensor package 1320 may further include a sensor which measures the EC of the liquid. The liquid used may be water, but the smart hydroponics system 1300 is not limited to water as the liquid used in the tank 1302.

As indicated above, the pH sensor on the sensor package 1320 may take measurements at intervals determined by the user throughout the cycle. The pH of the liquid indicates whether it is alkaline, acidic or neutral. If the pH is greater than 7, it is alkaline; if the pH is less than 7, it is acidic. A pH of 7 indicates that the solution is neutral. The plants ability in a hydroponic system to absorb nutrient solution depends on the pH of the nutrient solution. When the nutrient solution is above or below the target pH level, the plant may not receive enough nutrients. Different nutrients are available at different pH ranges. In hydroponics, the ideal pH range may be between 5.8 and 6.2, compared to a pH of 6.5 for soil gardens. Thus, a user may input the parameters of 5.8 and 6.2 in to the memory for the allowable range of pH for the liquid in the tank 1302. Depending on various factors, a pH for the liquid outside of 5.8 and 6.2 may be desirable. As these are user selected parameters, they may be changed using the central controller 1400 or the computing device 1350 to send a message containing the updated parameters to the smart hydroponic system module 1300.

When the sensor package 1320 sends a measurement above 6.2 for pH to the computing unit 1311, the computing unit 1311 may use the liquid level measurement for the same time interval to calculate a water volume in the tank 1302. Based on the water volume, and a known flow rate from the pH down additive compartment 1312 through the additive valve 1308 and tank valve 1304 and in to the tank 1302, calculate a time the additive valve 1308 and the tank valve 1304 can beneficially be open to add the required amount of pH down solution. The computing unit 1311 may send a command to the additive valve 1308 and the tank valve 1304 to provide fluid communication from the inlets corresponding to the pH down additive tank 1312 to the tank 1302. After the calculated time passes, the computing unit 1311 may then send a command moving the additive valve 1308 and the tank valve 1304 to the off position. The calculated time is determined by a calculation made by the processor 1316 based on instructions stored in the memory 1324. The calculation is made by taking the pH measurement, the volume of liquid in the tank 1302, the amount of change a unit of pH down additive will make to a corresponding unit of liquid in the tank, and the flow rate of pH down additive from the pH down additive tank 1312 to the tank 1302. The calculation results in the amount of time the additive valve 1308 and the tank valve 1304 should be held open to allow pH down additive to flow in to the tank 1302. The calculation should allow the proper amount of pH down additive to flow in to the tank 1302 to cause the liquid in the tank 1302 to move downward to a pH of 6.0.

Alternatively, the sensor package 1320 may send a measurement below 5.8 for the liquid in the tank 1302. This is a less common result, especially when water is used as the liquid, but the computing unit 1311 recognizes that there is a measurement outside of the user selected parameters for pH, and performs the calculation for the pH up additive. Similar to the pH down additive, the pH up additive flows from the pH tank 1330, and specifically the pH up additive compartment 1310, through the additive valve 1308 and tank valve 1304 before entering the tank 1302. The computing unit 1311 uses the flow rate for the pH up additive in the calculation, as it may differ from the flow rate for the pH down additive. For example, the pH down additive may have a different density or viscosity than the pH up additive. Similar to the process for the pH down additive scenario, the computing unit 1311 may send a command that opens the additive valve 1308 and tank valve 1304 to establish a fluid communication between the pH additive tank 1330 and the tank 1302. After the calculated time has elapsed, the computing unit 1311 then sends a second command to close the additive valve 1308 and the tank valve 1304. Again, the added pH up additive should bring the pH of the liquid in the tank 1302 to 6.0, or the center of the parameter range if an alternate pH range has been input by the user.

Similar to the measurements for pH, the sensor package 1302 may also measure the EC of the liquid in the tank 1302 at specified intervals. Each of the smart hydroponic system modules 1300a-h may contain different varieties of plants, and different plants require different nutrient solution concentrations for growth. It is beneficial to control nutrient solution concentrations in order to provide the improved conditions in the liquid. This allows the improved uptake of nutrients into the rest of the plant's cellular structure. Nutrient solution concentration can be monitored and controlled using electrical conductivity measurements. Electrical conductivity is measure of the ionic strength of a solution and can be converted into concentration. The concentration may be measured in parts per million (PPM). The ability to provide localized control of the smart hydroponic system module 1300 means that different varieties of plants may be grown under a single roof, as the EC may be customized to the plants being grown in any particular tank 1302. When the EC sensor in the sensor package 1320 measures an EC which is too high for the stored parameters, the computing unit 1311 may perform a calculation. The calculation may first determine the volume of water in the tank 1302 using the water level measurement from the same time period as the too high EC measurement. The computing unit 1311 may then calculate how much liquid should be added to the tank to bring the EC down to a center of the user specified parameters. The calculation may be based on the known flow rate through the tank valve 1304 from the liquid source 1306. From this, a time may be determined to leave the tank valve 1304 open to provide the proper amount of liquid from the liquid source 1306. By adding liquid 1306, the PPM of the EC will move lower, because those PPM are now placed in a greater volume of liquid. In order to accomplish the adding of the liquid, the computing unit 1311 may then send a command to the tank valve 1304 to open to provide fluid communication between the liquid source 1306 and the tank 1302. Liquid will flow from the liquid source 1306 through the tank valve 1304 and in to the tank 1302. After the specified time interval, the computing unit 1311 may send another command to the tank valve 1304 moving the tank valve 1304 to the off position. When the tank valve is in the off position, flow through the tank valve 1304 is blocked.

When the EC sensor in the sensor package 1320 measure an EC which is too low, the computing unit 1311 may perform a calculation. The calculation may first determine the volume of water in the tank 1302 using the water level measurement from the same time period as the too high EC measurement. The computing unit 1311 may then calculate how much fertilizer should be added to bring the measured EC up to the center of the parameters set by the user. For example, if a user sets EC parameters of 2.0 on the high end, and 13.0 on the low end, the calculation will determine the amount of fertilizer to bring the liquid to an EC of 13.5. Similar to the pH parameters discussed above, the parameters for EC may be set by a user, and may be chosen based on a number of factors. Regardless of exactly where the parameters are set, the computing unit 1311 will calculate adjustments to a center of the parameters. Again, the calculation is based on a flow rate of the fertilizer from the fertilizer tank 1314, through the additive valve 1308 and tank valve 1304 and in to the tank 1302. Based on the measurements and known data, the computing unit 1311 can determine a time period. The computing unit 1311 then sends a command opening the additive valve 1308 and tank valve 1304 to establish fluid communication between the fertilizer tank 1314 and the tank 1302. After the calculated time, the computing unit 1311 sends another command moving the additive valve 1308 and the tank valve 1304 to the off position, closing fluid communication between the additive valve 1308 and the tank 1302. The fertilizer used may be a liquid fertilizer. Alternatively to the additive valve 1308 and tank valve 1304 configuration, the smart hydroponic module 1300 may use a manifold configuration, with the pH up compartment, pH down compartment, the fertilizer, and the liquid source each having a separate valve which is electrically connected to the computing unit 1311. The manifold has an outlet which is in fluid communication with the tank 1302.

The measurements and adjustments, if required, described above continue throughout the time the light fixtures 1322 are on. At the end of the time period for the light fixtures 1322 to be on, if automated, the central controller 1400 may send a command to all of the connected smart hydroponic system modules 1300a-h which have a light fixture 1322 turned on. The command may include information for shutting the light fixtures 1322 off. The command may include information that ramps the lights down to a complete shut-down, in a reversal of the ramping up when they lights were turned on. The command may specify time intervals for ramping down, and the wattage reduction to be made with each time interval. The central controller 1400 may alternatively send a series of commands with each wattage reduction at the specified time intervals. Thus, there are two alternatives, a single command from the central controller 1400 with all of the data, and decentralized execution by the computing units 1311 of the various smart hydroponic system modules 1300a-h, or control retained by the central controller 1400 as the central controller 1400 sends out wattage reduction commands with no further data at specified time intervals to the smart hydroponic system modules 1300a-h. Either way, the central controller 1400 may cause the smart hydroponic system modules 1300a-h to ramp their light fixture 1322 wattage down to simulate a sunset, and then to finally shut down. Again, both the time intervals and the wattage settings may be user selected parameters added to the central controller 1400 by the user.

After the central controller 1400 or computing units 1311 complete the ramp down and the light fixtures 1322 are shut down, the remaining components of the smart hydroponic system module 1300 continue to function. As discussed above, both the temperature sensor 1318 and the sensor package 1320 may continue to take measurements and pass the measurements as data to the computing unit 1311. In the unlikely event that the temperature sensor 1318 or the temperature sensor in the sensor package 1320, should a temperature sensor be included with the sensor package 1320, provide a measurement that would trigger a command to dim or shut off, nothing happens because the light fixture 1322 is already shut off. The fact that the light fixture 1322 is shut off in no way affects the operation of the other sensors in the sensor package 1320, and potential resulting commands, as described above.

Because all the measurements of the sensor package 1320 and potential resulting commands from the computing unit 1311 are localized, most functions of the smart hydroponic system module 1300 will continue even if the central controller 1400 should fail. This is due to the above described open loop/closed loop hybrid architecture of the smart hydroponic system module 1300 and the central controller 1400. The open loop/closed loop hybrid architecture places the tasks in the hands of the components that can beneficially accomplish them. Because the Sun rises on an entire farm at approximately the same time outdoors, it makes sense to have a central controller 1400 turn on all the light fixtures 1322 at the same time. However, as discussed above, even indoor environments may vary in temperature, humidity, and other factors that may affect hydroponic systems. Thus, the remaining measurements and adjustments may be left to the local control of the computing unit 1311 of the hydroponic smart system 1300. Moreover, such measurements and adjustments are automated, as described above. The automation of such tasks greatly reduces the labor required to operate a hydroponic operation, and the localized control of the smart hydroponic system module 1300 ensures that the system will provide optimum conditions down to the single light fixture and tank level. This localization, will in turn, guarantee the largest possible crop yields at the lowest labor levels.

### Example Systems of Internet of Things

Disclosed is an Internet of Things (IoT) system and method. With further reference to FIG. 1, the IoT system 100 may have a plurality of key technologies which enable the function of the system and method. The first technology may be the electrical wiring infrastructure which was built along with a structure, building complex, neighborhood, or city to provide power to the structure, building complex, neighborhood, or city. The electrical wiring infrastructure provides a ready-made network for the system. The next technology applied to create the IoT system 100 includes a foundational architecture incorporated in either IoT devices or sensors connected to the power line network. The foundational architecture allows the IoT devices and sensors to send messages to each other, and to a universal device on the system. One key component of the foundational architecture may be a transceiver of a specific design which encodes binary information in a specific way. The transceivers create communication signals which are placed on the power line wiring infrastructure. This power line communication (PLC) signal is placed on the electrical wiring in addition to the power signal already present. The transceivers may each be connected to a processor and a memory. The memory may store a protocol which executes on the processor to send a PLC control signal or other data on the power lines. The PLC control signal may allow the IoT devices and sensors including the transceivers to communicate with each other directly. The IoT devices and sensors may also communicate with a transceiver enabled universal device connected to the power line network. The universal device may allow a smart device to access the IoT system either through a wired or wireless connection. The smart device may act as a central control device to give the IoT system a hybrid open loop/closed loop architecture as is described in further detail below.

The devices may include IoT devices which perform a variety of functions and sensors either operating independently or in conjunction with an IoT device. Each of the IoT devices and sensors may have a foundational architecture which allows the device to communicate on the IoT system. From this foundational architecture, that is, a combination of computer hardware and software, additional computer architecture may be added to the IoT device or sensor to provide the IoT device with any function or set of functions desired by the designer. However, generally speaking, the sensors generally include additional architecture which allow the sensor to collect data which may be used to change the functioning of an IoT device. The IoT devices themselves can perform a single function or set of functions. These functions may be computer functions, mechanical functions, or other functions, or a combination of functions. The foundational architecture is also secure, because during customization, a designer may add any architecture on top of the foundational architecture. When a designer does this, the designer may choose the protocol that the added computer architecture uses to interface with the foundational architecture.

The final technology in the plurality of technologies is that embodied by the universal device. The same foundational architecture of the IoT devices and sensors or may be included in the universal device. The universal device may perform various device management functions and may allow access, both wired and wireless, to devices which do not natively use the PLC protocol to communicate on the network directly. The device management functions may allow a computing device connected to the universal device, either through a wired or wireless connection, to send control signals for controlling various functions of one or more of the IoT devices, or for setting parameters used by the sensors for closed loop functions. Thus, the universal device performs critical functions in enabling the open loop operation of the IoT system.

More specifically, with reference again to FIG. 1, the IoT system 100 may include a computing device 102. The computing device 102 may be a mobile computing device. For example, a mobile computing device such as a smartphone or tablet running an Android®, iOS®, or Windows® operating system. The software application running on the computing device 102 may be an application, often abbreviated as an “app,” programmed to operate on, for example, Android®, iOS®, or Windows® operating systems, or a combination of more than one of the operating systems. The computing device 102 may also be a laptop or a desktop computer. The laptop or desktop computer may include a software package available for personal computers running operating systems such as Microsoft® Windows®, Mac® OS, Unix, Linux, etc., or a combination of more than one of the operating systems. Alternatively, the computing device may be any device which provides a display to display control surfaces, and allows the control surfaces be manipulated to send commands to one or more IoT devices and parameters to one or more sensors on the IoT system. The computing device 102 may also receive data from designated IoT devices or sensors, or both, on the IoT system, and provide a display populated, at least in part, by the received data. In systems were essentially real time data is being taken by the sensors, the volume of data may be enough to overwhelm the computing device, causing the computing device to cease operating. Thus, only a portion of the data collected by the sensors may be sent to the computing device. The computing device may further summarize the sent data for display. The computing device may be connected to a universal device through a wired or wireless connection.

The computing device 102 may be electrically connected to the universal device 104. The universal device 104 may include programming which allows the universal device 104 to interoperate with computing devices 102 using various operating systems. Because of this feature, not only may more than one computing device 102 be used with the system, but each computing device 102 may have a different operating system. The system may operate with only a single computing device 102 accessing the system through the universal device 104 at a time, or the system may allow more than one computing device 102 to access the universal device 104 at a time. This interoperation is part of what makes the universal device 104 operate in a universal manner. The universal device 104 may receive messages from, and send messages to, any computing device 102 which a user wishes to place in to operation with the IoT system 100, making the universal device 104 agnostic in regard to the interoperability with computing devices 102 using any of a number of operating systems.

The universal device 104 may connect to the computing device 102 through a wired or wireless connection and, additionally, the universal device 104 may connect to a power line 112 which provides the communication backbone for the IoT system as a whole, and specifically, the IoT devices 130a-h and sensors 131a, 131b. The universal device 104 incorporates several modules of computer architecture, that is, assemblies of combined hardware and software, which enable the universal device 104 to perform its functions on the IoT system 100. One of these modules of computer architecture is the foundational architecture. The foundational architecture may include a transceiver. The transceiver may be connected to a processor. The processer may be connected to a memory which stores an open source PLC protocol. While existing electric wiring may provide the network infrastructure for the IoT system, the PLC protocol actually forms and sends the messages used to communicate to the IoT devices and sensors.

Alternatively, or in addition, the IoT system 100 may include a display panel 103 hardwired to, or integrated with, the universal device 104. The display panel 103 may include touch screen technology and software which allows a user to control IoT devices 130a-h and set parameters for sensors 131a, 131b on the IoT system 100. For example, the display panel 103 may include programmable logic controller technology. The programmable logic controller may be integrated with the universal device 104. Thus, the display panel 103 may allow a user to use the computing device 102 as an extension of the display panel 103, or to operate devices and sensors on the IoT system 100 from the display panel 103. Thus, the display panel 103 and the computing device 102 can be used in parallel, for example, to operate two different IoT devices or send parameters to sensors, or monitor data being taken by sensor contemporaneously. Alternatively, the display panel 103 may be a tablet computer. The table computer may also be integrated with the universal device 104. The display panel 103 may include a wireless module which allows the display panel 103 to communicate with the computing device 102, and allows for pass through of computing device 102 messages to the universal device 104. For ease of explanation, when used in the remainder of this disclosure, the term “universal device,” is understood to include the display panel 103 unless specifically stated otherwise.

The universal device 104 and display screen 103 combination may include a screen which allows a user to view data passed from one or more IoT devices 130a-h or sensors 131a, 131b and to generate commands to be sent to one or more of the IoT devices 130a-h or sensors 131a, 131b for action. The universal device 104 may include a number of circuits and components which would be common to design from scratch IoT devices.

These features are typically redundantly included in design from scratch IoT devices. By way of example and not limitation, both a thermostat and a sprinkler control system may include display screens. Rather than have a display screen on both of the sprinkler control system and the thermostat, the display on the computing device 102 or on the universal device 104, or both, provide a display which performs all the display tasks for the IoT system 100. Thus, this one display on the computing device 102 or the universal device 104 replaces the screens on the traditional sprinkler system and thermostat. The universal device 104 may include other circuits or components that would be common to all design from scratch IoT devices. The inclusion of these components and circuits in the universal device 104 or computing device 102 or both, through either hardware or software, integrates tasks which would normally be performed by a traditional peripheral device in to the universal device 104 and the computing device 102.

The transceiver 126a-i, processor 127a-h 136a, 136b, memory 123a-h, 134a, 134b, and PLC protocol are all part of the foundational architecture shared by the universal device 104, the one or more IoT devices 130a-h, and the one or more sensors 131a, 131b. This foundational architecture ensures that any device or sensor added to the IoT system 100 will be able to communicate with the computing device 102 through the universal device 104, the universal device 104 itself, the IoT devices 130a-h on the IoT system 100, and the sensors 131a, 131b on the IoT system 100. The foundational architecture allows IoT device and sensor designers to design from the foundational computing architecture rather than designing from scratch. This not only saves design time by eliminating redundancy of design, but it also guarantees that any IoT device or sensor designed will be able to interoperate with other IoT devices, sensors, and universal devices, and that control signals sent from, and data sent to, a computing device accessing the IoT network through a universal device will be able to operate IoT devices and receive feedback and data from the IoT devices and sensors. Thus, with the wiring infrastructure essentially ubiquitous, and the computing architecture designed and ready for customization, IoT devices and sensors of the disclosed IoT system may be produced at much faster rates.

This foundational architecture may be added to in order to customize IoT devices 130a-h and sensors 131a, 131b. IoT devices may be customized by adding computer architecture or other hardware which enables the IoT device to perform a function or set of functions. The protocol used by the designer of the IoT device for operating the customized hardware, as part of the customized computer architecture or other hardware, may interoperate with the protocol however the designer desires. The software portion of the computer architecture may be designed so it can convert messages from and to the PLC protocol, but then may be translated into a protocol chosen or designed by the designers to make the hardware on the IoT device function according to the control signals of the PLC protocol. This allows the protocol that operates the hardware of the customized portion to be kept largely, if not completely, proprietary. Also, the requirement not to use the PLC protocol throughout the entirety of IoT devices and sensors may allow for greater design efficiency, as these IoT devices and sensors do not have to be designed around a single protocol for their operation, but may take advantage of existing computer architecture, including designer created protocol for operation of the IoT devices and sensors.

Each of the one or more IoT devices 130a-h may be electrically connected to one or more sensors 131a, 131b either directly or through the power line 112. Alternatively, one or more sensors 131b may be integrated with an IoT device. For example, the IoT devices 130a-h may include lights, fans, outdoor sprinkler valves, garage door openers, automated blinds, thermostats, doorbell camera systems, and medical devices, among others. The sensors may measure various aspects of the environment or the IoT system itself. For example, the sensors may measure power levels of batteries, temperature, current flow, wind speed, pH level, electrical conductivity in water, and light levels, among other types of measurements. The PLC protocol allows both control signals and raw sensor data to be converted by the PLC protocol to messages that may be sent on the IoT network. Each of the IoT devices 130a-h and independent sensors 131a may include a transceiver 126a-I which generates signals, and transmits the signals to the power line 112. The signals may include control signals, including commands, parameters for use in sensors, and data signals including measurement results.

A PLC transceiver 108 may be integrated with the universal device 104. The primary function of the PLC transceiver 108 is to send signals as directed by the controller, or the computing device 102, or both. The PLC transceiver 108 sends a signal upon which control information is encoded. The PLC transceiver may also receive data signals from the IoT devices 130a-h and sensors 131a. 131b. For example, the IoT devices 130a-h or sensors 131a, 131b may send acknowledgements of messages or self-identification information to the universal device 104.

The PLC transceiver 106 may include a single crystal oscillator 110. When power is applied to the crystal oscillator 110, the crystal oscillator 110 produces a signal at a frequency based on the structure of the crystal oscillator 110. The signal produced by the crystal oscillator 110 may be sent to an output. From the output, the signal may be split on two different signal paths. Alternatively, the PLC transceiver 106 includes two crystal oscillator circuits 110a, 110b. The crystal oscillator circuits draw power from the power line 112. The power is taken from the power line 112 and transformed down from 110V to 0.1V. On a 10 amp circuit of the power line 112, the 0.1V of transformed voltage produces one watt of power for the crystal oscillator circuit. As long as the crystal oscillator circuit 110a, 110b receives power, the crystal oscillator will continue to output a wave signal.

Crystal oscillators emit a sinusoidal wave at a frequency determined by their physical structure. The crystal oscillators, and particularly quartz crystal oscillators, have a very high Q factor. The Q factor, as is well known in the art, is the resonant frequency of the crystal divided by the bandwidth. Quartz crystal oscillators are capable of primary frequencies in the high kHz up the MHz range. Also, as indicated by the high Q factor, they have a narrow bandwidth. A typical Q factor for a quartz oscillator ranges from 104 to 106, compared to 102 for an inductor and capacitor, or LC, oscillator. The maximum Q for a high stability quartz crystal oscillator can be estimated as Q=1.6×107/f, where f is the resonant frequency in megahertz.

Another aspect of a quartz crystal oscillator is that a quartz crystal oscillator exhibits very low phase noise. In many oscillators, any spectral energy at the resonant frequency is amplified by the oscillator, resulting in a collection of tones at different phases. In a crystal oscillator, the crystal mostly vibrates on one axis, therefore only one phase is dominant. Low phase noise makes crystal oscillators particularly useful in applications requiring stable signals and very precise time references.

A quartz crystal provides both series and parallel resonance. The series resonance is a few kilohertz lower than the parallel resonance. Crystals below 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit has to be exactly that specified by the crystal manufacturer. Note that these points imply a subtlety concerning crystal oscillators in this frequency range: the crystal does not usually oscillate at precisely either of its resonant frequencies.

Crystals above 3 MHz (up to >200 MHz) are generally operated at series resonance where the impedance appears at its minimum and equal to the series resistance. For these crystals the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit usually includes additional LC circuits to select the desired overtone.

The transceiver 106, may include a single crystal oscillator which is output to two different signal paths 110a, 110b. Each of the signal paths may further modify the signal on that path, as described in detail below. Alternatively, the transceiver 108 may include two crystal oscillator circuits, one on each signal path. The crystal oscillator circuits may be essentially identical, and may include some amplification. Each crystal oscillator circuit includes an output. The signal generated by each of the crystal oscillator circuits is sent to the output.

A signal on one signal path 110a is next routed to a phase shift sub-circuit 116 to phase shift that signal. The phase shifted signal is then routed to one terminal of a switch 114. The signal on the other signal path 110b is routed to the other terminal of the switch 114. The switch 114 may be a fast switching operation, as is well known in the art, or any other switch which is able to provide fast enough switching, including transistors which may act as switches by having a voltage applied to, and then disconnected from, the base of the transistor. The switch 114 may have the form of a single pole, dual throw, or SPDT switch. An output may be connected to the common of the switch 114. The speed of the switch 114 allows for very rapid alternation between the first signal and the phase shifted second signal. By way of example and not limitation, the switch 114 may cycle fast enough to switch 10 times from the first signal to the second signal and back to the first signal in a single cycle of a 40 MHz signal. Thus, there is an opportunity, depending on the PLC protocol used by the system, to send 10 bits of information in a single 40 MHz cycle, all without interference by noise. In this example, the IoT system 100 could generate 400 million bits of information a second on a bandwidth of a single frequency. Alternatively, the switch 114 may cycle fewer than 10 times in a 40 MHz cycle, or more than 10 times in a 40 MHz cycle. Still further alternatively, the crystal oscillator may generate a sinusoidal wave at more than 40 MHz or less than 40 MHz. The operation of the system, including the creation and switching between the sinusoidal waves produced by the crystal oscillators is discussed in detail below. The transmission portion 106 is electrically connected to a transceiver output, which is in turn connected to the power line 112.

The universal device may include a memory 122 on which the PLC protocol is stored, and a processor 124 which is electrically connected to the memory 122, and on which the PLC protocol is executed. The PLC protocol may include a portion which interprets commands sent by the display screen 103 or computing device 102, or from an IoT device or a sensor transceiver. The PLC protocol, executed by the processor 124, accomplishes the encoding of the sinusoidal waves generated by the crystal oscillator circuits 110a, 110b, one of which is then phase shifted, by controlling the switch. Additional details related to PLC are discussed in International Patent Application Publication No. WO 2021/107961, which is hereby incorporated by reference herein.

The IoT devices 130a-h and sensors 131a, 131b may be connected to the wiring infrastructure by a cord with a plug configured to fit a standardized socket in an outlet 132a-h connected to the power line 112. The universal device 104 may be hardwired to the electrical power line 112, or may also include a cord which plugs in to a socket in an outlet. The socket may be placed in a junction box where it can be accessed either inside or outside of a structure.

Moreover, the IoT devices 130a-h and sensors 131a, 131b for traditional non-IoT devices, for example, lamps, can, in addition to making the lamp part of the IoT system 100, add smart features to the lamp. For example, a dimming feature, controllable by the computing device 102 and the universal device 104, may be added to the IoT devices 130a-h and sensors 131a, 131b for the lamp. The IoT devices 130a-h and sensors 131a, 131b could use a variable resistor, the level of which may be set by a control surface on a user interface created by a software application, to vary the wattage to the lamp. Thus, lamps which were previously either on or off only may now be dimmed. Thus, not only may features be off loaded to the computing device 102 and the universal device 104 to remove common circuits and components from the module, but, as is show with the lamps, new features may be added that would have been prohibitively expensive to add to a lamp without the disclosed IoT system 100.

IoT devices for the disclosed IoT system may also be designed without any regard to requirements for an IoT device to operate as a stand-alone device. With this design style, only the most unique functions are added to the foundational architecture to create the newly designed IoT device, while the redundant and common circuits and components are off loaded to the computing device 102 and universal device 104. The cost to produce IoT devices 130a-h using this design paradigm drives the cost much lower than the traditional devices they replace. Because some of the functions previously performed on the traditional IoT device are off loaded, in the disclosed IoT system 100, to the computing device 102 and universal device 104, the components for those functions are no longer needed by the IoT devices 130a-h and sensors 131a, 131b. Centralizing functions and their corresponding components lowers the cost to produce an IoT device 130a-h or sensor 131a, 131b while also making the IoT system 100 more user friendly. The IoT system 100 may be more user friendly because a user no longer has to physically go to each IoT device or sensor in order to operate the device or obtain data from it, for example, going to a sprinkler system controller to operate the sprinkler system, or to the installation site of a thermostat to operate the thermostat. Rather, the user can operate all of the IoT devices 130a-h and change parameters on sensors 131a, 131b on the IoT system 100 from a single location. That location may be a mobile due to a wireless connection. For example, a computing device 102 with a wireless connection to the universal device 104. Alternatively, the location may be a fixed location with a desktop computing device 102, or a display panel 103. Still further alternatively, all of the above computing devices may be used in any combination, and therefore be mobile or fixed as the user desires. As can be easily understood from the discussion of the components of the IoT system 100, the disclosed IoT system 100 is customizable to almost every implementation. The ability to customize allows the system to be used in both industrial and residential applications. The IoT system 100 may be based around the universal device 104. A computing device 102 may make control easier, for example, by placing the ability to control in a user's pocket, but is not required for operation of the IoT system 100. Further, there may be more than one model of the universal device 104. By way of example and not limitation, the universal device may have a first model which relies on the computing device for the display, and all commands must be sent using the computing device. Alternatively, another model of the universal device may be integrated with a display screen as discussed above. This model may allow parallel use of the display screen and computing device in sending commands, or for a user to choose between exclusive use of the display screen or computing device from time to time.

The universal device 104, IoT devices 130a-h and sensors 131a, 131b may be purchased based on what a user needs the IoT system to accomplish. If a user knows that a universal device will almost always be connected to a computing device, that user may not need a universal device with a display screen. A user living in a home in a geographic region with heavy year-round rainfall may choose to not purchase sprinkler system related IoT devices and sensors because the user's home does not have sprinklers. However, the same user may purchase one or more light fixture IoT devices to intelligently control the lighting of the home.

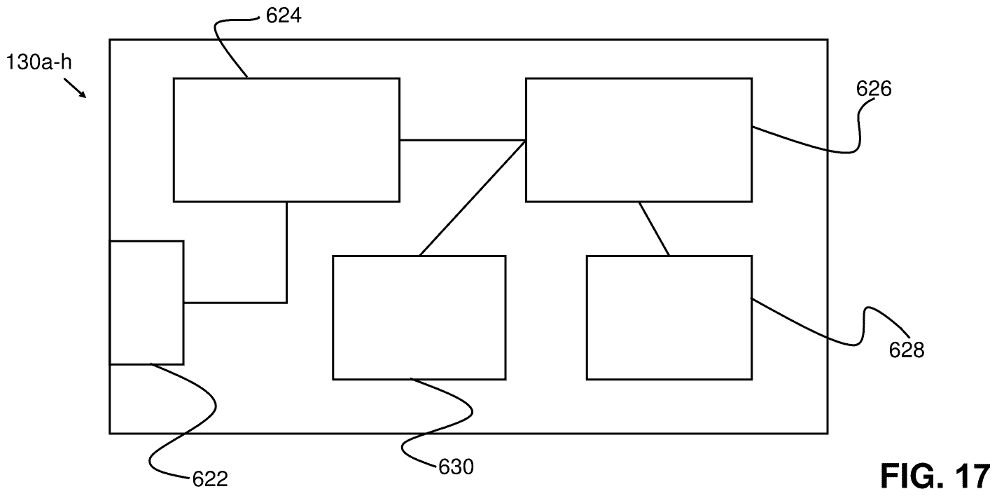

In operation, with reference to FIGS. 1, 5, 10, and 15-17, when a computing device 102 is connected to IoT network though the universal device 104, the computing device 102 may send a message to the universal device 104 requesting initialization information regarding connected IoT devices 130a-h and sensors 131a, 131b. Additionally, when a new IoT device 130a-h or sensor 131a, 131b is connected to the IoT network, the IoT device 130a-h or sensor 131a, 131b may automatically send initialization information to the universal device 104. Alternatively, as part of the universal device's device management functions, the universal device 104 may detect the newly added IoT device 130a-h or sensor 131a, 131b and the universal device 104 may request initialization information from the newly added IoT device 130a-h or sensor 131a, 131b. The initialization information may include the type of IoT device 130a-h or sensor 131a, 131b, what controllable functions the IoT device 130a-h or sensor 131a, 131b has, and what the parameters may be changed to enable the operation of a sensor or to control the functions of an IoT device.

With reference to FIGS. 1 and 10, the initialization information may be used by a software application stored on the computing device 102 to create a user interface 1000. The user interface 1000 may have control surfaces 1002, 1004 for controlling the parameter values of the functions.

The universal device 104 may, in turn, send some or all of the initialization information to the computing device 102. The initialization information may include an identifier for the IoT device 130a-h or sensor 131a, 131b. The identifier may be a binary sequence. The initialization information may further include which features may be controlled through the user interface 1000, and which type of control surface 1002, 1004 corresponds to each feature. The self-identification information may also include what control parameters correspond to the control surface 1002, 1004 for controlling a particular feature. Control parameters may include what category of control, that is, a brightness level, a time period, or other category. Control parameters may also include the range of possible parameter values, as is described in detail below.

With reference to FIGS. 1 and 10, the computing device 102 includes in the app a subroutine which receives data from the universal device 104 and creates a user interface 1000. The app receives the initialization information from the universal device 104. The initialization information may provide how many IoT devices 130a-h and sensors 131a, 131b are on the IoT system, a unique identification for each, the available function or functions for the one or more IoT devices 130a-h and available parameters for the one or more IoT devices 130a-h and sensors 131a, 131b. Using the initialization information, the app on the computing device 102 may automatically create a user interface 1000. There is no action required by the user to create the user interface 1000 beyond connecting the computing device 102 to the universal device 104 and opening the app.

The user interface 1000 may include one or more screens. The one or more screens may include screens which display data including a condensed amount of data from each of the sensors. Alternatively, or in addition, a single screen may include an average of the measurements taken by one type of sensor. The user interface may include one or more screens for controlling the one or more functions of the one or more IoT devices. The one or more screens may include control surfaces.

By way of example and not limitation, the control surfaces may map to a specific IoT devices 130a-h and sensors 131a, 131b. The IoT device 130a-h may have a first function which responds to a binary control parameter. This control parameter may be, for example, state of operation control parameter which includes the values “on” and “off.” As a part of the user interface 1000, the software application may create a control surface 1002 corresponding to the function and control parameter. In the case of a binary control parameter the user interface 1000 may include a control surface 1002 which includes two radio buttons 1006, 1008. A first radio button 1006 may allow a user to send a command turn the system module on by selecting the first radio button 1006, which is labelled “on,” and a second radio button 1008 may allow a user to send a command turning the system module off by selecting the second radio button 1008, which is labelled “off.”

The screen on the user interface may have an additional control surface. The control surface may map to the same IoT device. The IoT device may have a second function which has a control parameter which includes a range of values. For example, the range of values may be a wattage value, or may be an indexed number, for example 1 to 10, used to designate levels of resistance in a circuit, to control a volume level. As a part of the user interface 1000, the software application may create a control surface corresponding to the function and control parameter. In the case of a control parameter with a range of values, the user interface 1000 may include a control surface 1004 which includes a scale of values. As shown in FIG. 10, the values range from 1 to 10. However, it is understood that the values may begin at any number, and may end at any number. The range of values may be more than 10, and the range of values may be less than 10. The user may slide the marker 1010 along the scale 1012 to each of the indexed positions in order to control the function.

The one or more sensors 131a, 131b connected to the IoT system 100 may each have a screen. On the screen may be information, including what type of data the sensor 131a, 131b measures. As will be described in detail below with regard to closed loop operation of portions of the IoT system 100, the sensor 131a, 131b may have certain parameters which may be set which will affect the operation of the sensor 131a, 131b, specifically, if the sensor 131a, 131b takes a measurement matching set parameter value, then the sensor 131a, 131b may send a control signal to one or more pre-determined IoT devices 130a-h to control the operation of the one or more pre-determined IoT devices 130a-h.

A user may send control signals from the user interface 1000 to control one of the one or more IoT devices 130a-h. Alternatively, or in addition, the user may send control signals from the user interface 1000 to control a plurality of the IoT devices 130a-h. In a similar way, the user may send control signals from the user interface 1000 to set parameters for a plurality of the one or more sensors 131a, 131b.

The PLC protocol is designed so that control signals include an identifier as to which of the one or more IoT devices 130a-h and sensors 131a, 131b the message is directed. Although eight IoT devices 130a-h and two sensors 131a, 131b are shown, it will be understood that the IoT system 100 may have more than eight IoT devices and two sensors or less than eight IoT devices and two sensors. If a message is not directed to a particular IoT device 130a-h or sensor 131a, 131b, that IoT device 130a-h or sensor 131a, 131b ignores the message. The PLC protocol may further include an identifier that includes all of the IoT devices 130a-h and sensors 131a, 131b. Using the identifier which includes all of the IoT devices 130a-h and sensors 131a, 131b, a user may send a control signal which affects all of the IoT devices 130a-h and sensors 131a, 131b, for example, to turn off all of the IoT devices 130a-h and sensors 131a, 131b. The control surfaces which affect all of the IoT devices and sensors on the IoT system may be on a separate screen.

The computing device 102 may access the IoT system 100 through the universal device 104, which means that the universal device may receive all control signals sent by the computing device and transmits all data and acknowledgements sent by the IoT devices and sensors to the computing device, over either the wired or wireless connection. In addition to these communications functions, the universal device 104 performs several other functions. First, the universal device 104 converts the messages of the computing device 102 to the PLC protocol. The universal device 104 includes instructions which allow the universal device 104 to recognize which operating system the computing device 102 is using, and establish bilateral communication with the computing device 102. Then, when the computing device 102 sends messages, the universal device 104 converts the messages in to the PLC protocol used for communication between the universal device 104 and the IoT devices and sensors 106a-h. Second, the universal device 104 provides routing functions for messages sent by the computing device 102 to the various IoT devices and sensors 106a-h and between the IoT devices and sensors. Third, the universal device 104 provides device management. When a new IoT device or sensor 106a-h is added, the universal device 104 may detect the addition of the IoT device or sensor 106a-h and request initialization information from the IoT device or sensor 106a-h. The initialization information may include an identification code for the IoT device or sensor 106a-h, what functions the IoT device or sensor 106a-h has, and what the control parameters for the functions are. The universal device 104 may store this information in a non-transient media memory 122.

The one or more IoT devices 130a-h or one or more sensors 131a, 131b, or both, include circuits and components which perform functions. For example, every room in a structure may need one or more lighting fixtures. Each of these lighting fixtures may be IoT devices. The light functions may have one or more control surfaces 1002, 1004. For example, there may be a first control surface 1002 for “on,” which turns the light on at maximum brightness, and a second control surface 1004 which affects the wattage output of the light, commonly known as a dimmer. The second control surface 1004 may be represented as a slide, or an indexed slide 1012. Alternately, only the second control surface 1004 may be used, and set to o watts or “off” when the control surface is at a minimum setting and at max brightness when the control surface is set to the opposite side. When a user manipulates the control surfaces on the computing device, the user interface generates messages which are sent to the universal device 104. As described above, the messages may then be converted to control signals by the PLC protocol. These control signals are broadcast on the power line 112 by the universal device 104. The sole function for most sensors may be taking a particular type of measurement and sending the result of the measurement as data to the universal device 104 and, ultimately, the computing device 102.

The display screen 103 as part of the universal device 104 or computing device 102 may be used as a system interface by a user (not shown). Certain control signals which may be executed by the PLC protocol may be indicated by visual representations, or control surfaces, on the touch screen. For example, the control signals may be indicated by icons or text, or a combination of both. When a user touches the portion of the screen with the visual representation, it causes a control signal to be sent in a message to the universal device 104, which interprets the control signal using the PLC protocol.

In forming the control signal, the universal device 104 includes identification information as to which of the one or more IoT devices 130a-h or which of the one or more sensors 131a, 131b the control signal is directed. As discussed above, the identification information ensures that the correct IoT device or sensor, or both receives the control signal, and other IoT devices and sensors are on notice that the control signal is not directed to those other IoT devices and sensors. If an IoT device 130a-h or sensor 131a, 131b determines that the control signal is directed to that IoT device 130a-h or sensor 131a, 131b, then the IoT device 130a-h or sensor 131a, 131b processes a command contained within the control signal. The command directs a change in the one or more functions of the IoT device or sets a parameter value for the sensor. As discussed above, the PLC protocol command may be converted to a proprietary command for execution by the one or more IoT devices or sensor. Customized hardware built on the foundational architecture of the IoT device 130a-h or sensor 131a, 131b may complete the execution of the command. Contemporaneously, the IoT device 130a-h or sensor 131a, 131b may each generate a control signal directed to the universal device 104, and ultimately, to the computing device 102. The control signal may include an acknowledgement that the control signal directed to the IoT device 130a-h or sensor 131a, 131b was received. If such an acknowledgement is not received, the computing device 102 or the universal device 104 may resend the original control signal at pre-determined time intervals until the computing device 102 receives the acknowledgement.

The computing device 102 may also send parameters which affect the operation of one or more sensors 131a, 131b on the IoT system 100, as is described in greater detail below. The operation of the IoT system 100, from the manipulation of the control surface to the sending of the acknowledgement is the same, with the exception that the control signal includes a command which sets a parameter for the one or more sensors 131a, 131b. The parameter may set a parameter for the one or more sensors 131a, 131b. For example, if the one or more sensors are brightness sensors, then the parameter value may be a brightness value.

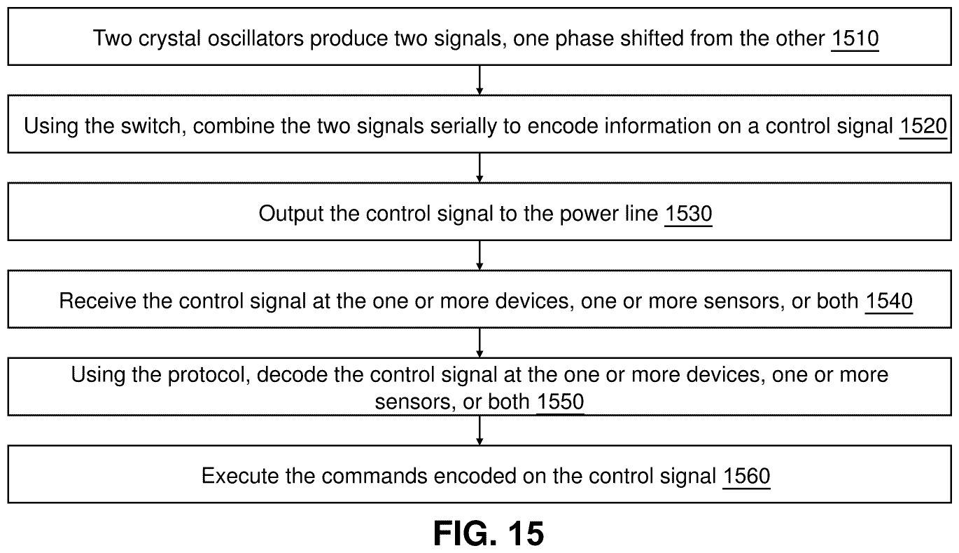

As shown in FIGS. 1, 5, 15, and 16, in order to send commands to one or more IoT devices 130a-h or sensors 131a, 131b, commands from the user interface 1000 on the computing device 102 or display screen 103 are converted to control signals by the universal device 104 using the PLC protocol. The control signal has two parts. The first part is two sinusoidal waves 510, 512, which two crystal oscillation circuits generate continuously, as shown in Step 1510 on FIG. 15. The second part is binary control information which is encoded using the sinusoidal waves, which is shown in Step 1520 of FIG. 15. After generation, the sinusoidal waves 510, 512 are fed to the connected switch 114, as is described above. The switch 114 is also connected to a processor 124 which executes the protocol by operating the switch 114. Based on the command signals from the computing device 102, which are converted by the processor in the universal device 104 using the PLC protocol, the processor 124 directs the switch 114 to switch between the two sinusoidal waves, one of which is phase shifted by the phase shift circuit 116 from the other. Information is encoded by switching the switch 114 from the non-phase shifted wave 510 to the phase shifted wave 512 and back to the non-phase-shifted wave 510. Each of the waves 510, 512 may represent a binary state. For example, one wave may represent a first binary state, for example, one, and the second wave may represent a second binary state, for example, zero. By adding each of the waves 510, 512 serially at certain intervals, control information which may be encoded by the PLC protocol. The resulting sinusoidal wave with the control information is called a control signal 500, and has some portions in a first phase state 502, and some portions in a second phase state 504.

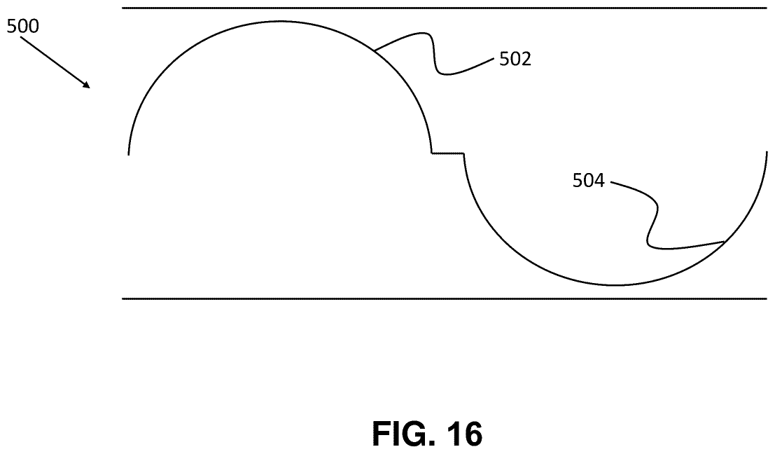

The timing for the switch 114 between waves 510, 512 with differing phase states may be set to a single cycle of the wave frequency. Alternatively, the timing may be set to a fractional portion of the cycle of the wave frequency. The timing may be specified within the PLC protocol. Thus, the number of cycles or fractions of a cycle one phase state or the other of the wave appears on the control signal, may be indicative of several consecutive instances of a binary state. In this way, the PLC protocol may interpret the control signal as a series of binary states, with the binary states representing either a one or a zero. Commands may be defined by the PLC protocol from differing binary sequences, or combinations of ones and zeros. As shown in FIG. 16, the timing of the control signal 500 is set to half a wave cycle, and the phase states 502, 504 change at the zero crossing. Sequences of ones and zeros may form data or commands that can be sent as messages over the power lines 112. These messages may be received by a receiver portion 108 of the transceiver 126a-i and analyzed and converted by the PLC protocol. As an example, one IoT device may be a light fixture and the system may further include a separate temperature sensor. Each of the light fixture and the temperature sensor may identify themselves using a binary code of a set number of digits. The identification may be a shorter or longer sequence than those of the commands. The PLC protocol may define a preliminary indicator which indicates the start of a command or data string, and a second indicator which indicates the command or data send is complete and requests that the lighting fixture or fixtures, or temperature sensors to which the command was directed send an acknowledgement. Similarly, the PLC protocol may use binary sequences to define commands. By way of example and not limitation, the PLC protocol may define that “1001” may correspond to a command to turn a lighting fixture to 100% of the wattage, while “1000” may correspond to a command to turn the lighting fixture off. The data and commands may be packaged as messages that include the preliminary indicator that a command or data follows, headers which identify to which lighting fixtures the command is directed, the command, and an indicator that the command is complete and a request for acknowledgement of the command by the lighting fixture or temperature sensor.

When the control signal 500 is created by combining sinusoidal waves 510, 512 of differing phase states, the amplitude and frequency of the resulting control signal 500 are the same as that of the two sinusoidal waves 510, 512. Only the phase is sometimes changed in creating the control signal 500. Thus, the control signal 500 is output to the power line 112 with the frequency and amplitude unaffected from when the sinusoidal waves 510, 512 were generated by the crystal oscillators. Also, the amplitude is unaffected at this stage, as the only amplification, if any, takes place within the crystal oscillation circuits.

Once the control information is encoded on the control signal 500, the control signal 500 is output to the power line 112 as is shown in Step 1530 of FIG. 15. The output is a broadcast throughout the power line 112. An exemplary control signal 500 is shown in FIG. 16. The control signal 500 includes alternating phase states 502, 504 at different intervals. The change in phase state may be seen at a zero crossing as the signal moves laterally one direction or another depending on which phase state the control signal is changing from, and which phase state the control signal is changing to.

Referring now to FIGS. 1, 5, 15, 16, and 17, if PLC is being used, on the receiving end, the control signal 500 is received on an input/output port 622 and passed to the transceiver 624 of the one or more IoT devices 130a-h or one or more sensors 131a, as is shown in Step 1540 of FIG. 15. The crystal filter of the transceiver 624 bandpasses only a bandwidth of 50 Hz or less centered on the transmission frequency of the crystal oscillator from the signal on the power line 112, allowing the remainder of the signal to remain on the line. Naturally, the rest of the signal on the power line 112 may be band passed so that the power on the power line 112 may be used to power the one or more IoT devices 130a-h and sensors 131a, 131b which may be connected. The 50 Hz or less bandwidth captures the control signal 500 because the phase shifting does nothing to spread the bandwidth of the original sinusoidal waves generated by the crystal oscillators, which are on a single frequency. That is to say, the control signal is not the result of encoding information by frequency modulation. Again, the frequency remains constant.

Following the filtering, the PLC protocol stored on a memory 628, and executing on a processor 626, on the one or more IoT devices 130a-h or one or more sensors 131a, 131b, detects and analyzes the information in the control signal 500. The control information encoded on the control signal 500 may be decoded and converted by the PLC protocol as is shown in Step 1550 of FIG. 15. The conversion may result in instructions which are executable to give commands to the one or more IoT devices and to set control parameters for the functions of the IoT devices 130a-h, or to set parameters for the one or more sensors 131a, 131b as is shown in Step 1560 of FIG. 15, and described above.

The use of ultra-narrow bandwidth and phase shifting combined with PLC protocol defined timing of the phase states 502, 504 in the control signal 500 provides robust protection against interference by electrical noise on the power line 112. In order for electrical noise on the IoT system 100 to interfere with the control signal, the electrical noise would need both reach in to the narrow bandwidth on which the oscillator is transmitting, and the filter is receiving, and to shift its phase to match the control signal 500. This kind of rapid phase shifting is uncommon in electrical noise, including the noise typically found on power lines 112. Thus, in addition to all the other ways the IoT system 100 is robust against electrical noise, in order to provide a clear control signal 500, even the manner in which the information is encoded within the control signal 500 provides robustness against interference by electrical noise. This largely mitigates concerns about electronic noise interfering with the control signal 500, and makes a separate wiring infrastructure even less attractive, given the cost of a separate wiring infrastructure.

The one or more IoT devices 130a-h and one or more sensors 131a, 131b may then execute the command sent. Contemporaneously, the one or more IoT devices 130a-h and sensors 131a, 131b may send a confirmation to the universal device 104 that the command has been received. Once the command has been executed, the one or more IoT devices 130a-h may further send an update to the universal device 104 showing the current operating state, including the new parameter setting. The updated operating state may be reflected in the user interface 1000. The universal device 104 may communicate with the computing device 102 to confirm the new state of operation for the one or more IoT devices 130a-h and sensors 131a, 131b.

Unlike previous IoT devices and ecosystems, the disclosed IoT system 100 allows for not only control signals 500 created or timed by a user accessing the IoT system 100 from a computing device 102 operating through the universal device 104, but the disclosed IoT system 100 may include sensors 131a, 131b sending control signals to IoT devices 130a-h in point to point communication on the IoT system 100. Thus, the disclosed IoT devices 130a-h and independent sensors 131a include a combination of hardware and software which allows for point to point communication without the need for messages to pass through the universal device 104 or any other device acting as a “hub” of the IoT system 100. Thus, in addition to the open loop operation in which the computing device 102 might originate commands, the IoT system 100 may operate in closed loop environment where the sensors send control signals to operate the one or more IoT devices 130a-h. Because these modes of operation may occur at least contemporaneously, and potentially simultaneously, the disclosed system includes a hybrid open loop/closed loop operation.

Further, each of the one or more IoT devices 130e may include a sensor 131b, or a sensor 131a may be associated with, but physically separate from, the one or more of the IoT devices 130a-d, 130f-h. The sensor may use the parameter values set by the computing device 102 as trigger points in controlling the IoT devices 130a-h in a closed loop operation. In the closed loop operation, the sensor 131a, 131b and IoT device 130a-h communicate directly. The sensor 131a, 131b provides the control signal 500, rather than the computing device 102, acting through the universal device 104. For example, the sensor 131a, 131b may be a brightness sensor. The sensor may be integrated with a light fixture, or may be physically separate, but may include software which identifies one or more light fixtures to which the sensor may send control signals, based on measurements taken by the sensor matching input parameters.

To accomplish both the messaging necessary for the open loop and the closed loop communication, the transceivers 106, 126a-i on both the universal device 104 and on the IoT devices and sensors 130a-h, 131a may be nearly identical or identical. The transceivers 106, 126a-i may contain both a transmission circuit and a receiver circuit described in additional detail above. The transceivers 106, 126a-i are included in both the universal device 104 and each of the IoT devices 130a-h and any independent, that is, not integrated, sensors 131a because communication routed through a single device is both risky and impractical, particularly when the communication may be point to point and bi-directional as the operation of the system allows.

The following examples are used to illustrate how the closed loop operation of the one or more IoT devices and one or more sensors works. The examples are not meant to be limiting, but rather only illustrative of how some aspects of this technology works. By way of example and not limitation, a sprinkler system for outdoor watering is traditionally a standalone system which may not be controlled by a mobile device, or as part of an integrated IoT system. However, using one or more IoT devices and one or more sensors to replace the traditional controller of the sprinkler system, the sprinkler system is readily integrated in to the disclosed IoT system 100. The IoT device itself may only allow for turning the sprinklers on or off. However, sensors may be added with one or more parameters each. For example, one sensor may be added which is a clock. Parameter values may be set which cause the sprinkler system to turn on or off at pre-determined times. A second sensor may be integrated or assigned to control the sprinkler system. This second sensor may be a rain sensor. When the rain sensor detects rain within less than a predetermined period before the first sensor is set to turn the sprinkler system on, the rain sensor may send a control signal to the IoT device to ignore the next control signal from the first sensor. Thus, if there is rain shortly before the sprinkler system is set to run, the second sensor sends a control signal formed using the PLC protocol and transmitted to the power lines by the transceiver for the sprinkler system IoT device to ignore the next control signal from the first sensor. The pump included in a swimming pool filtration system may also be added to the IoT system 100 in a similar way. The addition of atypical devices to the IoT system 100 is another way in which the IoT system 100 creates universality.

In some instances, the IoT devices 130e and sensors 131b may be a single device, and the sensor may generate control signals which are executed internally. By way of example and not limitation, a thermostat IoT device may include one or more sensors inherently. For example, thermostats typically include a temperature sensor. The thermostat may include additional sensors, such as a humidity sensor. The temperature sensor may send commands to a blower and condenser, which are only connected to the IoT system through the thermostat. Thus, the control signals generated by the thermostat, based on the temperature sensor measurement travel along separate wiring from the electrical power wiring in the structure. This means that the commands are executed internally.

The PLC protocol of the system disclosed herein presents new possibilities for heating, ventilation, and air conditioning (HVAC) systems. With traditional HVAC systems, extra low voltage wiring has to be run in the structure to carry the control signals from the thermostat to the blower and condenser. With the IoT system 100, the same control signals may be generated and then sent using the PLC protocol. The low voltage wiring required to send signals between the thermostat and other HVAC components maybe eliminated, and control signals which cause the same effects may be sent from the thermostat on to the power line. With this configuration, the thermostat may be a programmable sensor, and the blower and condenser IoT devices. Traditional blowers and condensers will need a foundational architecture adapter. Some manufacturers may choose to include the foundational architecture in their blowers and condensers, and these would be able to join the IoT system without the use of an adapter. The thermostat would not be collocated with the blower or condenser, but would provide the primary control of those IoT devices in a closed loop operation.

The IoT system 100 may also use wireless connections in combination with the PLC connection. For example, a wireless connection may be made between the computing device 102 and the universal device 104, and, in some instances, between a sensor and the universal device 104. For example, the computing device 102 may connect to the universal device 104 through a wireless connection, as discussed above. Further, the universal device 104 may make use of a wireless connection to the cloud for certain functions. For example, the universal device 104 may access the cloud to store configuration settings for the IoT system 100. Alternatively, or in addition, the IoT system 100 may access computer code for creating user interfaces 1000 based on the self-identification information the IoT devices 130a-h and the sensors 131a, 131b provide. Also, if a user is not physically collocated with the IoT system 100, the user may access the IoT system 100, and specifically the universal device 104, via the internet using the computing device 102. Thus, the universal device 104 may have both a wired connection, for example, via power line 112, and a wireless connection via, for example, WiFi, to connected to a computing device 102 via the internet or local area network as is well known in the art.

Because the universal device 104 and the IoT devices 130a-h and sensors 131a, 131b communicate in most instances via the PLC protocol, and because the bandwidth available via PLC is large in comparison to the data needs of the PLC protocol, the communication between the universal device 104 and the IoT devices 130a-h and sensors 131a, 131b is fast. In fact, the universal device 104 can communicate with each of the attached IoT devices 130a-h and sensors 131a, 131b multiple times in a fraction of a second. Such a communication configuration allows for near instantaneous changes when required by a user.

As an alternative, the universal device 104 and the one or more IoT devices 130a-h and sensors 131a, 131b may communicate via a wireless connection. The universal device 104 and the one or more IoT devices 130a-h and sensors 131a, 131b may use WiFi protocol, or Bluetooth®, or other wireless protocols which allow the exchange messages between the IoT devices 130a-h, sensors 131a, 131b, and the universal device 104.

### Example Embodiments

Below is a list of nonlimiting examples of implementations of the description above.

### Group 1

In a 1st Example, a system for controlling devices via power line communication, comprising: a controller which sends commands indicative of a user's operation of the controller; a first transceiver electrically connected to the controller, the first transceiver including a first transmitter, including: a first crystal oscillator circuit including a first crystal oscillator powered to transmit a first signal wave at a clock frequency from a first output; a second crystal oscillator circuit including a second crystal oscillator powered to transmit a second signal wave at a transmission frequency and a first phase from a second output; a signal splitter connected to the second output, the signal splitter splitting the second signal wave to a first signal and a second signal and outputting the first signal to a third output and the second signal to a fourth output; a phase shift circuit configured to receive the second signal and to phase shift the second signal to a second phase; a switch configured to alternately output the first signal and the second signal, the output combination of the first signal and the second signal forming a control signal; a transceiver configured to output the control signal; a power line electrically connected to the transceiver output; one or more electrical outlets electrically connected to the power line; and one or more devices electrically connected to the one or more electrical outlets, the one or more devices configured to decode the control signal to obtain a baseband signal.

In a 2nd Example, the system of Example 1, further comprising at least one sensor.

In a 3rd Example, the system of Example 2, further comprising a processor electrically connected to each of the at least one sensor, and a memory electrically connected to the processor.

In a 4th Example, the system of Example 3, further comprising a third transceiver electrically connected to the at least one senor and located between the sensor and the power line.

In a 5th Example, the system of Example 4, wherein one of the at least one sensor sends control signals to only one of the one or more devices.

In a 6th Example, the system of Example 5, wherein the one of the at least one sensor sends control signals to the only one of the one or more devices based on parameters sent to the sensor by the controller.

In a 7th Example, the system of Example 1, wherein the one or more devices comprises a baseband decoder configured to interpret a first phase state of the control signal as a first binary state and a second phase state of the control signal as a second binary state.

In a 8th Example, a method for providing power line communication, comprising: generating a signal wave using a crystal oscillator; splitting the signal wave into a first signal and a second signal; phase shifting the second signal using a phase shift circuit, wherein the phase of the second signal is shifted according to an index of a clock frequency generated by a clock crystal oscillator electrically connected to the phase shift circuit; outputting the first signal and the second signal to a switch; forming a control signal by operating the switch to alternate between outputting the first signal and the second, phase shifted signal according to a baseband signal; outputting the control signal to a power line; receiving the control signal on a receiver electrically connected to the power line; decoding the control signal to executable instructions; and controlling the operation of at least one device based on the decoded control signal.

In a 9th Example, the method of Example 8, wherein the phase shift circuit is part of an integrated circuit.

In a 10th Example, the method of Example 9, wherein the information may include parameters for the operation of the one or more sensors.

In a 11th Example, the method of Example 8, wherein the control signal may include information for one or more sensors connected to the power line.

In a 12th Example, a system for providing power line communication, comprising: a smart device which sends commands interpreted by a protocol; a first transceiver electrically connected to the smart device, the transceiver including a first crystal oscillator configured to generate and send a first signal to a first output; a signal splitter connected to the first output and configured to transmit the first signal to a second output and a copy of the first signal to a third output; a phase shift circuit configured to create a second signal with a phase state different from that of the first signal and to output the second signal to a fourth output; a switch having a first terminal electrically connected to the second output and a second terminal electrically connected to the fourth output, the switch further including a transceiver output; a first processor electrically connected to the smart device, the switch, and a first memory containing the protocol, the first processor executing the protocol to control operation of the switch; a power line connected to the transceiver output; at least one device electrically connected to the power line; and at least one sensor connected to the power line; wherein, when a user operates the smart device to send a command, the protocol, executing on the first processor, converts the command to a control signal by sending a baseband signal to the switch, wherein the switch alternates between outputting the first signal and the second signal to encode the control signal with information.

In a 13th Example, the system of Example 12, wherein the first transceiver further includes a circuit which compensates for frequency drift of the first crystal oscillator.

In a 14th Example, the system of Example 12, wherein the at least one sensor comprises a second transceiver having an ultra narrow band filter and is configured to send control signals based on the encoded information.

In a 15th Example, the system of Example 12, wherein the at least one device and the at least one sensor send an acknowledgement to the controller after receiving a control signal.

In a 16th Example, the system of Example 12, wherein the first transceiver can output at a first frequency and a second frequency, the first frequency being at least an order of magnitude greater than the second frequency.

In a 17th Example, the system of Example 16, wherein the second frequency is a harmonic of the first frequency.

In an 18th Example, the system of Example 16, wherein the at least one device comprises a first receiver configured to receive on both the first frequency and the second frequency.

In a 19th Example, the system of Example 12, wherein the at least one device and the at least one sensor include a transmitter, the transmitter including a crystal oscillation circuit for sending acknowledgement messages.

### Group 2

In a 1st Example, the system for controlling devices via power line control, comprising: a controller which sends commands indicative of a user's operation of the controller; an emitter electrically connected to the controller, the emitter including: a crystal oscillator configured to transmit a sinusoidal wave at a transmission frequency; a switch electrically connected to the crystal oscillator; a phase inversion circuit electrically connected to a first side of the switch; and a bypass electrically connected to a second side of the switch; a power line electrically connected to the phase inversion circuit; and one or more smart fans configured to be operated in response to a signal from the controller.

In a 2nd Example, the system of Example 1, wherein the system includes two or more smart fans, but the commands from the controller is directed to only one of the two or more smart fans.

In a 3rd Example, the system of Example 1, wherein the switch may provide 50 or more phase inversion spikes per cycle of the sinusoidal wave.

In a 4th Example, the system of Example 1, wherein the crystal oscillator is a quartz crystal oscillator.

In a 5th Example, the system of Example 4, wherein a Q factor of the crystal oscillator is in a range of 105 to 106.

In a 6th Example, the system of Example 5, wherein the sinusoidal wave is output with one watt of power.

In a 7th Example, the system of Example 1, further comprising: a first processor electrically connected to the switch, the first processor executing commands sent by the controller in order to operate the switch and to add phase inversion spikes to the sinusoidal wave; and a first memory electrically connected to the processor, the first memory having a protocol stored on it, wherein the protocol interprets the phase inversion spikes as a one and an absence of a phase inversion spike as a zero, or interprets the phase inversion spikes as a zero and the absence of a phase inversion spike as a one.

In a 8th Example, a method for providing power line control, comprising: generating a sinusoidal wave using a crystal oscillator; forming a control signal by routing the sinusoidal wave through a phase inversion circuit; forming phase inversion spikes at predetermined intervals on the sinusoidal wave; outputting the control signal to a power line; receiving the control signal on a crystal filter electrically connected to the power line; converting the control signal to executable instructions; and controlling a motor based on the converted control signal.

In a 9th Example, the method of Example 8, wherein the crystal oscillator is a quartz crystal oscillator.

In a 10th Example, the method of Example 9, wherein sinusoidal wave has one watt of power.

In a 11th Example, the method of Example 8, further comprising operating a switch to provide at least 50 inversion spikes per cycle of the sinusoidal wave.

In a 12th Example, the method of Example 8, wherein a Q factor of the crystal oscillator is in a range of 105 to 106.

In a 13th Example, a system for providing power line control, comprising: a controller configured to send commands; an emitter configured to emit a sinusoidal wave; and at least one smart fan electrically connected to a power line; wherein, when a user operates the controller to send a command, the controller is configured to cause the emitter to generate a sinusoidal wave having control information comprising phase inversion spikes and spacing between the spikes and to transmit the sinusoidal wave via the power line to control the at least one smart fan.

In a 14th Example, the system of Example 13, wherein the system includes at least two smart fans, but the at least two smart fans may be sent commands individually.

In a 15th Example, the system of Example 13, further comprising a switch configured to provide at least 50 phase inversion spikes per cycle of the sinusoidal wave.

In a 16th Example, the system of Example 13, wherein the emitter comprises a crystal oscillator.

In a 17th Example, the system of Example 16, wherein a Q factor of the crystal oscillator is in a range of 105 to 106.

In an 18th Example, the system of Example 17, wherein the sinusoidal wave is output with one watt of power.

In a 19th Example, the system of Example 16, wherein the emitter operates the crystal oscillator between series and parallel resonance.

In a 20th Example, the system of Example 16, wherein the emitter operates the crystal oscillator at series resonance.

### Group 3

In a 1st Example, a smart home system for controlling devices, comprising: a computing device; one or more system modules electrically connected to the computing device, the one or more system modules only including circuitry for performing one or more unique functions, a transceiver, a memory, and a processor, a protocol stored on the memory and executing on the processor to exchange messages, including initialization information, with the computing device; a universal device interposed between the computing device and the one or more system modules, so that the universal device exchanges messages with both the computing device and the one or more system modules, the universal device including a transceiver for sending data to, and receiving data from, the computing device; and a software application stored on non-transient media on the computing device which includes instructions for requesting the initialization information from the one or more system modules, and allowing a user to execute the one or more unique functions of the modules.

In a 2nd Example, the method of Example 1, wherein the initialization information includes the one or more unique functions and control parameters are for the one or more unique functions.

In a 3rd Example, the method of any of Examples 1-2, wherein the software application further includes instructions for creating a user interface based on the initialization information.

In a 4th Example, the method of Example 3, wherein the user interface includes one or more control surfaces which generate commands for changing control parameters on a corresponding one of the one or more system modules.

In a 5th Example, the method of Example 4, wherein a user operates the control surfaces on a touch screen display of the computing device.

In a 6th Example, the method of any of Examples 1-5, wherein the one or more system modules are connected to the universal device via a wired connection.

In a 7th Example, the method of Example 6, wherein the wired connection is made using a power line.

In an 8th Example, a method for providing control of a smart home system, comprising: providing a computing device including a display; connecting a universal device to the computing device via a wired or wireless connection; connecting one or more system modules to the universal device via a wired or wireless connection, the one or more system modules and the universal device communicating using an open source protocol; sending a message from the computing device to the one or more system modules requesting initialization information; sending a message from the one or more system modules to the computing device including the initialization information, the initialization information including information regarding one or more unique functions of the corresponding one of the one or more system modules and control parameters of the one or more functions; creating a user interface for displaying on the display of the computing device, the user interface including control surfaces which, when manipulated by a user, cause a change in a value of one of the control parameters of one of the one or more functions of the peripheral device.

In a 9th Example, the method of Example 8, wherein the connection between the universal device and the one or more system modules is a wired connection.

In a 10th Example, the method of Example 9, wherein the wired connection is made through power lines.

In an 11th Example, the method of any of Examples 8-10, wherein the open source protocol is a power line communication protocol.

In a 12th Example, the method of any of Examples 8-11, wherein the one or more system modules each include one or more unique functions, circuitry for performing the one or more unique functions, a transceiver, a memory, and a processor, a protocol stored on the memory and executing on the processor.

In a 13th Example, a smart home system for providing ubiquitous control, comprising: a computing device for sending commands which are interpreted by a protocol; a universal device including a transceiver for sending data to, and receiving data from, the computing device, and a non-transient media containing the protocol; one or more system modules connected to the universal device, the one or more system modules each including one or more unique functions, the one or more system modules communicating with the universal device using the protocol; and a software application stored on non-transient media on the computing device, the software application including instructions for requesting the initialization information from the one or more system modules and instructions for creating a user interface based on the initialization information, the user interface including one or more control surfaces which correspond to the one or more unique functions identified in the initialization information.

In a 14th Example, the system of Example 13, wherein the universal device and the one or more system modules are connected via a wireless connection.

In a 15th Example, the system of any of Examples 13-14, wherein the universal device and the one or more system modules are connected via a wired connection.

In a 16th Example, the system of Example 15, wherein the wired connection is made through a power line.

In a 17th Example, the system of any of Examples 13-16, wherein the protocol provides for communication via power line communication.

In an 18th Example, the system of any of Examples 17, wherein the power line communication includes adding control information to a sinusoidal wave created by a crystal oscillator.

In a 19th Example, the system of any of Examples 13-18, wherein the one or more control surfaces generate commands for changing control parameters on a corresponding one of the one or more system modules.

In a 20th Example, the system of any of Examples 13-19, including two or more system modules, the two or more system modules having only the transceiver circuit in common.

### Group 4

In a 1st Example, a system for hybrid centralized and local control of a hydroponic system, comprising: a central controller which sends commands using a power line control protocol; a computing unit electrically connected to the central controller, the computing unit including a processor and a memory, the memory including instructions executing on the processor to receive measurements, check the measurements against user input parameters, and send commands if the measurements are outside of the input parameters; a light fixture electrically connected to the computing unit; a temperature sensor electrically connected to the computing unit; a tank containing a volume of a liquid; a tank valve in electrical communication with the computing unit, the tank valve including an outlet in fluid communication with the tank, a first tank valve inlet in fluid communication with a liquid source and the outlet, and a second tank valve inlet in fluid communication with the outlet; an additive valve in electrical communication with the computing unit, the additive valve including an outlet in fluid communication with the second tank valve inlet, a first additive valve inlet in fluid communication with a pH tank, and a second additive valve inlet in fluid communication with a fertilizer tank; and a sensor package at least partially submerged in the volume of liquid in the tank, the sensor package including at least a first sensor measuring a pH of the liquid in the tank, a second sensor measuring an electrical conductivity of the liquid in the tank, and a third sensor measuring a liquid level in the tank; wherein, the central controller sends commands to control at least the light fixture, and, based on measurements from the temperature sensor, the sensor package, or both, and wherein the computing unit sends commands to operate the tank valve, the additive valve, and the light fixture. In a 2nd Example, the system of Example 1, wherein the liquid in the tank is water. In a 3rd Example, the system of any of Examples 1-2, wherein the commands sent by the central controller are based on user input parameters.

In a 4th Example, the system of any of Example 1-3, wherein the sensor package further includes a second temperature sensor.

In a 5th Example, the system of Example 4, wherein the instructions stored on the memory and executing on the processor checks both the measurement of the temperature sensor and the second temperature sensor against user input parameters before sending commands. In a 6th Example, the system of Example 5, wherein both the measurements must be outside the user input parameters before sending commands.

In a 7th Example, the system of any of Example 1-6, wherein the tank valve and the additive valve are electrically actuatable between fluid communication between the first inlet and the outlet, fluid communication between the second inlet and the outlet, and an off position with no fluid communication.

In an 8th Example, a method for operating a smart hydroponic system, comprising: providing a central controller connected to a power line; connecting a computing unit to the power line; connecting an air temperature sensor, and at least one sensor submerged in a volume of liquid to the computing unit; placing at least one electrically actuated valve in electrical communication with the computing unit; placing a light fixture in electrical communication with the central controller and the computing unit; sending commands from the central controller using a power line communication protocol, the commands affecting at least operation of the light fixture; and sending commands, based on measurements from the air temperature sensor, or the at least one sensor, from the computing unit to control operation of the of the at least one electrically actuated valve and the light fixture, either separately, or contemporaneously.

In a 9th Example, the method of Example 8, wherein there are two electrically actuated valves in electrical communication with the computing unit.

In a 10th Example, the method of any of Examples 8-9, wherein when sending the commands, the computing unit checks the measurements against user input parameters, and only sends commands if the measurements are outside the user input parameters.

In a 11th Example, the method of any of Examples 8-10, wherein the central controller sends commands using a power line control protocol.

In a 12th Example, the method of any of Examples 8-11, wherein the liquid is water.

In a 13th Example, a system for optimizing hydroponic growth through a combination of central and local control, comprising: a central controller which generates commands using user input parameters; and one or more smart hydroponic system modules electrically connected to the central controller, the one or more smart hydroponic system modules including: a computing unit including a processor and a memory, the memory including a set of instructions which direct the computing unit to receive measurements, and, based on the measurements, process commands for execution on the processor; a temperature sensor electrically connected to the computing unit, the temperature sensor taking a first portion of the measurements and sending the first portion of the measurements to the computing unit; a sensor package electrically connected to the computing unit, the sensor package taking a second portion of the measurements and sending the second portion of the measurements to the computing unit; at least one valve electrically actuatable between establishing fluid communication between a first inlet and an outlet, a second inlet and the outlet, and an off position, the electric actuation being controlled by commands send by the computing unit; and a light fixture electrically connected to the computing unit and the central controller, the light fixture adapted to turn on, turn off, or dim, based on both commands sent from the central controller, and commands sent from the computing unit, the commands from the computing unit being based on either the first portion of the measurements or the second portion of the measurements.

In a 14th Example, the system of Example 13, wherein the central controller sends commands using a power line control protocol.

In a 15th Example, the system of any of Examples 13-14, wherein the computing unit checks the measurements against user input parameters, and, if the measurements are outside the input parameters, processes the commands.

In a 16th Example, the system of any of Examples 13-15, further comprising a first valve and a second valve.

In a 17th Example, the system of Example 16, wherein an outlet of the first valve is connected to a first inlet of the second valve, and the second inlet of the second valve is connected to a liquid source.

In an 18th Example, the system of Example 17, wherein a first inlet of the first valve is connected to a pH tank, and a second inlet of the first valve is connected to a fertilizer tank. In a 19th Example, the system of any of Example 13-18, wherein the sensor package includes a pH sensor, an electrical conductivity sensor, and a water level sensor.

n a 20th Example, the system of any of Example 13-19, wherein the sensor package is located at least partially submerged in a liquid in a tank.

### Group 5

In a 1st Example, an internet of things system to provide for communication between devices, comprising: an electrical power line; one or more IoT devices electrically connected to the power line, the one or more IoT devices each including a first set of circuitry for performing a first set of one or more functions, a first transceiver, a first memory, and a first processor, a PLC protocol stored on the first memory and executing on the first processor to send messages over the electrical power line, including initialization information, or control signals or sensor data, or a combination of initialization information, control signals, and sensor data; and a universal device electrically connected to the electrical power line and wirelessly connected to at least one computing device, so that the universal device exchanges messages with the one or more IoT devices and the at least one computing device, the universal device including a power line transceiver and a wireless transceiver; wherein the one or more IoT devices, at least one computing device and universal device all use a common foundational hardware design and the communication protocol to communicate directly from one of the one or more IoT devices to another of the one or more IoT devices, or from one of the one or more IoT devices through the universal device to one of the at least one computing device.

In a 2nd Example, the system of Example 1, wherein the initialization information includes one or more functions for the one or more IoT devices.

In a 3rd Example, the system of any of Examples 1-2, wherein the software application further includes instructions for creating a user interface based on the initialization information.

In a 4th Example, the system of Example 3, wherein the user interface includes one or more control surfaces which generate commands for operating a corresponding one of the one or more IoT devices.

In a 5th Example, the system of Example 4, wherein a user operates the control surfaces on a touch screen display of the computing device.

In a 6th Example, the system of any of Examples 1-5, further including one or more sensors electrically connected to the electrical power line, the one or more sensors each including a second transceiver to send control signals on the electric power line, a second processor electrically connected to the second transceiver, and a second memory electrically connected to the second processor, the second memory including a copy of the PLC protocol.

In a 7th Example, the system of Example 6, wherein the one or more sensors are assigned to one or more IoT devices and the one or more sensors send control signals to the one or more IoT devices to operate the one or more IoT devices.

In a 8th Example, a method for providing control of an IoT system, comprising: providing a computing device including a display; connecting a universal device to the computing device via a wired or wireless connection; connecting one or more IoT devices to the universal device via a wired connection, the one or more IoT devices and the universal device each including a transceiver to send and receive messages formatted using a PLC protocol; sending a message from the computing device to the one or more IoT devices requesting initialization information; sending a message from the one or more IoT devices to the computing device including the initialization information, the initialization information including information regarding one or more unique functions of the corresponding one of the one or more IoT devices and control parameters of the one or more unique functions; creating a user interface for displaying on the display of the computing device, the user interface including control surfaces which, when manipulated by a user, cause a change in a value of one of the control parameters of one of the one or more functions of one of the one or more IoT devices; and manipulating a control surface to operate one of the one or more IoT devices.

In a 9th Example, the method of Example 8, wherein the connection between the universal device and the one or more system modules is a wired connection.

In a 10th Example, the method of Example 9, wherein the wired connection is made through electrical power lines.

In a 11th Example, the method of any of Examples 8-10, wherein the PLC protocol is stored on one or more memories, each one of the one or more memories being electrically connected to the transceiver in each of the one or more IoT devices and the universal device.

In a 12th Example, the method of any of Examples 8-11, wherein the one or more IoT devices each include one or more unique functions, circuitry for performing the one or more unique functions, a processor electrically connected to the transceiver, and a memory electrically connected to the processor, the PLC protocol stored on the memory and executing on the processor.

In a 13th Example, an IoT system for allowing the interoperation of devices, comprising: a computing device for sending control signals using a PLC protocol; a universal device including a first transceiver for sending data to, and receiving data from, the computing device, and a non-transitory first memory electrically connected to the transceiver, the first memory containing the PLC protocol; one or more IoT devices connected to the universal device through electrical power lines, the one or more IoT devices each including one or more unique functions, the one or more IoT devices each including a second memory storing a first copy of the PLC protocol, and a second transceiver electrically connected to the second memory and communicating with the universal device using the PLC protocol; and one or more sensors connected to the one or more IoT devices through the electrical power lines, the one or more sensors each including a third memory storing a second copy of the PLC protocol, and a third transceiver electrically connected to the third memory and communicating with the universal device using the PLC protocol; wherein one of the one or more sensors sends a control signal directly to one or more of the one or more IoT devices.

In a 14th Example, the system of Example 13, wherein the universal device, the one or more IoT devices, and the one or more sensors all include foundational architecture.

In a 15th Example, the system of any of Examples 13-14, wherein at least one of the one or more IoT devices has an integrated sensor.

In a 16th Example, the system of Example 15, wherein the integrated sensor communicates direct to the one of the one or more IoT devices without the signal being placed on the electrical power lines.

In a 17th Example, the system of any of Examples 13-16, wherein the PLC protocol encodes information using two phase shifted sinusoidal waves.

In an 18th Example, the system of Example 17, wherein the sinusoidal waves are each generated by a crystal oscillator.

In a 19th Example, the system of any of Examples 13-18, wherein the one or more control surfaces generate commands for changing control parameters on a corresponding one of the one or more IoT devices.

In a 20th Example, the system of any of Examples 13-19, including two or more IoT devices, the two or more IoT devices having only the foundational architecture in common.

### Other Considerations

The above description is given by way of example, and not limitation. Given the above disclosure, one skilled in the art could devise variations that are within the scope and spirit of the invention disclosed herein, including various ways of forming the syntax of the text or natural language commands. Further, the various features of the embodiments disclosed herein can be used alone, or in varying combinations with each other and are not intended to be limited to the specific combination described herein. Thus, the scope of the claims is not to be limited by the illustrated embodiments.

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A smart home system for controlling devices, comprising:
a computing device;
a crystal oscillator configured to produce a sinusoidal wave comprising control information;
one or more system modules electrically connected to the computing device, the one or more system modules comprising circuitry for performing one or more unique functions based on the control information, the one or more system modules further comprising a transceiver, a memory, and a processor, a protocol stored on the memory configured to be executed by the processor to exchange messages, including initialization information, with the computing device;
a universal device interposed between the computing device and the one or more system modules, so that the universal device exchanges messages with both the computing device and the one or more system modules, the universal device including a transceiver for sending data to, and receiving data from, the computing device; and
a software application stored on non-transient media on the computing device which includes instructions for requesting, based on the control information, the initialization information from the one or more system modules, and allowing a user to execute the one or more unique functions of the modules.

2. The method of claim 1, wherein the initialization information includes the one or more unique functions and control parameters are for the one or more unique functions.

3. The method of claim 1, wherein the software application further includes instructions for creating a user interface based on the initialization information.

4. The method of claim 3, wherein the user interface includes one or more control surfaces which generate commands for changing control parameters on a corresponding one of the one or more system modules.

5. The method of claim 4, wherein a user operates the control surfaces on a touch screen display of the computing device.

6. The method of claim 1, wherein the one or more system modules are connected to the universal device via a wired connection.

7. The method of claim 6, wherein the wired connection is made using a power line.

8. A method for providing control of a smart home system, comprising:
providing a computing device including a display;
connecting a universal device to the computing device via a wired or wireless connection;
connecting one or more system modules to the universal device via a wired or wireless connection, the one or more system modules and the universal device communicating using an open source protocol;
sending a message from the computing device to the one or more system modules requesting initialization information;
sending a message from the one or more system modules to the computing device including the initialization information, the initialization information including information regarding one or more unique functions of the corresponding one of the one or more system modules and control parameters of the one or more functions;
creating a user interface for displaying on the display of the computing device, the user interface including control surfaces which, when manipulated by a user, cause a change in a value of one of the control parameters of one of the one or more functions of the peripheral device.

9. The method of claim 8, wherein the connection between the universal device and the one or more system modules is a wired connection.

10. The method of claim 9, wherein the wired connection is made through power lines.

11. The method of claim 8, wherein the open source protocol is a power line communication protocol.

12. The method of claim 8, wherein the one or more system modules each include one or more unique functions, circuitry for performing the one or more unique functions, a transceiver, a memory, and a processor, a protocol stored on the memory and executing on the processor.

13. A smart home system for providing ubiquitous control, comprising:
a computing device for sending commands which are interpreted by a protocol;
a universal device including a transceiver for sending data to, and receiving data from, the computing device, and a non-transient media containing the protocol; one or more system modules connected to the universal device, the one or more system modules each including one or more unique functions, the one or more system modules communicating with the universal device using the protocol; and
a software application stored on non-transient media on the computing device, the software application including instructions for requesting the initialization information from the one or more system modules and instructions for creating a user interface based on the initialization information, the user interface including one or more control surfaces which correspond to the one or more unique functions identified in the initialization information.

14. The system of claim 13, wherein the universal device and the one or more system modules are connected via a wireless connection.

15. The system of claim 13, wherein the universal device and the one or more system modules are connected via a wired connection.

16. The system of claim 15, wherein the wired connection is made through a power line.

17. The system of claim 13, wherein the protocol provides for communication via power line communication.

18. The system of claim 17, wherein the power line communication includes adding control information to a sinusoidal wave created by a crystal oscillator.

19. The system of claim 13, wherein the one or more control surfaces generate commands for changing control parameters on a corresponding one of the one or more system modules.

20. The system of claim 13, including two or more system modules, the two or more system modules having only the transceiver circuit in common.
